(19) United States
(12) Patent Application Publication
(10) Pub. No.: US 2009/0147658 A1
(43) Pub. Date: Jun. 11, 2009

(54) OPTICAL HEAD AND OPTICAL INFORMATION RECORDER/REPRODUCER EMPLOYING IT

(75) Inventor: Ryuichi Katayama, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 12/097,736

(22) PCT Filed: Nov. 17, 2006
(86) PCT No.: PCT/JP2006/322934

§ 371 Date: Jun. 16, 2008

(30) Foreign Application Priority Data
Dec. 15, 2005 (JP) 2005-361382

(51) Int. Cl. G11B 7/135

(52) U.S. Cl. 369/112.03; G9B/7

(57) ABSTRACT

To provide an optical head capable of detecting tilt with high sensitivity for two kinds of optical recording media having different groove pitches, and to provide an optical information recording/reproducing device, diffraction optical elements split emitted light from a light source into a main beam, a first sub-beam (diffracted light from a region of the diffraction optical element, and a second sub-beam (diffracted light from a region of the diffraction optical element). The region of the diffraction optical element has a diameter larger than that of the region of the diffraction optical element. A push-pull signal by the first sub-beam under track-servo is employed as a radial tilt error signal for an optical recording medium having a narrow groove pitch, and a push-pull signal by the second sub-beam under track-servo is employed as a radial tilt error signal for an optical recording medium having a wide groove pitch.

### TECHNICAL FIELD

The present invention relates to an optical head and an optical information recording/reproducing device for performing recording/reproduction to/from a recording medium having grooves. More specifically, the present invention relates to an optical head and an optical information recording/reproducing device, which are capable of detecting signals (such as radial tilt error signals) with high sensitivity from two kinds of optical recording media having different groove pitches. Note that “recording/reproducing” herein means at least either “recording” or “reproducing”, i.e., means “both recording and reproducing”, “recording only”, or “reproducing only”.

### RELATED ART

Recording density of an optical information recording/reproducing device is inversely proportional to a square of the diameter of a light focusing spot that is formed on an optical recording medium by an optical head. That is, the smaller the diameter of the light focusing spot is, the higher the recording density becomes. The diameter of the light focusing spot is inversely proportional to the numerical aperture (referred to as “NA” hereinafter) of an objective lens of the optical head. That is, the higher the NA of the objective lens is, the smaller the diameter of the light focusing spot becomes. In the meantime, when the optical recording medium tilts in a radial direction with respect to the objective lens, the shape of the light focusing spot is disturbed because of a comma aberration caused due to a tilt in the radial direction (radial tilt), thereby deteriorating the recording/reproducing property. The comma aberration is proportional to a cube of the NA of the objective lens. Thus, the higher the NA of the objective lens is, the narrower the margin of the radial tilt of the optical recording medium for the recording/reproducing property becomes. Therefore, in the optical head and the optical information recording/reproducing device in which the NA of the objective lens is increased for improving the recording density, it is necessary to detect and correct the radial tilt of the optical recording medium so as not to deteriorate the recording/reproducing property.

In multisession-type and rewritable type optical recording media in which RF signals are not recorded in advance, grooves are normally formed for tracking. From the light incident side of the optical recording medium, a recessed part is called a land and a protruded part is called a groove. There are an optical head and an optical information recording/reproducing device depicted in Patent Document 1 as a conventional optical head and optical information recording/reproducing device capable of detecting the radial tilt for an optical recording medium with the grooves.

FIG. 41 shows a structure of the optical head depicted in Patent Document 1. Emitted light from a semiconductor laser 1 is parallelized by a collimator lens 2, and it is divided by a diffraction optical element 3w into three light beams, i.e., ¥transmission light as a main beam, and negative and positive first order diffracted lights as sub-beams. These light beams make incident on a polarizing beam splitter 4 as P-polarized light, and almost 100% thereof transmit therethrough. The light beams then transmit a quarter wavelength plate 5, which are converted to circularly polarized light from linearly polarized light, and converged by an objective lens 6 onto a disk 7. The three reflected light beams from the disk 7 transmit the objective lens 6 from an inverse direction, which transmit the quarter wavelength plate 5 and are then converted from the circularly polarized light to linearly polarized light whose polarizing direction is orthogonal to the outward path. The linearly polarized light makes incident on the polarizing beam splitter 4 as S-polarized light, and almost 100% thereof is reflected thereby, which transmits through a cylindrical lens 8 and a convex lens 9. Then, it is received by a photodetector 10e. The photodetector 10e is deposited in the middle of two caustic curves of the cylindrical lens 8 and the convex lens 9.

FIG. 42 is a plan view of the diffraction optical element 3w. The diffraction optical element 3w is formed in a structure in which a diffraction grating is formed only in a region 16 on the inner side of a circle that has a smaller diameter than an effective diameter 6a of the objective lens 6 illustrated with a dotted line in the drawing. The grating direction in the diffraction grating is in parallel to the radial direction of the disk 7, and the pattern of the grating is in a linear form of an equivalent pitch. For example, about 87.3% of the light making incident on the inside the region 16 transmits therethrough as zeroth order light, and about 5.1% each is diffracted as the positive and negative first order diffracted light. Further, almost 100% of the light making incident on the outer side of the region 16 transmits therethrough. Here, the main beam contains both the light transmitted through the inside of the region 16 and the light transmitted through the outer side thereof, while the sub-beams contain only the light diffracted on the inside the region 16. As a result, the intensity of the peripheral part of the sub-beams becomes weaker than that of the main beam.

FIG. 43 shows the layout of the light focusing spots on the disk 7. FIG. 43A shows a case where the groove pitch of the disk 7 is narrow, and FIG. 43B shows a case where the groove pitch of the disk 7 is wide. The light focusing spots 25a, 25b, and 25c correspond to the transmission light, to the positive first order diffracted light, and to the negative first order diffracted light from the diffraction optical element 3w, respectively. The light focusing spots 25a, 25b, and 25c are arranged on a same track 22a in FIG. 43A, and the light focusing spots 25a, 25b, and 25c are arranged on a same track 22b in FIG. 43B. The light focusing spots 25b and 25c as the sub-beams have a larger diameter than the light focusing spot 25a as the main a beam.

FIG. 44 shows a pattern of a light-receiving part of the photodetector 10e and layout of the optical spots on the photodetector 10e. The optical spot 35a corresponds to transmission light from the diffraction optical element 3w, and it is received by light-receiving parts 34a-34d which are divided into four by a dividing line that is in parallel to the tangential direction of the disk 7 passing through the optical axis and by a dividing line that is in parallel to the radial direction. The optical spot 35b corresponds to the positive first order diffracted light from the diffraction optical element 3w, and it is received by light-receiving parts 34e and 34f which are divided into two by a dividing line that is in parallel to the radial direction of the disk 7 passing through the optical axis. The optical spot 35c corresponds to the negative first order diffracted light from the diffraction optical element 3w, and it is received by light-receiving parts 34g and 34h which are divided into two by a dividing line that is in parallel to the radial direction of the disk 7 passing through the optical axis. The intensity distribution in the tangent direction of the disk 7 and the intensity distribution in the radial direction are switched from each other in the optical spots 35a-35c, because of the effects of the cylindrical lens 8 and the convex lens 9.

When outputs from the light-receiving parts 34a-34h are expressed as V34a-V34h, respectively, a focus error signal can be obtained by an arithmetic operation of (V34a+V34d)-(V34b+V34c) based on an astigmatism method. A push-pull signal by the main beam can be given by (V34a+V34b)-(V34c+V34d), and a push-pull signal by the sub-beams can be given by (V34e+V34g) (V34f+V34h) The push-pull signal by the main beam is used as a track error signal. The RF signal recorded in the disk 7 can be obtained by an arithmetic operation of (V34a+V34b+V34c+V34d).

FIG. 45 shows various push-pull signals related to detection of radial tilt. The lateral axis in the drawing is a detrack amount of the light focusing spot, and the longitudinal axis is the push-pull signal. The push-pull signal 38a shown in FIG. 45A is a push-pull signal by the main beam and a push-pull signal by the sub-beams when there is no radial tilt in the disk 7. In the meantime, the push-pull signals 38b and 35c shown in FIG. 45B are push-pull signals by the main beam and the sub-beams, respectively, when there is a positive radial tilt in the disk 7. Further, the push-pull signals 38d and 38e shown in FIG. 45C are push-pull signals by the main beam and the sub-beams, respectively, when there is a negative radial tilt in the disk 7. In the push-pull signal by the main beam, the position crossing at 0-point from the negative side to the positive side corresponds to a land, and the position crossing at 0-point from the positive side to the negative side corresponds to a groove.

When there is no radial tilt in the disk 7, the zero-cross point of the push-pull signal by the sub-beams becomes consistent with that of the push-pull signal by the main beam. Thus, the push-pull signal is “0” in both the land and the groove. In the meantime, when there is a positive radial tilt in the disk 7, the zero-cross point of the push-pull signal by the sub-beams is shifted to the left side of the drawing with respect to that of the push-pull signal by the main beam. Thus, the push-pull signal becomes positive in the land and becomes negative in the groove. Further, when there is a negative radial tilt in the disk 7, the zero-cross point of the push-pull signal by the sub-beams is shifted to the right side of the drawing with respect to that of the push-pull signal by the main beam. Thus, the push-pull signal becomes negative in the land and becomes positive in the groove. Therefore, the push-pull signal by the sub-beams under track-servo can be used as a radial tilt error signal.

Patent Document 1: Japanese Unexamined Patent Publication 2001-236666

### DISCLOSURE OF THE INVENTION

In the optical head and the optical information recording/reproducing device depicted in Patent Document 1, NA for the main beam depends on the effective diameter of the objective lens 6, and NA for the sub-beams depends on the diameter of the region 16 of the diffraction optical element 3w. The NA of the sub-beams is lower than that of the main beam. Thus, when there is a radial tilt in the disk 7, the zero-cross a point of the push-pull signal by the main beam becomes shifted from that of the push-pull signal by the sub-beams. The radial tilt in the disk 7 can therefore be detected based on the shift. The lower the NA of the sub-beams is, the larger the shift between the zero-cross points of the push-pull signal by the main beam and the push-pull signal by the sub-beams when there is a radial tilt in the disk 7 becomes. However, the amplitude of the push-pull signal by the sub-beam becomes smaller. The absolute value of the radial tilt error signal when there is a radial tilt in the disk 7 becomes larger as the shift between the zero-cross points of the push-pull signal by the main beam and the push-pull signal by the sub-beams becomes larger. Further, it is larger when the amplitude of the push-pull signal by the sub-beams becomes larger. Therefore, there is the optimum value in the NA of the sub-beams, with which the absolute value of the radial tilt error signal becomes the maximum.

As the multisession-type and rewritable-type optical recording media, there is a groove-recording type optical recording medium with which recording/reproduction is performed only on the groove, e.g. HD DVD-R (High Density Digital Versatile Disc-Recordable), and a land/groove-recording type optical recording medium with which recording/reproduction is performed on both the land and groove, e.g. HD DVD-RW (High Density Digital Versatile Disk-Rewritable) Normally, the groove pitch of the groove-recording type optical recording medium is narrower than that of the land/groove-recording type optical recording medium. Here, the optimum value of the NA of the sub-beams with which the absolute value of the radial tilt error signal becomes the maximum depends on the groove pitch of the optical recording medium.

FIG. 46 shows an example of calculating the relation between the NA of the sub-beams and the radial tilt error signal. The lateral axis in the drawing is the NA of the sub-beams, and the longitudinal axis is the absolute value of the radial tilt error signal when the radial tilt normalized by a sum signal is 0.1 degree. FIG. 46A shows a case where the optical recording medium is an HD DVD-R whose groove pitch is narrow, and FIG. 46B shows a case where the optical recording medium is an HD DVD-RW whose groove pitch is wide. The conditions used for the calculation are as follows: the wavelength of the light source=405 nm; the NA of the objective lens=0.65; the substrate thickness of the optical recording medium=0.6 mm; the groove pitch of the optical recording medium=0.4 μm (FIG. 46A), 0.68 μm (FIG. 46B); the groove depth of the optical recording medium=25 nm (FIG. 46A), 45 nm (FIG. 46B).

The optimum values of the NA of the sub-beams with which the absolute value of the radial tilt error signal become the maximum are about 0.6 (FIG. 46A) and about 0.52-0.53 (FIG. 46B). When the NA of the sub-beams is set as 0.6, the absolute value of the radial tilt error signal for HD DVD-R becomes the maximum, while it is decreased to nearly a half the maximum value for HD DVD-RW. In the meantime, when the NA of the sub-beams is set as 0.52-0.53, the absolute value of the radial tilt error signal for HD DVD-RW becomes the maximum, while it is decreased to nearly zero for HD DVD-R. That is, it is not possible to detect the radial tilt with high sensitivity for both of the two kinds of optical recording media having different groove pitches.

Note here that the radial tilt error signal is merely away of example, and the relation between the NA of the sub-beams and the signal intensity shown in FIG. 46 is also observed in other signals to a greater or lesser extent in each of the two kinds of optical recording media having different groove pitches.

It is an object of the present invention to provide an optical head and an optical information recording/reproducing device, which are capable of detecting signals (for example, radial tilt error signals) with high sensitivity for both of two kinds of optical recording media having different groove pitches.

A first optical head according to the present invention includes a light source, an objective lens for converging emitted light from the light source onto a disk-type optical recording medium, a diffraction optical element provided between the light source and the objective lens, and a photodetector for receiving reflected light from the optical recording medium. The optical head uses, as the optical recording medium, a first optical recording medium having grooves with a first pitch for forming a track and a second optical recording medium having grooves with a second pitch for forming a track. The diffraction optical element has a function of generating, from the emitted light from the light source, a main beam, a first sub-beam group having an intensity distribution that corresponds to the first optical recording medium, and a second sub-beam group having an intensity distribution that corresponds to the second optical recording medium, which are converged on the optical recording medium by the objective lens. The photodetector has a first light-receiving part group for receiving reflected light of the main beam that is reflected by the optical recording medium, a second light-receiving part group for receiving reflected light of the first sub-beam group that is reflected by the optical recording medium, and a third light-receiving part group for receiving reflected light of the second sub-beam group that is reflected by the optical recording medium. For example, the intensity distribution of the first sub-beam group may be so set that the absolute value of the radial tilt error signal of the first optical recording medium becomes the maximum, and the intensity distribution of the second sub-beam group may be so set that the absolute value of the radial tilt error signal of the second optical recording medium becomes the maximum.

A second optical head according to the present invention includes a light source, an objective lens for converging emitted light from the light source onto a disk-type optical recording medium, a diffraction optical element provided between the light source and the objective lens, and a photodetector for receiving reflected light from the optical recording medium. The optical head uses, as the optical recording medium, a first optical recording medium having grooves with a first pitch for forming a track and a second optical recording medium having grooves with a second pitch for forming a track. The diffraction optical element has a function of generating, from the emitted light from the light source, a main beam and a first sub-beam group, which are converged on the optical recording medium by the objective lens. The photodetector has a first light-receiving part group for receiving reflected light of the main beam that is reflected by the optical recording medium, and a second light-receiving part group for receiving reflected light of the first sub-beam group that is reflected by the optical recording medium. The optical head further includes an intensity distribution changing device which cooperates with the diffraction optical element to change an intensity distribution of the first sub-beam group either to an intensity distribution corresponding to the first optical recording medium or to an intensity distribution corresponding to the second optical recording medium. For example, the intensity distribution of the first sub-beam group may be so set that the absolute value of the radial tilt error signal of the first optical recording medium becomes the maximum, and the intensity distribution of the second sub-beam group may be so set that the absolute value of the radial tilt error signal of the second optical recording medium becomes the maximum.

In other words, the first optical head according to the present invention is used at least for a first disk-type optical recording medium having grooves with a first pitch for forming a track and a second disk-type optical recording medium having grooves with a second pitch for forming a track as target optical recording media. The optical head includes a light source, an objective lens for converging emitted light from the light source onto a disk-type optical recording medium, a diffraction optical element provided between the light source and the objective lens, and a photodetector for receiving reflected light from the optical recording medium. The diffraction optical element has a function of generating, from the emitted light from the light source, at least a main beam, a first sub-beam group, and a second sub-beam group each having different intensity distributions normalized by the intensity on the optical axis, which are converged by the objective lens on the optical recording medium. The light-receiving parts of the photodetector include a first light-receiving part group for receiving reflected light of the main beam that is reflected by the optical recording medium in order to detect the push-pull signals at least for the first and second optical recording media, a second light-receiving part group for receiving reflected light of the first sub-beam group that is reflected by the optical recording medium in order to detect the push-pull signal at least for the first optical recording medium, and a third light-receiving part group for receiving reflected light of the second sub-beam group that is reflected by the optical recording medium in order to detect the push-pull signal at least for the second optical recording medium.

A first optical information recording/reproducing device according to the present invention includes: the above-described first optical head according to the present invention; a device which detects a push-pull signal at least for the first and second optical recording media from outputs of the first light-receiving part group; a device which detects a push-pull signal at least for the first optical recording medium from outputs of the second light-receiving part group; a device which detects a push-pull signal at least for the second optical recording medium from outputs of the third light-receiving part group; and a device which detects a radial tilt error signal indicating radial tilt of the optical recording medium based on the push-pull signal detected from the outputs of the second light-receiving part group when the optical recording medium is the first optical recording medium, and detects a radial tilt error signal indicating radial tilt of the optical recording medium based on the push-pull signal detected from the outputs of the third light-receiving part group when the optical recording medium is the second optical recording medium.

A second optical head according to the present invention uses at least a first disk-type optical recording medium having grooves with a first pitch for forming a track and a second disk-type optical recording medium having grooves with a second pitch for forming a track as target optical recording media. The optical head includes a light source, an objective lens for converging emitted light from the light source onto a disk-type optical recording medium, a diffraction optical element provided between the light source and the objective lens, and a photodetector for receiving reflected light from the optical recording medium. The diffraction optical element has a function of generating, from the emitted light from the light source, at least a main beam and a first sub-beam group having different intensity distributions normalized by the intensity on the optical axis, which are converged by the objective lens on the optical recording medium. The light-receiving parts of the photodetector include a first light-receiving part group for receiving reflected light of the main beam that is reflected by the optical recording medium in order to detect the push-pull signals at least for the first and second optical recording media, and a second light-receiving part group for receiving reflected light of the first sub-beam group that is reflected by the optical recording medium in order to detect the push-pull signal at least for the first and second optical recording media. The optical head further includes an intensity distribution changing device which cooperates with the diffraction optical element to change an intensity distribution of the first sub-beam group between an intensity distribution corresponding to the first optical recording medium and an intensity distribution corresponding to the second optical recording medium.

A second optical information recording/reproducing device according to the present invention includes: the above-described second optical head according to the present invention; a device which detects a push-pull signal at least for the first and second optical recording media from outputs of the first light-receiving part group; and a device which detects a push-pull signal at least for the first and second optical recording media from outputs of the second light-receiving part group; and a device which changes the intensity distribution of the first sub-beam group to the first intensity distribution by the intensity distribution changing device and detects a radial tilt error signal indicating radial tilt of the optical recording medium based on the push-pull signal detected from the outputs of the second light-receiving part group when the optical recording medium is the first optical recording medium, and changes the intensity distribution of the first sub-beam group to the second intensity distribution by the intensity distribution changing device and detects a radial tilt error signal indicating radial tilt of the optical recording medium based on the push-pull signal detected from the outputs of the second light-receiving part group when the optical recording medium is the second optical recording medium.

With the first optical head and optical information recording/reproducing device according to the present invention, for the first optical recording medium, the push-pull signal is detected from the outputs of the second light-receiving part group that receives the reflected light of the first sub-beam group reflected by the optical recording medium, and the radial tilt error signal is detected based on the push-pull signal. In the meantime, for the second optical recording medium, the push-pull signal is detected from the outputs of the third light-receiving part group that receives the reflected light of the second sub-beam group reflected by the optical recording medium, and the radial tilt error signal is detected based on the push-pull signal. The intensity distribution of the first sub-beam group can be so set that the absolute value of the radial tilt error signal for the first optical recording medium becomes the maximum, and the intensity distribution of the second sub-beam group can be so set that the absolute value of the radial tilt error signal for the second optical recording medium becomes the maximum. Therefore, the radial tilt can be detected with high sensitivity for both of the two kinds of optical recording media having different groove pitches.

With the second optical head and optical information recording/reproducing device according to the present invention, for the first optical recording medium, the intensity distribution of the first sub-beam group is set as the first intensity distributions the push-pull signal is detected from the outputs of the second light-receiving part group that receives the reflected light of the first sub-beam group reflected by the optical recording medium, and the radial tilt error signal is detected based on the push-pull signal. In the meantime, for the second optical recording medium, the intensity distribution of the first sub-beam group is set as the second intensity distribution, the push-pull signal is detected from the outputs of the second light-receiving part group that receives the reflected light of the first sub-beam group reflected by the optical recording medium, and the radial tilt error signal is detected based on the push-pull signal. The first intensity distribution can be so set that the absolute value of the radial tilt error signal for the first optical recording medium becomes the maximum, and the second intensity distribution can be so set that the absolute value of the radial tilt error signal for the second optical recording medium becomes the maximum. Therefore, the radial tilt can be detected with high sensitivity for both of the two kinds of optical recording media having different groove pitches.

As described above, the effect of the optical head and the optical information recording/reproducing device according to the present invention is that it is possible to detect signals with high sensitivity for both of the two kinds of optical recording media having different groove pitches. The reason for enabling it is that the different sub-beam groups of corresponding intensity distributions are used for each of the optical recording media.

For example, if the signal is the radial tilt error signal, it is possible to detect the radial tilt with high sensitivity for both of the two kinds of optical recording media having different groove pitches. It is because the present invention uses the sub-beam groups whose intensity distributions are so set that the absolute value of the radial tilt error signal becomes the maximum for the respective optical recording media.

### BEST MODE FOR CARRYING OUT THE INVENTION

Exemplary embodiments of the present invention will be described hereinafter by referring to the accompanying drawings.

FIG. 1 shows a first exemplary embodiment of an optical head according to the present invention. Emitted light from a semiconductor laser 1 is parallelized by a collimator lens 2, and it is divided by diffraction optical element 3a, 3b into five light beams in total, i.e., a single ray of transmission light as a main beam, two rays of diffraction light as first sub-beams, and two rays of diffraction light as second sub-beams. The main beam is the transmission light from the diffraction optical element 3b out of the transmission light from the diffraction optical element 3a/the first sub-beams are the transmission light from the diffraction optical element 3b out of the positive and negative first order diffracted lights from the diffraction optical element 3a, and the second sub-beams are the positive and negative first order diffracted lights from the diffraction optical element 3b out of the transmission light from the diffraction optical element 3a. These light beams make incident on a polarizing beam splitter 4 as P-polarized light, and almost 100% thereof transmit therethrough. The light beams then transmit through a quarter wavelength plate 5, which are converted to circularly polarized light from linearly polarized light, and converged by an objective lens 6 onto a disk 7. The five reflected light beams from the disk 7 transmit the objective lens 6 from an inverse direction, which transmit the quarter wavelength plate 5 and are then converted from the circularly polarized light to linearly polarized light whose polarizing direction is orthogonal to the outward path. The linearly polarized light makes incident on the polarizing beam splitter 4 as S-Polarized light, and almost 100% thereof is reflected thereby, which transmits through a cylindrical lens 8 and a convex lens 9. Then, it is received by a photodetector 10a. The photodetector 10a is deposited in the middle of two caustic curves of the cylindrical lens 8 and the convex lens 9. The semiconductor laser 1 and the disk 7 correspond to “light source” and “optical recording medium” depicted in the appended claims, respectively.

FIG. 2A is a plan view of the diffraction optical element 3a. The diffraction optical element 3a is formed in a structure in which a diffraction grating is formed only in a region 13a on the inner side of a circle that has a smaller diameter than an effective diameter 6a of the objective lens 6 illustrated with a dotted line in the drawing. The grating direction in the diffraction grating is in parallel to the radial direction of the disk 7, and the pattern of the grating is in a linear form of an equivalent pitch. For example, about 87.3% of the light making incident on the inside the region 13a transmits therethrough as zeroth order light, and about 5.1% each is diffracted as the positive and negative first order diffracted light. Further, almost 100% of the light making incident on the outer side of the region 53a transmits therethrough.

FIG. 2B is a plan view of the diffraction optical element 3b. The diffraction optical element 3b is formed in a structure in which a diffraction grating is formed only in a region 13b on the inner side of a circle that has a smaller diameter than the effective diameter 6a of the objective lens 6 illustrated with a dotted line in the drawing. The grating direction in the diffraction grating is in parallel to the radial direction of the disk 7, and the pattern of the grating is in a linear form of an equivalent pitch. For example, about 87.3% of the light making incident on the inside the region 13b transmits therethrough as zeroth order light, and about 5.1% each is diffracted as the positive and negative first order diffracted light. Further, almost 100% of the light making incident on the outer side of the region 13b transmits therethrough.

The pitch of the grating in the diffraction grating formed in the region 13a of the diffraction optical element 3a is wider than that of the diffraction grating formed in the region 13b of the diffraction optical element 3b. Further, the diameter of the region 13a of the diffraction optical element 3a is larger than that of the region 13b of the diffraction optical element 3b. Here, the main beam contains both the light transmitted through the inside the region 13a of the diffraction optical element 3a and the light transmitted through the outer side thereof, and both the light transmitted through the inside the region 13b of the diffraction optical element 3b and the light transmitted through the outer side thereof. The first sub-beams contain only the light diffracted on the inside the region 13a of the diffraction optical element 3a. The second sub-beams contain only the light diffracted on the inside the region 13b of the diffraction optical element 3b. As a result, the intensity of the peripheral part of the first sub-beams becomes weaker than that of the main beam, and the intensity of the peripheral part of the second sub-beams becomes weaker than that of the first sub-beams.

The order of the diffraction optical elements 3a and 3b may be inverted. Further, instead of the diffraction optical gratings 3a and 3b, it is also possible to use a single diffraction optical element including one of those diffraction gratings shown in FIG. 2A and in FIG. 2B formed on the incident face, and the other formed on the exit face.

FIG. 3 shows the layout of the light focusing spots on the disk 7. FIG. 3A shows a case where the groove pitch of the disk 7 is narrow, and FIG. 3B shows a case where the groove pitch of the disk 7 is wide. The light focusing spots 23a, 23b, 23c, 23d, and 23e correspond to the transmission light from the diffraction optical element 3b out of the transmission light from the diffraction optical element 3a, to the transmission light from the diffraction optical element 3b out of the positive first order diffracted light from the diffraction optical element 3a, to the transmission light from the diffraction optical element 3b out of the −1st diffraction light from the diffraction optical elements 3a, to the positive first order diffracted light from the diffraction optical element 3b out of the transmission light from the diffraction optical element 3a, and to the −1st diffraction light from the diffraction optical elements 3b out of the transmission light from the diffraction optical element 3a, respectively. The light focusing spots 23a, 23b, 23c, 23d, and 23e are arranged on a same track 22a in FIG. 3A, and the light focusing spots 23a, 23b, 23c, 23d, and 23e are arranged on a same track 22b in FIG. 3B. The light focusing spots 23b and 23c as the first sub-beams have a larger diameter than the light focusing spot 23a as the main beam. Further, the light focusing spots 23d and 23e as the second sub-beams have a larger diameter than the light focusing spots 23b and 23c as the first sub-beams.

FIG. 4 shows a pattern of a light-receiving part of the photodetector 10a and layout of the optical spots on the photodetector 10a. The optical spot 27a corresponds to transmission light from the diffraction optical element 3b out of the transmission light from the diffraction optical element Sa, and it is received by light-receiving parts 26a-26d which are divided into four by a dividing line that is in parallel to the tangential direction of the disk 7 passing through the optical axis and by a dividing line that is in parallel to the radial direction. The optical spot 27b corresponds to the transmission light from the diffraction optical element 3b out of the positive first order diffracted light from the diffraction optical element Sa, and it is received by light-receiving parts 26e and 26f which are divided into two by a dividing line that is in parallel to the radial direction of the disk 7 passing through the optical axis. The optical spot 27c corresponds to the transmission light from the diffraction optical element 3b out of the −1st diffraction light from the diffraction optical element 3a, and it is received by light-receiving parts 26g and 26h which are divided into two by a dividing line that is in parallel to the radial direction of the disk 7 passing through the optical axis. The optical spot 27d corresponds to the positive first order diffracted light from the diffraction optical element 3b out of the transmission light from the diffraction optical element 3a, and it is received by light-receiving parts 26i and 26j which are divided into two by a dividing line that is in parallel to the radial direction of the disk 7 passing through the optical axis. The optical spot 27e corresponds to the −1st diffraction light from the diffraction optical element 3b out of the transmission light from the diffraction optical element 3a, and it is received by light-receiving parts 26k and 26l which are divided into two by a dividing line that is in parallel to the radial direction of the disk 7 passing through the optical axis. The intensity distribution in the tangent direction of the disk 7 and the intensity distribution in the radial direction are switched from each other in the optical spots 27a-27e, because of the effects of the cylindrical lens 8 and the convex lens 9. The light-receiving parts 26a-26d, the light-receiving parts 26e-26h, and the light-receiving parts 26i-26l correspond to “first light-receiving part group”, “second light-receiving part group”, and “third light-receiving part group” depicted in the appended claims, respectively.

When outputs from the light-receiving parts 26a-26l are expressed as V26a-V26l, respectively, a focus error signal can be obtained by an arithmetic operation of (V26a+V26d)-(V26b+V26c) based on the astigmatism method. A push-pull signal by the main beam can be given by (V26a+V26b)-(V26c+V26d), a push-pull signal by the first sub-beams can be given by (V26e+V26g)-(V26f+V26h), and a push-pull signal by the second sub-beams can be given by (V26i+V26k) (V26j+V26l). The push-pull signal by the main beam is used as a track error signal. The RF signal recorded in the disk 7 can be obtained by an arithmetic operation of (V26a+V26b+V26c+V26d).

FIG. 5 shows various push-pull signals related to detection of radial tilt. The lateral axis in the drawing is a detrack amount of the light focusing spot, and the longitudinal axis is the push-pull signal. The push-pull signal 37a shown in FIG. 5A is a push-pull signal by the main beam and a push-pull signal by the first or the second sub-beams, when there is no radial tilt in the disk 7. In the meantime, the push-pull signals 37b and 37c shown in FIG. 5B are a push-pull signal by the main beam and a push-pull signal by the first or second sub-beams, respectively, when there is a positive radial tilt in the disk 7. Further, the push-pull signals 37d and 37e shown in FIG. 5C are a push-pull signal by the main beam and a push-pull signal by the first or second sub-beams, respectively, when there is a negative radial tilt in the disk 7. The position where the push-pull signal by the main beam cross at 0-point from the negative side to the positive side corresponds to a land, and the position where the push-pull signal crosses at 0-point from the positive side to the negative side corresponds to a groove.

When there is no radial tilt in the disk 7, the zero-cross point of the push-pull signal by the first or the second sub-beams is consistent with that of the push-pull signal by the main beam. Thus, the push-pull signal is “0” in both the land and the groove. In the meantime, when there is a positive radial tilt in the disk 7, the zero-cross point of the push-pull signal by the first or second sub-beams is shifted to the left side of the drawing with respect to that of the push-pull signal by the main beam. Thus, the push-pull signal becomes positive in the land and becomes negative in the groove. Further, when there is a negative radial tilt in the disk 7, the zero-cross point of the push-pull signal by the first or second sub-beams is shifted to the right side of the drawing with respect to that of the push-pull signal by the main beam. Thus, the push-pull signal becomes negative in the land and becomes positive in the groove. Therefore, the push-pull signal by the first or second sub-beams under track-servo can be used as a radial tilt error signal.

In this exemplary embodiment, when the groove pitch of the disk 7 is narrow, the push-pull signal by the first sub-beams under track-servo is used as a radial tilt error signal. When the groove pitch of the disk 7 is wide, the push-pull signal by the second sub-beams under track-servo is used as a radial tilt error signal. The NA for the first sub-beams depends on the diameter of the region 13a of the diffraction optical element 3a, and the NA for the second sub-beams depends on the diameter of the region 13b of the diffraction optical element 3b. Here, the NA for the first sub-beams is so set that the absolute value of the radial tilt error signal for the disk having a narrow groove pitch becomes the maximum, and the NA for the second sub-beams is so set that the absolute value of the radial tilt error signal for the disk having a wide groove pitch becomes the maximum. Specifically, when the disk 7 is an HD DVD-R with a narrow groove pitch, the NA for the first sub-beams is set as 0.6. When the disk 7 is an HD DVD-RW with a wide groove pitch, the NA for the second sub-beam is set as 0.52-0.53. This makes it possible to detect the radial tilt with high sensitivity for both of the two kinds of disks having different groove pitches.

A second exemplary embodiment of the optical head according to the invention is obtained by replacing the diffraction optical elements 3a, 3b of the first exemplary embodiment with diffraction elements 3c, 3d shown in FIG. 6A, respectively.

FIG. 6A is a plan view of the diffraction optical element 3c. The diffraction optical element 3c is formed in a structure in which a diffraction grating is formed only in a region 13c on the inner side of a band that has a smaller width than the effective diameter 6a of the objective lens 6 illustrated with a dotted line in the drawing. The grating direction in the diffraction grating is in parallel to the radial direction of the disk 7, and the pattern of the grating is in a linear form of an equivalent pitch. The zeroth order light as well as the positive and negative first order diffracted light is generated from the light making incident on the inside the region 13c, and the light making incident on the outer side of the region 13c transmits therethrough.

FIG. 6B is a plan view of the diffraction optical element 3d. The diffraction optical element 3d is formed in a structure in which a diffraction grating is formed only in a region 13d on the inner side of a band that has a smaller width than the effective diameter 6a of the objective lens G illustrated with a dotted line in the drawing. The grating direction in the diffraction grating is in parallel to the radial direction of the disk 7, and the pattern of the grating is in a linear form of an equivalent pitch. The zeroth order light as well as the positive and negative first order diffracted light is generated from the light making incident on the inside the region 13d, and the light making incident on the outer side of the region 13d transmits therethrough.

The pitch of the grating in the diffraction grating formed in the region 13c of the diffraction optical element 3c is wider than that of the diffraction grating formed in the region 13d of the diffraction optical element 3d. Further, the width of the region 13c of the diffraction optical element 3c is wider than that of the region 13d of the diffraction optical element 3d. As a result, the intensity of the first sub-beams in the peripheral part in the radial direction of the disk 7 becomes weaker than that of the main beam, and the intensity of the second sub-beams in the peripheral part in the radial direction of the disk 7 becomes weaker than that of the first sub-beams.

The order of the diffraction optical elements 3c and 3d may be inverted. Further, instead of the diffraction optical elements 3d, 3d, it is also possible to use a single diffraction optical element including one of those diffraction gratings shown in FIG. 6A and FIG. 6B formed on the incident face, and the other formed on the exit face.

As in the case of the first exemplary embodiment, a single light focusing spot as the main beam, two light focusing spots as the first sub-beams, and two light focusing spots as the second sub-beams of are disposed on a same track of the disk 7 in this exemplary embodiment.

The pattern of the light-receiving parts of a photodetector and the layout of the optical spots on the photodetector according to this exemplary embodiment are the same as those shown in FIG. 4. With this exemplary embodiment, a focus error signal, a push-pull signal by the main beam used as the track error signal, a push-pull signal by the first sub-beams, and a push-pull signal by the second sub-beams, as well as a RF signal recorded in the disk 7 can be obtained, as in the case of the first exemplary embodiment.

Various push-pull signals related to detection of the radial tilt according to this exemplary embodiment are the same as those shown in FIG. 5. In this exemplary embodiment, the push-pull signal by the first or second sub-beam under track-servo can be used as the radial tilt error signal, as in the case of the first exemplary embodiment.

In this exemplary embodiment, the NA in the radial direction of the disk 7 for the first sub-beams depends on the width of the region 12c of the diffraction optical element 3c, and the NA in the radial direction of the disk 7 for the second sub-beams depends on the width of the region 13d of the diffraction optical element 3c. Here, the NA for the first sub-beams is so set that the absolute value of the radial tilt error signal for the disk having a narrow groove pitch becomes the maximum, and the NA for the second sub-beams is so set that the absolute value of the radial tilt error signal for the disk having a wide groove pitch becomes the maximum. This makes it possible to detect the radial tilt with high sensitivity for both of the two kinds of disks having different groove pitches.

A third exemplary embodiment of the optical head according to the present invention is obtained by replacing the diffraction optical elements 3a, 3b of the first exemplary embodiment with a single diffraction element 3e that is shown in FIG. 7.

Emitted light from a semiconductor laser 1 is divided by the diffraction optical element 3e into five light beams in total, i.e., a single ray of transmission light as a main beam, two rays of diffraction light as first sub-beams, and two rays of diffraction light as second sub-beams. The main beam is the transmission light from the diffraction optical element 3e, the first sub-beams are the positive and negative first order diffracted lights from the diffraction optical element 3e, and the second sub-beams are the positive and negative second order diffracted light from the diffraction optical element 3e.

FIG. 7 is a plan view of the diffraction optical element 3e. The diffraction optical element 3e is formed in a structure in which a diffraction grating is formed only in regions 13f and 13e. The region 13f is between a first circle having a smaller diameter than the effective diameter 6a of the objective lens 6 illustrated with a dotted line in the drawing and a second circle having a smaller diameter than that of the first circle. The region 13e is on the inner side of the second circle. The grating direction in the diffraction grating is in parallel to the radial direction of the disk 7, and the pattern of the grating is in a linear form of an equivalent pitch. The pitch of the grating in the region 13e and the pitch of the grating in the region 13f are equivalent. For example, about 80.0% of the light making incident on the region 13e transmits therethrough as zeroth order light, about 3.2% each is diffracted as the positive and negative first order diffracted light, and bout 3.0% each is diffracted as the positive and negative second order diffracted light. About 91.0% of the light making incident on the region 13f transmits therethrough as zeroth order light, and about 3.6% each is diffracted as the positive and negative first order diffracted light. Further, almost 100% of the light making incident on the outer side of the regions 13e and 13f transmits therethrough. Here, the main beam contains all of the light transmitted through the inside of the region 13e, the light transmitted through the region 13f, and the light transmitted through the outer side of the regions 13e and 13f. The first sub-beams contain only the light diffracted on the region 13e and the light diffracted on the region 13f. The second sub-beams contain only the light diffracted on the region 13e. As a result, the intensity of the peripheral part of the first sub-beams becomes weaker than that of the main beam, and the intensity of the peripheral part of the second sub-beams becomes weaker than that of the first sub-beams.

As in the case of the first exemplary embodiment, a single light focusing spot as the main beam, two light focusing spots as the first sub-beams, and two light focusing spots as the second sub-beams are disposed on a same track of the disk 7 in the this exemplary embodiment.

The pattern of the light-receiving parts of a photodetector and the layout of the optical spots on the photodetector according to this exemplary embodiment are the same as those shown in FIG. 4. With this exemplary embodiment, a focus error signal, a push-pull signal by the main beam used as a track error signal, a push-pull signal by the first sub-beams, and a push-pull signal by the second sub-beams, as well as a RF signal recorded in the disk 7 can be obtained, as in the case of the first exemplary embodiment.

Various push-pull signals related to detection of the radial tilt according to this exemplary embodiment are the same as those shown in FIG. 5. In this exemplary embodiment, the push-pull signal by the first or second sub-beams under track-servo can be used as the radial tilt error signal, as in the case of the first exemplary embodiment.

In this exemplary embodiment, the NA for the first sub-beams is depends on the diameter of the region 13f of the diffraction optical element 3e, and the NA for the second sub-beams is depends on the diameter of the region 13e of the diffraction optical element 3e. Here, the NA for the first sub-beams is so set that the absolute value of the radial tilt error signal for the disk having a narrow groove pitch becomes the maximum, and the NA for the second sub-beams is so set that the absolute value of the radial tilt error signal for the disk having a wide groove pitch becomes the maximum. This makes it possible to detect the radial tilt with high sensitivity for both of the two kinds of disks having different groove pitches.

A fourth exemplary embodiment of the optical head according to the present invention is obtained by replacing the diffraction optical element 3e of the third exemplary embodiment with a diffraction optical element 3f that is shown in FIG. 8.

FIG. 8 is a plan view of the diffraction optical element 3f. The diffraction optical element 3f Is formed in a structure in which a diffraction grating is formed only in regions 13h and 13g. The region 13h is between a first band having a smaller width than the effective diameter Ca of the objective lens 6 illustrated with a dotted line in the drawing and a second band having a smaller width than that of the first band. The region 13g is on the inner side of the second band. The pitch of the a grating in the region 13g and the pitch of the grating in the region 13h are equivalent. The light making incident on the region 13g generates zeroth order light, positive and negative first order diffracted light, and positive and negative second order diffracted light, and the light making incident on the region 13h generates zeroth order light and positive and negative first order diffracted light. As a result, the intensity of the peripheral part of the first sub-beams in the radial direction of the disk 7 becomes weaker than that of the main beam, and the intensity of the peripheral part of the second sub-beams in the radial direction of the disk 7 becomes weaker than that of the first sub-beams.

As in the case of the first exemplary embodiment, a single light focusing spot as the main beam, two light focusing spots as the first sub-beams, and two light focusing spots as the second sub-beams of the third exemplary embodiment are disposed on a same track of the disk 7.

The pattern of the light-receiving parts and the layout of the optical spots on a photodetector according to this exemplary embodiment are the same as those shown in FIG. 4. With this exemplary embodiment, a focus error signal, a push-pull signal by the main beam used as a track error signal, a push-pull signal by the first sub-beams, and a push-pull signal by the second sub-beams, as well as a RF signal recorded in the disk 7 can be obtained, as in the case of the first exemplary embodiment.

Various push-pull signals related to detection of the radial tilt according to this exemplary embodiment are the same as those shown in FIG. 5. In this exemplary embodiment, the push-pull signal by the first or second sub-beams under track-servo can be used as the radial tilt error signal, as in the case of the first exemplary embodiment.

In this exemplary embodiment, the NA in the radial direction of the disk 7 for the first sub-beams depends on the width of the region 13h of the diffraction optical element 3f, and the NA in the radial direction of the disk 7 for the second sub-beams depends on the width of the region 13g of the diffraction optical element 3f. Here, the NA in the radial direction of the disk 7 for the first sub-beams is so set that the absolute value of the radial tilt error signal for the disk having a narrow groove pitch becomes the maximum, and the NA in the radial direction of the disk 7 for the second sub-beams is so set that the absolute value of the radial tilt error signal for the disk having a wide groove pitch becomes the maximum. This makes it possible to detect the radial tilt with high sensitivity for both of the two kinds of disks having different groove pitches.

FIG. 9 shows a fifth exemplary embodiment of the optical head according to the invention. This exemplary embodiment is obtained by adding diffraction optical elements 3g, 3h between the diffraction optical elements 3a, 3b and the polarizing beam splitter 4 of the first exemplary embodiment, and the photodetector 10a is replaced with a photodetector 10b.

Emitted light from a semiconductor laser 1 is divided by diffraction optical elements 3a, 3b, 3g, and 3h into nine light beams in total, i.e., a single ray of transmission light as a main beam, two rays of diffraction light as first sub-beams, two rays of diffraction light as second sub-beams, two rays of diffraction light as third sub-beams, and two rays of diffraction light as fourth sub-beams. The main beam is the transmission light from the diffraction optical elements 3a, 3b, 3g, and 3h, the first sub-beams are the positive and negative first order diffracted lights from the diffraction optical element 3a that are the transmission light from the diffraction optical elements 3b, 3g, and 3h, the second sub-beams are the positive and negative first order diffracted lights from the diffraction optical element 3b that are the transmission light from the diffraction optical elements 3a, 3g, and 3h, the third sub-beams are the positive and negative first order diffracted lights from the diffraction optical element 3g that are the transmission light from the diffraction optical elements 3a, 3b, and 3h, and the fourth sub-beams are the positive and negative first order diffracted lights from the diffraction optical element 3h that are the transmission light from the diffraction optical elements 3a, 3b, and 3g.

Plan views of the diffraction optical elements 3a and 3b of this exemplary embodiment are same as those shown in FIG. 2A and FIG. 2B, respectively. However, the direction of the grating in the diffraction grating formed in the region 13a of the diffraction optical element 3a and formed in the region 13b of the diffraction optical element 3b is tilted slightly with respect to the radial direction of the disk 7.

FIG. 10A is a plan view of the diffraction optical element 3g. The diffraction optical element 3g is formed in a structure in which a diffraction grating is formed on the whole surface including an effective diameter 6a of the objective lens 6 that is illustrated with a dotted line in the drawing. The grating direction in the diffraction grating is tilted slightly with respect to the radial direction of the disk 7, and the pattern of the grating is in a linear form of an equivalent pitch. For example, about 87.3% of the light making incident on the diffraction optical element 3g transmits therethrough as zeroth order light, and about 5.1% each is diffracted as the positive and negative first order diffracted light.

FIG. 10f is a plan view of the diffraction optical element 3h. The diffraction optical element 3h is formed in a structure in which a diffraction grating is formed on the whole surface including the effective diameter 6a of the objective lens 6 that is illustrated with a dotted line in the drawing. The grating direction in the diffraction grating is tilted slightly with respect to the radial direction of the disk 7, and the pattern of the grating is in a linear form of an equivalent pitch. For example, about 87.3% of the light making incident on the diffraction optical element 3h transmits therethrough as zeroth order light, and about 5.1% each is diffracted as the positive and negative first order diffracted light.

The pitch of the grating in the diffraction grating formed on the whole surface of the diffraction optical element 3g, the pitch of the grating of the diffraction grating formed on the whole surface of the diffraction optical element 3h, the pitch of the grating of the diffraction grating formed in the region 13a of the diffraction optical element 3a, and the pitch of the grating of the diffraction grating formed in the region 13b of the diffraction optical element 3b become narrower in this order. Here, the main beam, the third sub-beams, and the fourth sub-beams contain both the light transmitted through the inside the region 13a of the diffraction optical element 3a and the light transmitted through the outer side thereof, and both the light transmitted through the inside the region 13b of the diffraction optical element 3b and the light transmitted through the outer side thereof. The first sunbeams contain only the light diffracted on the inside the region 1a of the diffraction optical element 3a. The second sub-beams contain only the light diffracted on the inside the region 13b of the diffraction optical element 3b. As a result, the intensity distribution of the third and fourth sub-beams becomes the same as that of the main beam, the intensity of the first sub-beams in the peripheral part becomes weaker than that of the main beam, and the intensity of the second sub-beams in the peripheral part becomes weaker than that of the first sub-beams.

The order of the diffraction optical elements 3g and 3h may be inverted. Further, instead of the diffraction optical elements 3g and 3h, it is also possible to use a single diffraction optical element including one of those diffraction gratings shown in FIG. 10A and FIG. 10B formed on the incident face, and the other formed on the exit face. Furthermore, the order of the diffraction optical elements 3a, 3b and the diffraction optical elements 3g, 3h may be inverted. Moreover, the diffraction optical elements 3a and 3b may be replaced with the diffraction optical elements 3c and 3d, respectively.

FIG. 11 shows the layout of the light focusing spots on the disk 7. FIG. 11A shows a case where the groove pitch of the disk 7 is narrow, and FIG. 11B shows a case where the groove pitch of the disk 7 is wide. The light focusing spots 23a, 23f, 23g, 23h, 23i, 23j, 23k, 23l, and 23m correspond, respectively, to the transmission light from the diffraction optical elements 3a, 3b, 3g, and 3h, to the positive first order diffracted light from the diffraction optical element 3a that is the transmission light from the diffraction optical elements 3b, 3g, and 3b, to the negative first order diffracted light from the diffraction optical element 3a that is the transmission light from the diffraction optical elements 3b, 3g, and 3h, to the positive first order diffracted light from the diffraction optical element 3b that is the transmission light from the diffraction optical elements 3a, 3g, and 3h, to the negative first order diffracted light from the diffraction optical element 3b that is the transmission light from the diffraction optical elements 3a, 3g, and 3h, to the positive first order diffracted light from the diffraction optical element 3g that is the transmission light from the diffraction optical elements 3a, 3b, and 3h, to the negative first order diffracted light from the diffraction optical element 3g that is the transmission light from the diffraction optical elements 3a, 3b, and 3h, to the positive first order diffracted light from the diffraction optical element 3h that is the transmission light from the diffraction optical elements 3a, 3b, and 3g, and to the negative first order diffracted light from the diffraction optical element 3h that is the transmission light from the diffraction optical elements 3a, 3b, and 3g.

In FIG. 11A, the light focusing spot 25a is on a track 22a (land or groove), the light focusing spot 23j is on a track (groove or land) right next to the track 22a on the right side, the light focusing spot 23k is on a track (groove or land) right next to the track 22a on the left side, the light focusing spot 23f is on a second track (land or groove) from the track 22a on the right side, and the light focusing spot 23g is on a second track (land or groove) from the track 22a on the left side. In FIG. 11B, the light focusing spot 23a is on a track 22b (land or groove), the light focusing spot 23i is on a track (groove or land) right next to the track 22b on the right side, the light focusing spot 23m is on a track (groove or land) right next to the track 22b on the left side, the light focusing spot 23h is on a second track (land or groove) from the track 22b on the right side, and the light focusing spot 23i is on a second track (land or groove) from the track 22b on the left side. The light focusing spots 23j, 23k as the third sub-beams and the convergence pots 23l, 23m as the fourth sub-beams have the same diameter as that of the light focusing spot 23a as the main beam. The light focusing spots 23f, 23g as the first sub-beams have the larger diameter than that of the light focusing spot 23a as the main beam. Further, the light focusing spots 23h, 23i as the second sub-beams have the larger diameter than that of the light focusing spots 23f, 23g as the first sub-beams.

FIG. 12 shows a pattern of a light-receiving part of the photodetector 10b and layout of optical spots on the photodetector 10b. The optical spot 29a corresponds to transmission light from the diffraction optical elements 3a, 3b, 3g, and 3h, and it is received by light-receiving parts 28a-28d which are divided into four by a dividing line that is in parallel to the tangential direction of the disk 7 passing through the optical axis and by a dividing line that is in parallel to the radial direction. The optical snot 29b corresponds to the positive first order diffracted light from the diffraction optical element 3a that is the transmission light from the diffraction optical elements 3b, 3g, and 3h, and it is received by light-receiving parts 28e and 28f which are divided into two by a dividing line that is in parallel to the radial direction of the disk 7 passing through the optical axis. The optical spot 29c corresponds to the negative first order diffracted light from the diffraction optical element 3a that is the transmission light from the diffraction optical elements 3b, 3g, and 3f, and it is received by light-receiving parts 28g and 28h which are divided into two by a dividing line that is in parallel to the radial direction of the disk 7 passing through the optical axis. The optical spot 29d corresponds to the positive first order diffracted light from the diffraction optical element 3b that is the transmission light from the diffraction optical elements 3a, 3g, and 3h, and it is received by light-receiving parts 28i and 28j which are divided into two by a dividing line that is in parallel to the radial direction of the disk 7 passing through the optical axis. The optical spot 29e corresponds to the negative first order diffracted light from the diffraction optical element 3b that is the transmission light from the diffraction optical elements 3a, 3g, and 3h, and it is received by light-receiving parts 28k and 28l which are divided into two by a dividing line that is in parallel to the radial direction of the disk 7 passing through the optical axis. The optical spot 29f corresponds to the positive first order diffracted light from the diffraction optical element 3g that is the transmission light from the diffraction optical elements 3a, 3b, and 3h, and it is received by light-receiving parts 23m and 28n which are divided into two by a dividing line that is in parallel to the radial direction of the disk 7 passing through the optical axis. The optical spot 29g corresponds to the negative first order diffracted light from the diffraction optical element 3g that is the transmission light from the diffraction optical elements 3a, 3b, and 3h, and it is received by light-receiving parts 28o and 28p which are divided into two by a dividing line that is in parallel to the radial direction of the disk 7 passing through the optical axis. The optical spot 29h corresponds to the positive first order diffracted light from the diffraction optical element 3h that is the transmission light from the diffraction optical elements 3a, 3b, and 3g, and it is received by light-receiving parts 28q and 28r which are divided into two by a dividing line that is in parallel to the radial direction of the disk 7 passing through the optical axis. The optical spot 29i corresponds to the negative first order diffracted light from the diffraction optical element 3h that is the transmission light from the diffraction optical elements 3a, 3b, and 3g, and it is received by light-receiving parts 28s and 28t which are divided into two by a dividing line that is in parallel to the radial direction of the disk 7 passing through the optical axis. The intensity distribution in the tangential direction of the disk 7 and the intensity distribution in the radial direction are switched from each other in the optical spots 29a-29i, because of the effects of the cylindrical lens 8 and the convex lens 9. The light-receiving parts 28a-28d, the light-receiving parts 28e-28h, the light-receiving parts 28i-28l, the light-receiving parts 28m-28p, and the light-receiving parts 28q-28t correspond to “first light-receiving part group”, “second light-receiving part group”, “third light-receiving part group”, “fourth light-receiving part group”, and “fifth light-receiving part group” depicted in the appended claims, respectively.

When outputs from the light-receiving parts 28a-28t are expressed as V28a-V28t, respectively, a focus error signal can be obtained by an arithmetic operation of (V28a+V28d)-(V28b+V28c) based on the astigmatism method. A push-pull signal by the main beam can be given by (V28a+V28b)-(V28c+V28d), a push-pull signal by the first sub-beams can be given by (V28e+V28g)-(V28f+V28h), a push-pull signal by the second sub-beams can be given by (V26i+V28k)-(V28j+V28l), a push-pull signal by the third sub-beams can be given by (V28m+V28o)-(V28n+V28p), and a push-pull signal by the fourth sub-beams can be given by (V28q+V28s)-(V28r+V28t). The signal obtained by subtracting the push-pull signal by the third or fourth sub-beams from the push-pull signal by the main beam is used as a track error signal. The RP signal recorded in the disk 7 can be obtained by an arithmetic operation of (V28a+V28b+V28c+V28d).

FIG. 13 shows various push-pull signals related to detection of track error signal. The lateral axis in the drawing is a detrack amount of the light focusing spot, and the longitudinal axis is the push-pull signal. When the objective lens is shifted to the radial direction of the disk, there is an offset generated in the push-pull signal because of the shift in the lens. The push-pull signals 36a and 36b shown in FIG. 13A are a push-pull signal by the main beam and a push-pull signal by the third or fourth sub-beams, respectively, when the objective lens 6 is shifted to the outer side of the radial direction of the disk 7. Further, the push-pull signals 36c and 36d shown in FIG. 13B are a push-pull signal by the main beam and a push-pull signal by the third or fourth sub-beams, respectively, when the objective lens 6 is shifted to the inner side of the radial direction of the disk 7. The polarity of the push-pull signal by the main beam and that of the push-pull signal by the third or fourth sub-beams are inverted, while the signs of the offset when the objective lens 6 is shifted to the radial direction of the disk 7 are the same. There is a positive offset observed in FIG. 13A, and a negative offset observed in FIG. 13B. In the meantime, the push-pull signal 36e shown in FIG. 1C is a track error signal that is a difference between the push-pull signal by the main beam and the push-pull signal by the third or fourth sub-beams, when the objective lens 6 is shifted to the outer side and the inner side of the radial direction of the disk 7. In FIG. 13C, the offset of the push-pull signals generated in FIG. 13A and FIG. 13D is cancelled, so that there is no offset generated in the push-pull signal. Further, it is possible to use the sum of the push-pull signal by the main beam and the push-pull signal by the third or fourth sub-beams as a lens position signal that shows the shift amount of the objective lens 6 from the mechanical neutral position.

In this exemplary embodiment, when the groove pitch of the disk 7 is narrow, the signal obtained by subtracting the push-pull signal by the third sub-beams from the push-pull signal by the main beam is used as the track error signal. When the groove pitch of the disk 7 is wide, the signal obtained by subtracting the push-pull signal by the fourth sub-beams from the push-pull signal by the main beam is used as the track error signal. With this, there is no offset generated in the track error signal for both of the two kinds of disks having different groove pitches because of shift in the lens. Further, when the groove pitch of the disk 7 is narrow, the sum of the push-pull signal by the main beam and the push-pull signal by the third sub-beams is used as the lens position signal. When the groove pitch of the disk 7 is wide, the sum of the push-pull signal by the main beam and the push-pull signal by the fourth sub-beams is used as the lens position signal.

Various push-pull signals related to detection of the radial tilt according to this exemplary embodiment are the same as those shown in FIG. 5. In this exemplary embodiment, the push-pull signal by the first or second sub-beams under track-servo can be used as the radial tilt error signal, as in the case of the first exemplary embodiment. When there is a residual error in the track error signal due to an eccentricity or the like of the disk, there is also an offset generated in the push-pull signal by the first or second sub-beams because of the residual error. However, there is no offset generated in the radial tilt error signal by the residual error, when the signal obtained by subtracting the track error signal from the push-pull signal by the first or second sub-beams is used as the radial tilt error signal. Further, when the objective lens is shifted in the radial direction, there is also an offset generated in the push-pull signal by the first or second sub-beams because of the shift in the lens. However, there is no offset generated in the radial tilt error signal by the shift in the lens, when the signal obtained by subtracting the lens position signal from the push-pull signal by the first or second sub-beams is used as the radial tilt error signal. Furthermore, there is no offset generated in the radial tilt error signal caused by the residual error and the shift in the lens, when the signal obtained by subtracting the track error signal and the lens position signal from the push-pull signal by the first or second sub-beams is used as the radial tilt error signal.

A sixth exemplary embodiment of the optical head according to the invention is obtained by replacing the diffraction optical elements 3g, 3h of the fifth exemplary embodiment with diffraction optical elements 3i, 3j shown in FIG. 14, respectively.

FIG. 14A is a plan view of the diffraction optical element 3i. The diffraction optical element 3i is formed in a structure in which a diffraction grating, which is divided into two regions 13i, 13j by a straight line in parallel to the tangential direction of the disk 7 passing through the optical axis of incident light, is formed on the whole surface including the effective diameter 6a of the objective lens 6 that is illustrated with a dotted line in the drawing. The grating direction in the diffraction grating in both regions is in parallel to the radial direction of the disk 7, and the pattern of the grating in both regions is in a linear form of an equivalent pitch. The phase of the grating in the region 13i and the phase of the grating in the region 13j are shifted from each other by 180 degrees. The light making incident on the diffraction optical element 3i generates the zeroth order light and the positive and negative first order diffracted lights.

FIG. 14B is a plan view of the diffraction optical element 3j. The diffraction optical element 3j is formed in a structure in which a diffraction grating, which is divided into four regions 13k-13n by a straight line in parallel to the tangential direction of the disk 7 passing through the optical axis of incident light and two straight lines that are in parallel to the tangential direction of the disk 7 and are symmetrical with respect to the optical axis of the incident light, is formed on the whole surface including the effective diameter 6a of the objective lens 6 that is illustrated with a dotted line in the drawing. The grating direction in the diffraction grating in all the regions is in parallel to the radial direction of the disk 7, and the pattern of the grating in both regions is in a linear form of an equivalent pitch. The phase of the grating in the regions 13k, 13h and the phase of the grating in the regions 13l, 13m are shifted from each other by 180 degrees. The incident light generates the zeroth order light and the positive and negative first order diffracted lights.

The pitch of the grating in the diffraction grating formed in the regions 13i, 13j of the diffraction optical element 3i, the pitch of the grating of the diffraction grating formed in the regions 13k-13n of the diffraction optical element 3j, the pitch of the grating of the diffraction grating formed in the region 13a of the diffraction optical element 3a, and the pitch of the grating of the diffraction grating formed in the region 13b of the diffraction optical element 3b become narrower in this order. Here, the main beam, the third sub-beams, and the fourth sub-beams contain both the light transmitted through the inside the region 13a of the diffraction optical element 3a and the light transmitted through the outer side thereof, and both the light transmitted through the inside the region 13b of the diffraction optical element 3b and the light transmitted through the outer side thereof. The first sub-beams contain only the light diffracted on the inside the region 13a of the diffraction optical element 3a. The second sub-beams contain only the light diffracted on the inside the region 13b of the diffraction optical element 3b. As a result, the intensity distribution of the third and fourth sub-beams becomes the same as that of the main beam, the intensity of the first sub-beams in the peripheral part becomes weaker than that of the main beam, and the intensity of the second sub-beam in the peripheral part becomes weaker than that of the first sub-beams.

The order of the diffraction optical elements 3i and 3j may be inverted. Further, instead of the diffraction optical elements 3i, 3j, it is also possible to use a single diffraction optical element including one of those diffraction gratings shown in FIG. 14A and FIG. 14A formed on the incident face, and the other formed on the exit face. Furthermore, the order of the diffraction optical elements 3a, 3b and the diffraction optical elements 3i, 3j may be inverted. Moreover, the diffraction optical elements 3a and 3b may be replaced with the diffraction optical elements 3c and 3d, respectively.

FIG. 15 shows the layout of the light focusing spots on the disk 7. FIG. 15A shows a case where the groove pitch of the disk 7 is narrow, and FIG. 15B shows a case where the groove pitch of the disk 7 is wide. The light focusing spots 23a, 23b, 23c, 23d, 23e, 23n, 23o, 23p, and 23q correspond, respectively, to the transmission light from the diffraction optical elements 3a, 3b, 3i, and 3j, to the positive first order diffracted light from the diffraction optical element 3a that is the transmission light from the diffraction optical elements 3b, 3i, and 3j, to the negative first order diffracted light from the diffraction optical element 3a that is the transmission light from the diffraction optical elements 3b, 3i, and 3j, to the positive first order diffracted light from the diffraction optical element 3b that is the transmission light from the diffraction optical elements 3a, 3i, and 3j, to the negative first order diffracted light from the diffraction optical element 3b that is the transmission light from the diffraction optical elements 3a, 3i, and 3j, to the positive first order diffracted light from the diffraction optical element 3i that is the transmission light from the diffraction optical elements 3a, 3b, and 3j, to the negative first order diffracted light from the diffraction optical element 3i that is the transmission light from the diffraction optical elements 3a, 3b, and 3j, to the positive first order diffracted light from the diffraction optical element 3j that is the transmission light from the diffraction optical elements 3a, 3b, and 3i, and to the negative first order diffracted light from the diffraction optical element 3j that is the transmission light from the diffraction optical elements 3a, 3b, and 3i.

In FIG. 15A, the light focusing spots 23a, 23b, 23c, 23d, 23e, 23n, 23o, 23p, and 23q are on a same track 22a. In FIG. 15B, the light focusing spots 23a, 23b, 23c, 23d, 23e, 23n, 23o, 23p, and 23q are on a same track 22b. The light focusing spots 23n, 23o as the third sub-beams and the light focusing spots 23p, 23q as the fourth sub-beams have two peaks with the same intensity on the left side and right side of the radial direction of the disk 7. In the meantime, the light focusing spots 23b, 23c as the first sub-beams have the larger diameter than that of the light focusing spot 23a as the main beam. Further, the light focusing spots 23d, 23e as the second sub-beams have the larger diameter than that of the light focusing spots 23b, 23c as the first sub-beams.

The pattern of the light-receiving parts of a photodetector and the layout of the optical spots on the photodetector according to this exemplary embodiment are the same as those shown in FIG. 12. With this exemplary embodiment, the focus error signal, the push-pull signal by the main beam, the push-pull signal by the first sub-beams, the push-pull signal by the second sub-beams, the push-pull signal by the third sub-beams, the push-pull signal by the fourth sub-beams, and the RF signal that is recorded in the disk 7 can be obtained, as in the case of the fifth exemplary embodiment. As the track error signal, the signal obtained by subtracting the push-pull signal by the third or fourth sub-beams from the push-pull signal by the main beam is used.

FIG. 16A shows a phase of the third sub-beams reflected by the disk 7 and a phase of the third sub-beams diffracted by the disk 7, when the groove pitch of the disk 7 is narrow. It is assumed here that the light focusing spots as the third sub-beams are positioned at the center of the track of the disk 7. Regions 39a and 39b correspond, respectively, to the positive and negative first order diffracted lights from the regions 13i and 13j of the diffraction optical element 3i out of the light reflected by the disk 7 as the zeroth order light. Regions 39c and 39d correspond, respectively, to the positive and negative first order diffracted lights from the regions 13i and 13j of the diffraction optical element 3i out of the light diffracted by the disk 7 as the positive first order diffracted light. Regions 39e and 39f correspond, respectively, to the positive and negative first order diffracted lights from the regions 13i and 13j of the diffraction optical element 3i out of the light diffracted by the disk 7 as the negative first order diffracted light. The phases of the light in the regions marked with “+” and “−” in the drawing are +90 degrees and −90 degrees, respectively.

The push-pull signal is detected by utilizing the fact that the light reflected by the disk 7 interferes with the light diffracted by the disk 7 in the overlapping part thereof, and that the intensity of the interference light changes depending on the phases of each light. In FIG. 16A, the region 39a of the zeroth order light overlaps with the region 39d of the positive first order diffracted light, and the region 39d of the zeroth order light overlaps with the region 59e of the negative first order diffracted light, The phase of the light in the region 39a and the phase of the light in the region 39d are shifted from each other by 180 degrees, and the phase of the light in the region 39b and the phase of the light in the region 39e are shifted from each other by 180 degrees. Here, polarity of the push-pull signal by the third sub-beams is inverted from that of the push-pull signal by the main beam.

FIG. 16B shows a phase of the fourth sub-beams reflected by the disk 7 and a phase of the fourth sub-beams diffracted by the disk 7, when the groove pitch of the disk 7 is wide. It is assumed here that the light focusing spot as the fourth sub-beams are positioned at the center of the track of the disk 7. Regions 40a-40d correspond, respectively, to the positive and negative first order diffracted lights from the regions 13k-13n of the diffraction optical element 3j out of the light reflected by the disk 7 as the zeroth order light. Regions 40e-40h correspond, respectively, to the positive and negative first order diffracted lights from the regions 13k-13n of the diffraction optical element 3j out of the light diffracted by the disk 7 as the positive first order diffracted light. Regions 40i-40l correspond, respectively, to the positive and negative first order diffracted lights from the regions 13k-13n of the diffraction optical element 3j out of the light diffracted by the disk 7 as the negative first order diffracted light. The phases of the light in the regions marked with “+” and “−” in the drawing are +90 degrees and −90 degrees, respectively.

The push-pull signal is detected by utilizing the fact that the light reflected by the disk 7 interferes with the light diffracted by the disk 7 in the overlapping part thereof, and the intensity of the interference light changes depending on the phases of each light. In FIG. 16B, the regions 40c, 40a, 40b of the zeroth order light overlap with the regions 40e, 40f, 40k of the positive first order diffracted light, respectively, and the regions 40d, 40b, and 40a of the zeroth order light overlap with the regions 40j, 40i, and 40k of the negative first order diffracted light, respectively. The phase of the light in the regions 40c, 40a, and 40b and the phase of the light in the regions 40e, 40f1 and 40h are shifted from each other by 180 degrees, and the phase of the light in the regions 40d, 40b, and 40a and the phase of the light in the regions 40j, 40i, and 40k are shifted from each other by 180 degrees. Here, polarity of the push-pull signal by the fourth sub-beams is inverted from a that of the push-pull signal by the main beam.

Various push-pull signals related to detection of the track error signal according to this exemplary embodiment are the same as those shown in FIG. 13, because of the reasons described above. In this exemplary embodiment, there is no offset generated in the track error signal by the shift in the lens, as in the case of the fifth exemplary embodiment. Further, the sum of the push-pull signal by the main beam and the push-pull signal by the third or fourth sub-beams can be used as the lens position signal.

Various push-pull signals related to detection of the radial tilt according to this exemplary embodiment are the same as those shown in FIG. 5. In this exemplary embodiment, the push-pull signal by the first or second sub-beams under track-servo can be used as the radial tilt error signal, as in the case of the fifth exemplary embodiment. With the use of the signal obtained by subtracting the track error signal from the push-pull signal by the first or second sub-beams as the radial tilt error signal, there is no offset generated in the radial tilt error signal by the residual error. With the use of the signal obtained by subtracting the lens position signal from the push-pull signal by the first or second sub-beams as the radial tilt error signal, there is no offset generated in the radial tilt error signal by the shift in the lens. Furthermore, with the use of the signal obtained by subtracting the track error signal and the lens position signal from the push-pull signal by the first or second sub-beams as the radial tilt error signal, there is no offset generated in the radial tilt error signal caused by the residual error and the shift in the lens.

A seventh exemplary embodiment of the optical head according to the present invention is obtained by replacing the diffraction optical elements 3g, 3h of the fifth exemplary embodiment with diffraction elements 3k, 3l shown in FIG. 17, respectively.

FIG. 17A is a plan view of the diffraction optical element 3k. The diffraction optical element 2k is formed in a structure in which a diffraction grating, which is divided into two regions 13o, 13p by two straight lines that are in parallel to the tangential direction of the disk 7 and symmetrical with respect to the optical axis of incident light, is formed on the whole surface including the effective diameter 6a of the objective lens 6 that is illustrated with a dotted line in the drawing. The grating direction in the diffraction grating in both regions is in parallel to the radial direction of the disk 7, and the pattern of the grating in both regions is in a linear form of an equivalent pitch. The phase of the grating in the region 130 and the phase of the grating in the region 13p are shifted from each other by 180 degrees. The light making incident on the diffraction optical element 3k generates the zeroth order light and the positive and negative first order diffracted light.

FIG. 17B is a plan view of the diffraction optical element 3l. The diffraction optical element 3l is formed in a structure in which a diffraction grating, which is divided into two regions 13q, 13r by two straight lines that are in parallel to the tangential direction of the disk 7 and symmetrical with respect to the optical axis of incident light, is formed on the whole surface including the effective diameter 6a of the objective lens 6 that is illustrated with a dotted line in the drawing. The grating direction in the diffraction grating in both regions is in parallel to the radial direction of the disk 7, and the pattern of the grating in both regions is in a linear form of an equivalent pitch. The phase of the grating in the region 13q and the phase of the grating in the region 13r are shifted from each other by 180 degrees. The light making incident on the diffraction optical element 3l generates the zeroth order light and the positive and negative first order diffracted lights.

The pitch of the grating in the diffraction grating formed in the regions 13o, 13p of the diffraction optical element 3k, the pitch of the grating of the diffraction grating formed in the regions 13q, 13r of the diffraction optical element 31, the pitch of the grating of the diffraction grating formed in the region 13a of the diffraction optical element 3a, and the pitch of the grating of the diffraction grating formed in the region 13b of the diffraction optical element 3b become narrower in this order. Here, the main beam, the third sub-beams, and the fourth sub-beams contain both the light transmitted through the inside the region 13a of the diffraction optical element 3a and the light transmitted through the outer side thereof, and both the light transmitted through the inside the region 13b of the diffraction optical element 3b and the light transmitted through the outer side thereof. The first sub-beams contain only the light diffracted on the inside the region 13a of the diffraction optical element 3a. The second sub-beams contain only the light diffracted on the inside the region 13b of the diffraction optical element 3b. As a result, the intensity distribution of the third and fourth sub-beams becomes the same as that of the main beam, the intensity of the first sub-beams in the peripheral part becomes weaker than that of the main beam, and the intensity of the second sub-beams in the peripheral part becomes weaker than that of the first sub-beams.

The order of the diffraction optical elements 3k and 3l may be inverted. Further, instead of the diffraction optical elements 3k and 3l, it is also possible to use a single diffraction optical element including one of those diffraction gratings shown in FIG. 17A and FIG. 17B formed on the incident face, and the other formed on the exit face. Furthermore, the order of the diffraction optical elements 3a, 3b and the diffraction optical elements 3k, 3l may be inverted. Moreover, the diffraction optical elements 3a and 3b may be replaced with the diffraction optical elements 3c and 3d, respectively.

As in the case of the fifth exemplary embodiment, a single light focusing spot as the main beam, two light focusing spots as the first sub-beams, two light focusing spots as the second sub-beams, two light focusing spots as the third sub-beams, and two light focusing spots as the fourth sub-beams are disposed on a same track of the disk 7 in the seventh exemplary embodiment.

The pattern of the light-receiving parts of a photodetector and the layout of the optical spots on the photodetector according to this exemplary embodiment are the same as those shown in FIG. 12. With this exemplary embodiment, each of the focus error signal, the push-pull signal by the main beam, the push-pull signal by the first sub-beams, the push-pull signal by the second sub-beams, the push-pull signal by the third sub-beams, the push-pull signal by the fourth sub-beams, as well as a RF signal recorded in the disk 7 can be obtained, as in the case of the fifth exemplary embodiment. As the track a error signal, the signal obtained by subtracting the push-pull signal by the third or fourth sub-beams from the push-pull signal by the main beam is used.

Various push-pull signals related to detection of the track error signals according to this exemplary embodiment are the same as those shown in FIG. 13, because of the same reasons described above in the sixth exemplary embodiment by referring to FIG. 16. In this exemplary embodiment, there is no offset generated in the track error signal by the shift in the lens, as in the case of the fifth exemplary embodiment. Further, the sum of the push-pull signal by the main beam and the push-pull signal by the third or fourth sub-beams can be used as the lens position signal.

Various push-pull signals related to detection of the radial tilt according to this exemplary embodiment are the same as those shown in FIG. 5. In this exemplary embodiment, the push-pull signal by the first or second sub-beams under track-servo can be used as the radial tilt error signal, as in the case of the fifth exemplary embodiment. With the use of the signal obtained by subtracting the track error signal from the push-pull signal by the first or second sub-beams as the radial tilt error signal, there is no offset generated in the radial tilt error signal by the residual error. Further, with the use of the signal obtained by subtracting the lens position signal from the push-pull signal by the first or second sub-beams as the radial tilt error signal, there is no offset generated in the radial tilt error signal by the shift in the lens. Furthermore, with the use of the signal obtained by subtracting the track error signal and the lens position signal from the push-pull signal by the first or second sub-beams as the radial tilt error signal, there is no offset generated in the radial tilt error signal caused by the residual error and the shift in the lens.

An eighth exemplary embodiment of the optical head according to the invention is obtained by replacing the diffraction optical elements 3a, 3g of the fifth exemplary embodiment with a single diffraction element 3m that is shown in FIG. 18A, and replacing the diffraction optical elements 3b, 3h with a single diffraction optical element 3n that is shown in FIG. 18B.

Emitted light from a semiconductor laser 1 is divided by the diffraction optical elements 3m and 3n into nine light beams in total, i.e., a single ray of transmission light as the main beam, two rays of diffraction light as the first sub-beams, two rays of diffraction light as the second sub-beams, two diffraction light beams as the third sub-beams, and two rays of diffraction light as the fourth sub-beams. The main beam is the transmission light from the diffraction optical elements 3m, 3n, the first sub-beams are the positive and negative first order diffracted lights from the diffraction optical element 3m that is the transmission light from the diffraction optical element 3n, the second sub-beams are the positive and negative first order diffracted lights from the diffraction optical element 3n that is the transmission light from the diffraction optical element 3m, the third sub-beams are the positive and negative second order diffracted lights from the diffraction optical element 3m that is the transmission light from the diffraction optical element 3n, and the fourth sub-beams are the positive and negative second order diffracted lights from the diffraction optical element 3n that is the transmission light from the diffraction optical element 3m.

FIG. 18A is a plan view of the diffraction optical element 3m. The diffraction optical element 3m is structured to include the diffraction grating formed in regions is and 13t. The region 13s is on the inner side of a circle that has a smaller diameter than the effective diameter 6a of the objective lens 6 illustrated with a dotted line in the drawing. The region 13t is the outer side of that circle. The grating direction in the diffraction grating in both regions is slightly tilted with respect to the radial direction of the disk 7, and the pattern of the grating in both regions is in a linear form of an equivalent pitch. The pitch of the grating in the region is equivalent to that of the grating in the region 13t. For example, about 80.0% of the light making incident on the region 13s transmits therethrough as the zeroth order light, about 3.2% each is diffracted as the positive and negative first order diffracted light, and about 3.0% each is diffracted as the positive and negative second order diffracted light. Further, almost 91.0% of the light making incident on the region 13t transmits therethrough as the zeroth order light, and about 3.6% each is diffracted as the positive and negative first order diffracted light.

FIG. 18B is a plan view of the diffraction optical element 3n. The diffraction optical element 3n is structured to include the diffraction grating formed in regions 13u and 13v. The region 13u is on the inner side of a circle that has a smaller diameter than the effective diameter 6a of the objective lens 6 illustrated with a dotted line in the drawing. The region 13v is the outer side of that circle. The grating direction in the diffraction grating in both regions is slightly tilted with respect to the radial direction of the disk 7, and the pattern of the grating in both regions is in a linear form of an equivalent pitch. The pitch of the grating in the region 13u is equivalent to that of the grating in the region 13v. For example, about 80.0% of the light making incident on region 13u transmits therethrough as the zeroth order light, about 3.2% each is diffracted as the positive and negative first order diffracted light, and about 3.0% each is diffracted as the positive and negative second order diffracted light. Further, almost 91.0% of the light making incident on the region 13v transmits therethrough as the zeroth order light, and about 3.6% each is diffracted as the positive and negative first order diffracted light.

The pitch of the grating in the diffraction grating formed in the regions 13s, 13t of the diffraction optical element 3m is wider than that of the diffraction grating formed in the regions 13u, 13v of the diffraction optical element 3n. Further, the diameter of the region 13s of the diffraction optical element 3m is larger than that of the region 13u of the diffraction optical element 3n. Here, the main beam contains both the light transmitted through the region 13s of the diffraction optical element 3m and the light transmitted through the region 13t, and both the light transmitted through the region 13u of the diffraction optical element 3n and the light transmitted through the region 13v. The third sub-beams contain both the light diffracted by the region 13s of the diffraction optical element 3m and the light diffracted by the region 13t. The fourth sub-beams contain both the light diffracted by the region 13u of the diffraction optical element 3n and the light diffracted by the region 13v. The first sub-beams contain only the light diffracted by the region 13s of the diffraction optical element 3m. The second sub-beams contain only the light diffracted by the region 13u of the diffraction optical element 3n. As a result, the intensity distribution of the third and fourth sub-beams becomes the same as that of the main beam, the intensity of the first sub-beams in the peripheral part becomes weaker than that of the main beam, and the intensity of the second sub-beams in the peripheral part becomes weaker than that of the first sub-beams.

The order of the diffraction optical elements 3m and 3n may be inverted. Further, instead of the diffraction optical elements 3m and 3n, it is also possible to use a single diffraction optical element including one of those diffraction gratings shown in FIG. 18A and FIG. 18B formed on the incident face, and the other formed on the exit face.

In this exemplary embodiment, when the groove pitch of the disk 7 is narrow, the two light focusing spots as the third sub-beams and the two light focusing spots as the first sub-beams are on the tracks right next to the track of the single light focusing spot as the main beam on the right side and left side, and the second tracks from the track of the light focusing spot as the main beam on the right side and left side, respectively, as in the case of the fifth exemplary embodiment. When the groove pitch of the disk 7 is wide, the two light focusing spots as the fourth sub-beams and the two light focusing spots as the second sub-beams are on the tracks right next to the track of the single light focusing spot as the main beam on the right side and left side, and the second tracks from the track of the light focusing spot as the main beam on the right side and left side, respectively

The pattern of the light-receiving parts of a photodetector and the layout of the optical spots on the photodetector according to this exemplary embodiment are the same as those shown in FIG. 12. With this exemplary embodiment, each of the focus error signal, the push-pull signal by the main beam, the push-pull signal by the first sub-beams, the push-pull signal by the second sub-beams, the push-pull signal by the third sub-beams, the push-pull signal by the fourth sub-beams, as well as a RF signal recorded in the disk 7 can be obtained, as in the case of the fifth exemplary embodiment. As the track error signal, the signal obtained by subtracting the push-pull signal by the third or fourth sub-beams from the push-pull signal by the main beam is used.

Various push-pull signals related to detection of the track error signal according to this exemplary embodiment are the same as those shown in FIG. 13. In this exemplary embodiment, there is no offset generated in the track error signal by the shift in the lens, as in the case of the fifth exemplary embodiment. Further, the sum of the push-pull signal by the main beam and the push-pull signal by the third or fourth sub-beams can be used as the lens position signal.

Various push-pull signals related to detection of the radial tilt according to this exemplary embodiment are the same as those shown in FIG. 5. In this exemplary embodiment, the push-pull signal by the first or second sub-beams under track-servo can be used as the radial tilt error signal, as in the case of the fifth exemplary embodiment. With the use of the signal obtained by subtracting the track error signal from the push-pull signal by the first or second sub-beams as the radial tilt error signal, there is no offset generated in the radial tilt error signal by the residual error. Further, with the use of the signal obtained by subtracting the lens position signal from the push-pull signal by the first or second sub-beams as the radial tilt error signal, there is no offset generated in the radial tilt error signal by the shift in the lens. Furthermore, with the use of the signal obtained by subtracting the track error signal and the lens position signal from the push-pull signal by the first or second sub-beams as the radial tilt error signal, there is no offset generated in the radial tilt error signal caused by the residual error and the shift in the lens.

A ninth exemplary embodiment of the optical head according to the present invention is obtained by replacing the diffraction optical element 3m of the eighth exemplary embodiment with a diffraction element 3o that is shown in FIG. 19A, and replacing the diffraction optical element 3n with a diffraction optical element 3p that is shown in FIG. 19B.

FIG. 19A is a plan view of the diffraction optical element 3o. The diffraction optical element 3o is structured to include the diffraction grating formed in regions 13w and 13x. The region 13w is on the inner side of a band that has a smaller width than the effective diameter 6a of the objective lens 6 illustrated with a dotted line in the drawing. The region 13x is the outer side of that band. The grating direction in the diffraction grating in both regions is slightly tilted with respect to the radial direction of the disk 7, and the pattern of the grating in both regions is in a linear form of an equivalent pitch. The pitch of the grating in the region 13w is equivalent to that of the grating in the region 13x. The light making incident on the region 13w generates the zeroth order light, the positive and negative first order diffracted lights, and positive and negative second order diffracted light. The light making incident on the region 13x generates the zeroth order light and the positive and negative first order diffracted lights.

FIG. 19B is a plan view of the diffraction optical element 3p. The diffraction optical element 3p is structured to include the diffraction grating formed in regions 13y and 13z. The region 13y is on the inner side of a band that has a smaller width than the effective diameter 6a of the objective lens 6 illustrated with a dotted line in the drawing. The region 13z is the outer side of that band. The grating direction in the diffraction grating in both regions is slightly tilted with respect to the radial direction of the disk 7, and the pattern of the grating in both regions is in a linear form of an equivalent pitch. The pitch of the grating in the region 13y is equivalent to that of the grating in the region 13z. The light making incident on the region 13y generates the zeroth order light, the positive and negative first order diffracted lights, and positive and negative second order diffracted light. The light making incident on the region 13z generates the zeroth order light and the positive and negative first order diffracted lights.

The pitch of the grating in the diffraction grating formed in the regions 13w, 13x of the diffraction optical element 3o is wider than that of the diffraction grating formed in the regions 13y, 13z of the diffraction optical element 3p. Further, the width of the region 13w of the diffraction optical element 3o is wider than that of the region 13y of the diffraction optical element 3p. As a result, the intensity distribution of the third and fourth sub-beams becomes the same as that of the main beam, the intensity of the first sub-beams in the peripheral part in the radial direction of the disk 7 becomes weaker than that of the main beam, and the intensity of the second sub-beam in the peripheral part in the radial direction of the disk 7 becomes weaker than that of the first sub-beams.

The order of the diffraction optical elements 3o and 3p may be inverted. Further, instead of the diffraction optical elements 3o and 3p, it is also possible to use a single diffraction optical element including one of those diffraction gratings shown in FIG. 19A and FIG. 19B formed on the incident face, and the other formed on the exit face.

In this exemplary embodiment, when the groove pitch of the disk 7 is narrow, the two light focusing spots as the third sunbeams and the two light focusing spots as the first sub-beams are on the tracks right next to the track of the single light focusing spot as the main beam on the right side and left side, and the second tracks from the track of the light focusing spot as the main beam on the right side and left side, respectively, as in the case of the fifth exemplary embodiment. When the groove pitch of the disk 7 is wide, the two light focusing spots as the fourth sub-beams and the two light focusing spots as the second sub-beams are deposited on the tracks right next to the track of the single light focusing spot as the main beam on the right side and left side, and the second tracks from the track of the light focusing spot as the main beam on the right side and left side, respectively.

The pattern of the light-receiving parts of a photodetector and the layout of the optical spots on the photodetector according to this exemplary embodiment are the same as those shown in FIG. 12. With this exemplary embodiment, each of the focus error signal, the push-pull signal by the main beam, the push-pull signal by the first sub-beams, the push-pull signal by the second sub-beams, the push-pull signal by the third sub-beams, the push-pull signal by the fourth sub-beams, as well as a RF signal recorded in the disk 7 can be obtained, as in the case of the fifth exemplary embodiment. As the track error signal, the signal obtained by subtracting the push-pull signal by the third or fourth sub-beams from the push-pull signal by the main beam is used.

Various push-pull signals related to detection of the track error signal according to this exemplary embodiment are the same as those shown in FIG. 13. In this exemplary embodiment, there is no offset generated in the track error signal by the shift in the lens, as in the case of the fifth exemplary embodiment. Further, the sum of the push-pull signal by the main beam and the push-pull signal by the third or fourth sub-beams can be used as the lens position signal.

Various push-pull signals related to detection of the radial tilt according to this exemplary embodiment are the same as those shown in FIG. 5. In this exemplary embodiment, the push-pull signal by the first or second sub-beams under track-servo can be used as the radial tilt error signal, as in the case of the fifth exemplary embodiment. With the use of the signal obtained by subtracting the track error signal from the push-pull signal by the first or second sub-beams as the radial tilt error signal, there is no offset generated in the radial tilt error signal by the residual error. Further, with the use of the signal obtained by subtracting the lens position signal from the push-pull signal by the first or second sub-beams as the radial tilt error signal, there is no offset generated in the radial tilt error signal by the shift in the lens. Furthermore, with the use of the signal obtained by subtracting the track error signal and the lens position signal from the push-pull signal by the first or second sub-beams as the radial tilt error signal, there is no offset generated in the radial tilt error signal caused by the residual error and the shift in the lens.

A tenth exemplary embodiment of the optical head according to the present invention is obtained by replacing the diffraction optical element 3m of the eighth exemplary embodiment with a diffraction element 3q that is shown in FIG. 20A, and replacing the diffraction optical element 3n with a diffraction optical element 3r that is shown in FIG. 20B.

FIG. 20A is a plan view of the diffraction optical element 3q. The diffraction optical element 3g is formed in a structure in which a diffraction grating, which is divided into two regions 14a, 14b by a straight line in parallel to the tangential direction of the disk 7 passing through the optical axis of incident light, is formed on the inner side of a circle that has a smaller diameter than the effective diameter 6a of the objective lens 6 that is illustrated with a dotted line in the drawing, and a diffraction grating, which is divided into two regions 14c, 14d by a straight line in parallel to the tangential direction of the disk 7 passing through the optical axis of incident light, is formed on the outer side of that circle. The grating direction in the diffraction grating in both regions is in parallel to the radial direction of the disk 7, and the pattern of the grating in both regions is in a linear form of an equivalent pitch. The pitch of the grating in the regions 14a, 14b is equivalent to that of the grating in the regions 14c, 14d. The phase of the grating in the regions 14a, 14b and the phase of the grating in the regions 14c, 14d are shifted from each other by 180 degrees. The light making incident on the regions 14a and 14b generates the zeroth order light, the positive and negative first order diffracted lights, and the positive and negative second order diffracted lights. The light making incident on the regions 14c and 14d generates the zeroth order light and the positive and negative first order diffracted lights.

FIG. 20B is a plan view of the diffraction optical element 3r. The diffraction optical element 3r is formed in a structure in which a diffraction grating, which is divided into two regions 14e, 14f by a straight line in parallel to the tangential direction of the disk 7 passing through the optical axis of incident light, is formed on the inner side of a circle that has a smaller diameter than the effective diameter 6a of the objective lens 6 that is illustrated with a dotted line in the drawing, and a diffraction grating, which is divided into four regions 14g-14j by a straight line in parallel to the tangential direction of the disk 7 passing through the optical axis of incident light and two straight lines that are in parallel to the tangential direction of the disk 7 and are symmetrical with respect to the optical axis of the incident light, is formed on the outer side of that circle. The grating direction in the diffraction grating in both regions is in parallel to the radial direction of the disk 7, and the pattern of the grating in both regions is in a linear form of an equivalent pitch. The pitch of the grating in the regions 14e, 14f is equivalent to that of the grating in the regions 14g-14j. The phase of the grating in the regions 14e, 14g, 14j and the phase of the grating in the regions 14f, 14h, 14i are shifted from each other by 180 degrees. The light making incident on the regions 14e and 14f generates the zeroth order light, the positive and negative first order diffracted lights, and the positive and negative second order diffracted lights. The light making incident on the regions 14g-14j generates the zeroth order light and the positive and negative first order diffracted lights.

The pitch of the grating in the diffraction grating formed in the regions 14a-14d of the diffraction optical element 3q is wider than that of the diffraction grating formed in the regions 14e-14j of the diffraction optical element 3r. Further, the diameter of the regions 14a, 14b of the diffraction optical element 3q is larger than that of the regions 14e, 14f of the diffraction optical element 3r. As a result, the intensity distribution of the third and fourth sub-beams becomes the same as that of the main beam, the intensity of the first sub-beams in the peripheral part becomes weaker than that of the main beam, and the intensity of the second sub-beams in the peripheral part becomes weaker than that of the first sub-beams.

The order of the diffraction optical elements 3q and 3r may be inverted. Further, instead of the diffraction optical elements 3q and 3r, it is also possible to use a single diffraction optical element including one of those diffraction gratings shown in FIG. 20A and FIG. 20B formed on the incident face, and the other formed on the exit face. Furthermore, instead of the diffraction optical elements 3q and 3r, it is also possible to use a diffraction optical element in which a plurality of regions on the inner side and a plurality of regions on the outer side are divided not by a circle but a band, like the diffraction optical elements 3o and 3p shown in FIG. 19.

As in the case of the fifth exemplary embodiment, a single light focusing spot as the main beam, two light focusing spots as the first sub-beams, two light focusing spots as the second sub-beams, two light focusing spots as the third sub-beams, and two light focusing spots as the fourth sub-beams are disposed on a same track of the disk 7 in this exemplary embodiment.

The pattern of the light-receiving parts of a photodetector and the layout of the optical spots on the photodetector according to this exemplary embodiment are the same as those shown in FIG. 12. With this exemplary embodiment, each of the focus error signal, the push-pull signal by the main beam, the push-pull signal by the first sub-beams, the push-pull signal by the second sub-beams, the push-pull signal by the third sub-beams, the push-pull signal by the fourth sub-beams, as well as a RF signal recorded in the disk 7 can be obtained, as in the case of the fifth exemplary embodiment. As the track error signal, the signal obtained by subtracting the push-pull signal by the third or fourth sub-beams from the push-pull signal by the main beam is used.

Various push-pull signals related to detection of the track error signal according to this exemplary embodiment are the same as those shown in FIG. 13, because of the same reasons described above in the sixth exemplary embodiment by referring to FIG. 16. In this exemplary embodiment, there is no offset generated in the track error signal by the shift in the lens, as in the case of the fifth exemplary embodiment. Further, the sum of the push-pull signal by the main beam and the push-pull signal by the third or fourth sub-beams can be used as the lens position signal.

Various push-pull signals related to detection of the radial tilt according to this exemplary embodiment are the same as those shown in FIG. 5. In this exemplary embodiment, the push-pull signal by the first or second sub-beams under track-servo can be used as the radial tilt error signal, as in the case of the fifth exemplary embodiment. With the use of the signal obtained by subtracting the track error signal from the push-pull signal by the first or second sub-beams as the radial tilt error signal, there is no offset generated in the radial tilt error signal by the residual error. Further, with the use of the signal obtained by subtracting the lens position signal from the push-pull signal by the first or second sub-beams as the radial tilt error signal, there is no offset generated in the radial tilt error signal by the shift in the lens. Furthermore, with the use of the signal obtained by subtracting the track error signal and the lens position signal from the push-pull signal by the first or second sub-beams as the radial tilt error signal, there is no offset generated in the radial tilt error signal caused by the residual error and the shift in the lens.

An eleventh exemplary embodiment of the optical head according to the present invention is obtained by replacing the diffraction optical element 3m of the eighth exemplary embodiment with a diffraction element 3s that is shown in FIG. 21A, and replacing the diffraction optical element 3n with a diffraction optical element 3t that is shown in FIG. 21B.

FIG. 21A is a plan view of the diffraction optical element 3s. The diffraction optical element 3s is formed in a structure in which a diffraction grating, which is divided into two regions 14k, 14l by a straight line in parallel to the tangential direction of the disk 7 and symmetrical with respect to the optical axis of the incident light, is formed on the inner side of a circle that has a smaller diameter than the effective diameter 6a of the objective lens 6 that is illustrated with a dotted line in the drawing, and a diffraction grating, which is divided into two regions 14m, 14n by two straight lines that are in parallel to the tangential direction of the disk 7 and symmetrical with respect to the optical axis of the incident light, is formed on the outer side of that circle. The grating direction in the diffraction grating in both regions is in parallel to the radial direction of the disk 7, and the pattern of the grating in both regions is in a linear form of an equivalent pitch. The pitch of the grating in the regions 14k, 14l is equivalent to that of the grating in the regions 14m, 14n. The phase of the grating in the regions 14k, 14l and the phase of the grating in the regions 14m, 14n are shifted from each other by 180 degrees. The light making incident on the regions 14k and 14l generates the zeroth order light, the positive and negative first order diffracted lights, and the positive and negative second order diffracted light. The light making incident on the regions 14m and 14n generates the zeroth order light and the positive and negative first order diffracted lights.

FIG. 21B is a plan view of the diffraction optical element 3t. The diffraction optical element 3t is formed in a structure in which a diffraction grating, which is divided into two regions 14o, 14p by a straight line in parallel to the tangential direction of the disk 7 and symmetrical with respect to the optical axis of the incident light, is formed on the inner side of a circle that has a smaller diameter than the effective diameter 6a of the objective lens 6 that is illustrated with a dotted line in the drawing, and a diffraction grating, which is divided into two regions 14q, 14r by two straight lines that are in parallel to the tangential direction of the disk 7 and symmetrical with respect to the optical axis of the incident light, is formed on the outer side of that circle. The grating direction in the diffraction grating in both regions is in parallel to the radial direction of the disk 7, and the pattern of the grating in both regions is in a linear form of an equivalent pitch. The pitch of the grating in the regions 140, 14q is equivalent to that of the grating in the regions 14p, 14r. The phase of the grating in the regions 14o, 14q and the phase of the grating in the regions 14p, 14r are shifted from each other by 180 degrees. The light making incident on the regions 14o and 14p generates the zeroth order light, the positive and negative first order diffracted lights, and the positive and negative second order diffracted lights. The light making incident on the regions 14q, 14r generates the zeroth order light and the positive and negative first order diffracted lights.

The pitch of the grating in the diffraction grating formed in the regions 14k-14n of the diffraction optical element 3s is wider than that of the diffraction grating formed in the regions 14o-14r of the diffraction optical element 3t. Further, the diameter of the regions 14k, 14l of the diffraction optical element 3s is larger than that of the regions 14o, 14p of the diffraction optical element 3t. As a result, the intensity distribution of the third and fourth sub-beams becomes the same as that of the main beam, the intensity of the first sub-beams in the peripheral part becomes weaker than that of the main beam, and the intensity of the second sub-beams in the peripheral part becomes weaker than that of the first sub-beams.

The order of the diffraction optical elements 3s and 3t may be inverted. Further, instead of the diffraction optical elements 3s and 3t, it is also possible to use a single diffraction optical element including one of those diffraction gratings shown in FIG. 21A and FIG. 21B formed on the incident face, and the other formed on the exit face. Furthermore, instead of the diffraction optical elements 3s and 3t, it is also possible to use a diffraction optical element in which a plurality of regions on the inner side and a plurality of regions on the outer side are divided not by a circle but a band, like the diffraction optical elements 3o and 3p shown in FIG. 19.

As in the case of the fifth exemplary embodiment, a single light focusing spot as the main beam, two light focusing spots as the first sub-beams, two light focusing spots as the second sub-beams, two light focusing spot as the third sub-beams, and two light focusing spots as the fourth sub-beams are disposed on a same track of the disk 7 in this exemplary embodiment.

The pattern of the light-receiving parts of a photodetector and the layout of the optical spots on the photodetector according to this exemplary embodiment are the same as those shown in FIG. 12. With this exemplary embodiment, each of the focus error signal, the push-pull signal by the main beam, the push-pull signal by the first sub-beams, the push-pull signal by the second sub-beams, the push-pull signal by the third sub-beams, the push-pull signal by the fourth sub-beams, as well as a RF signal recorded in the disk 7 can be obtained, as in the case of the fifth exemplary embodiment. As the track error signal, the signal obtained by subtracting the push-pull signal by the third or fourth sub-beams from the push-pull signal by the main beam is used.

Various push-pull signals related to detection of the track error signal according to this exemplary embodiment are the same as those shown in FIG. 13, because of the same reasons described above in the sixth exemplary embodiment by referring to FIG. 16. In this exemplary embodiment, there is no offset generated in the track error signal by the shift in the lens, as in the case of the fifth exemplary embodiment. Further, the sum of the push-pull signal by the main beam and the push-pull signal by the third or fourth sub-beams can be used as the lens position signal.

Various push-pull signals related to detection of the radial tilt according to this exemplary embodiment are the same as those shown in FIG. 5. In this exemplary embodiment, the push-pull signal by the first or second sub-beams under track-servo can be used as the radial tilt error signal, as in the case of the fifth exemplary embodiment. With the use of the signal obtained by subtracting the track error signal from the push-pull signal by the first or second sub-beams as the radial tilt error signal, there is no offset generated in the radial tilt error signal by the residual error. Further, with the use of the signal obtained by subtracting the lens position signal from the push-pull signal by the first or second sub-beams as the radial tilt error signal, there is no offset generated in the radial tilt error signal by the shift in the lens. Furthermore, with the use of the signal obtained by subtracting the track error signal and the lens position signal from the push-pull signal by the first or second sub-beams as the radial tilt error signal, there is no offset generated in the radial tilt error signal caused by the residual error and the shift in the lens.

FIG. 22 shows a twelfth exemplary embodiment of the optical head according to the present invention. In this exemplary embodiment, the diffraction optical elements 3g, 3h of the fifth exemplary embodiment are replaced with a single diffraction optical element 3u, and the photodetector 10b is replaced with a photodetector 10c.

Emitted light from a semiconductor laser 1 is divided by diffraction optical elements 3a, 3b, and 3u into seven light beams in total, i.e., a single rays of transmission light as the main beam, two rays of diffraction light as the first sub-beams, two rays of diffraction light as the second sub-beams, and two rays of diffraction light as the third sub-beams. The main beam is the transmission light from the diffraction optical elements 3a, 3b, and 3u, the first sub-beams are the positive and negative first order diffracted lights from the diffraction optical element 3a that is the transmission light from the diffraction optical elements 3b, 3u, the second sub-beams are the positive and negative first order diffracted lights from the diffraction optical element 3b that is the transmission light from the diffraction optical elements 3a, 3u, and the third sub-beams are the positive and negative first order diffracted lights from the diffraction optical element 3u that is the transmission light from the diffraction optical elements 3a, 3b.

The plan views of the diffraction optical elements 3a and 3b according to this exemplary embodiment are the same as those shown in FIG. 2A and FIG. 2B, respectively.

FIG. 23 is a plan view of the diffraction optical element 3u. The diffraction optical element 3u is formed in a structure in which a diffraction grating, which is divided into eight regions 15a-15h by a straight line in parallel to the tangential direction of the disk 7 passing through the optical axis of incident light and six straight lines that are in parallel to the tangential direction of the disk 7 and are symmetrical with respect to the optical axis of the incident light, is formed on the whole surface including the effective diameter 6a of the objective lens 6 that is illustrated with a dotted line in the drawing. The grating direction in the diffraction grating in all the regions is in parallel to the radial direction of the disk 7, and the pattern of the grating in all the regions is in a linear form of an equivalent pitch. The phase of the grating in the regions 15e, 15a, 15d, 15h and the phase of the grating in the regions 15f, 15b, 15c, 15g are shifted from each other by 180 degrees. The light making incident on the diffraction optical element 3u generates the zeroth order light and the positive and negative first order diffracted lights.

The pitch of the grating in the diffraction grating formed in the regions 15a-15h of the diffraction optical element 3u, the pitch of the grating of the diffraction grating formed in the region 13a of the diffraction optical element 3a, and the pitch of the grating of the diffraction grating formed in the region 13b of the diffraction optical element 3b become narrower in this order. Here, the main beam and the third sub-beams contain both the light transmitted through the inside the region 13a of the diffraction optical element 3a and the light transmitted through the outer side thereof, and both the light transmitted through the inside the region 13b of the diffraction optical element 3b and the light transmitted through the outer side thereof. The first sub-beams contain only the light diffracted on the inside the region 13a of the diffraction optical element 3a. The second sub-beams contain only the light diffracted on the inside the region 13b of the diffraction optical element 3b. As a result, the intensity distribution of the third sub-beams becomes the same as that of the main beam, the intensity of the first sub-beams in the peripheral part becomes weaker than that of the main beam, and the intensity of the second sub-beams in the peripheral part becomes weaker than that of the first sub-beams.

The order of the diffraction optical elements 3a, 3b and the diffraction optical element 3u may be inverted. Further, the diffraction optical elements 3a and 3b may be replaced with the diffraction optical elements 3c and 3d, respectively.

FIG. 24 shows the layout of the light focusing spots on the disk 7. FIG. 24A shows a case where the groove pitch of the disk 7 is narrow, and FIG. 24B shows a case where the groove pitch of the disk 7 is wide. The light focusing spots 23a, 23b, 23c, 23d, 23e, 23r, and 23s correspond, respectively, to the transmission light from the diffraction optical elements 3a, 3b, 3u, to the positive first order diffracted light from the diffraction optical element 3a that is the transmission light from the diffraction optical elements 3b, 3u, to the negative first order diffracted light from the diffraction optical element 3a that is the transmission light from the diffraction optical elements 3b, 3u, to the positive first order diffracted light from the diffraction optical element 3b that is the transmission light from the diffraction optical elements 3a, 3u, to the negative first order diffracted light from the diffraction optical element 3b that is the transmission light from the diffraction optical elements 3a, 3u, to the positive first order diffracted light from the diffraction optical element 3u that is the transmission light from the diffraction optical elements 3a, 3b, and to the negative first order diffracted light from the diffraction optical element 3u that is the transmission light from the diffraction optical elements 3a, 3b.

In FIG. 24A, the light focusing spots 23a, 23b, 23c, 23d, 23e, 23r, and 23s are on a same track 22a. In FIG. 24B, the light focusing spots 23a, 23b, 23c, 23d, 23e, 23r, and 23s are on a same track 22b. The light focusing spots 23r and 25s as the third sub-beams have two peaks with the same intensity on the left side and right side of the radial direction of the disk 7. In the meantime, the light focusing spots 23b and 23c as the first sub-beams have the larger diameter than that of the light focusing spot 23a as the main beam. Further, the light focusing spots 23d, 23e as the second sub-beams have the larger diameter than that of the light focusing spots 23b, 23c as the first sub-beams.

FIG. 25 shows the pattern of a light-receiving part of the photodetector 10c and layout of optical spots on the photodetector 10c. The optical spot 31a corresponds to transmission light from the diffraction optical elements 3a, 3b, 3u, and it is received by light-receiving parts 30a-30d which are divided into four by a dividing line that is in parallel to the tangential direction of the disk 7 passing through the optical axis and by a dividing line that is in parallel to the radial direction. The optical spot 31b corresponds to the positive first order diffracted light from the diffraction optical element 3a that is the transmission light from the diffraction optical elements 3b, 3u, and it is received by light-receiving parts 30e and 30f which are divided into two by a dividing line that is in parallel to the radial direction of the disk 7 passing through the optical axis. The optical spot 31c corresponds to the negative first order diffracted light from the diffraction optical element 3a that is the transmission light from the diffraction optical elements 3b, 3u, and it is received by light-receiving parts 30g and 30h which are divided into two by a dividing line that is in parallel to the radial direction of the disk 7 passing through the optical axis. The optical spot 31d corresponds to the positive first order diffracted light from the diffraction optical element 3b that is the transmission light from the diffraction optical elements 3a, 3u, and it is received by light-receiving parts 30i and 30j which are divided into two by a dividing line that is in parallel to the radial direction of the disk 7 passing through the optical axis. The optical spot 31e corresponds to the negative first order diffracted light from the diffraction optical element 3b that is the transmission light from the diffraction optical elements 3a, 3u, and it is received by light-receiving parts 30k and 30l which are divided into two by a dividing line that is in parallel to the radial direction of the disk 7 passing through the optical axis. The optical spot 31f corresponds to the positive first order diffracted light from the diffraction optical element 3u that is the transmission light from the diffraction optical elements 3a, 3b, and it is received by light-receiving parts 30m and 30n which are divided into two by a dividing line that is in parallel to the radial direction of the disk 7 passing through the optical axis. The optical spot 31g corresponds to the negative first order diffracted light from the diffraction optical element 3u that is the transmission light from the diffraction optical elements 3a, 3b, and it is received by light-receiving parts 30o and 30p which are divided into two by a dividing line that is in parallel to the radial direction of the disk 7 passing through the optical axis. The intensity distribution of in the tangential direction of the disk 7 and the intensity distribution in the radial direction of the optical spots 31a-30g are switched from each other, because of the effects of the cylindrical lens 8 and the convex lens 9. The light-receiving parts 30a-30d, the light-receiving parts 30e-30h, the light-receiving parts 30i-30l, and the light-receiving parts 30m-30p correspond to “first light-receiving part group”, “second light-receiving part group”, “third light-receiving part group”, and “fourth light-receiving part group” depicted in the appended claims, respectively.

When outputs from the light-receiving parts 30a-30p are expressed as V30a-V30p, respectively, a focus error signal can be obtained by an arithmetic operation of (V30a+V30d)-(V30b+V30c) based on the astigmatism method. A push-pull signal by the main beam can be given by (V30a+V30b)-(V30c+V30d), a push-pull signal by the first sub-beams can be given by (V30e+V30g)-(V30f+V30h), a push-pull signal by the second sub-beams can be given by (V30i+V30k)-(V30j+V30l), and a push-pull signal by the third sub-beams can be given by (V30m+V30o)-(V30n+V30p). The signal obtained by subtracting the push-pull signal by the third sub-beams from the push-pull signal by the main beam is used as a track error signal. The RF signal recorded in the disk 7 can be obtained by an arithmetic operation of (V30a+V30b+V30c+V30d).

FIG. 26A shows a phase of the third sub-beams reflected by the disk 7 and a phase of the third sub-beams diffracted by the disk 7, when the groove pitch of the disk 7 is narrow. It is assumed here that the light focusing spots as the third sub-beams are positioned at the center of the track of the disk 7. Regions 41a-41h correspond, respectively, to the positive and negative first order diffracted lights from the regions 15a-15h of the diffraction optical element 3u out of the light reflected by the disk 7 as the zeroth order light. Regions 41i-41p correspond, respectively, to the positive and negative first order diffracted lights from the regions 15a-15h of the diffraction optical element 3u out of the light diffracted by the disk 7 as the positive first order diffracted light. Regions 41q-41x correspond, respectively, to the positive and negative first order diffracted lights from the regions 15a-15h of the diffraction optical element 3u out of the light diffracted by the disk 7 as the negative first order diffracted light. The phases of the light in the regions marked with “+” and “−” in the drawing are +90 degrees and −90 degrees, respectively.

The push-pull signal is detected by utilizing the fact that the light reflected by the disk 7 interferes with the light diffracted by the disk 7 in the overlapping part thereof, and that the intensity of the interference light changes depending on the phases of each light. In FIG. 26A, the regions 41g, 41e, 41c of the zeroth order light overlap with the regions 41l, 41n, 41p of the positive first order diffracted light, and the regions 41h, 41f, 41d of the zeroth order light overlap with the regions 41s, 41u, 41w of the negative first order diffracted light. The phase of the light in the regions 41g, 41e, 41c and the phase of the light in the regions 41l, 41n, 41p are shifted from each other by 180 degrees, and the phase of the light in the regions 41h, 41f, 41d and the phase of the light in the regions 41s, 41u, 41w are shifted from each other by 180 degrees-Here, polarity of the push-pull signal by the third sub-beams is inverted from that of the push-pull signal by the main beam.

FIG. 26B shows a phase of the third sub-beams reflected by the disk 7 and a phase of the third sub-beams diffracted by the disk 7, when the groove pitch of the disk 7 is wide. It is assumed here that the light focusing spots as the third sub-beams are positioned at the center of the track of the disk 7. Regions 41a-41h correspond, respectively, to the positive and negative first order diffracted lights from the regions 15a-15h of the diffraction optical element 3u out of the light reflected by the disk 7 as the zeroth order light. Regions 41i-41p correspond, respectively, to the positive and negative first order diffracted lights from the regions 15a-15h of the diffraction optical element 3u out of the light diffracted by the disk 7 as the positive first order diffracted light. Regions 41q-41x correspond, respectively, to the positive and negative first order diffracted lights from the regions 15a-15h of the diffraction optical element 3u out of the light diffracted by the disk 7 as the negative first order diffracted light. The phase of the light in the regions marked with “+” and “−” in the drawing are +90 degrees and −90 degrees, respectively.

The push-pull signal is detected by utilizing the fact that the light reflected by the disk 7 interferes with the light diffracted by the disk 7 in the overlapping part thereof, and the intensity of the interference light changes depending on the phases of each light. In FIG. 26B, the regions 41g, 41e, 41c, 41a, 41b of the zeroth order light overlap with the regions 41i, 41j, 41l, 41n, 41p of the positive first order diffracted light, respectively, and the regions 41h, 41f, 41d, 41b, 41a of the zeroth order light overlap with the regions 41r, 41q, 41s, 41u, 41w of the −1st diffraction light, respectively. The phase of the light in the regions 41g, 41e, 41c, 41a, 41b and the phase of the light in the regions 41i, 41j, 41l, 41n, 41p are shifted from each other by 180 degrees, and the phase of the light in the regions 41h, 41f, 41d, 41b, 41a and the phase of the light in the regions 41r, 41q, 41s, 41u, 41w are shifted from each other by 180 degrees. Here, polarity of the push-pull signal by the third sub-beams is inverted from that of the push-pull signal by the main beam.

Various push-pull signals related to detection of the track error signal according to this exemplary embodiment are the same as those shown in FIG. 13, because of the reasons described above. In this exemplary embodiment, there is no offset generated in the track error signal by the shift in the lens, as in the case of the fifth exemplary embodiment. Further, the sum of the push-pull signal by the main beam and the push-pull signal by the third sub-beams can be used as the lens position signal.

This exemplary embodiment uses the signal obtained by subtracting the push-pull signal by the third sub-beams from the push-pull signal by the main beam as the track error signal both in the case where the groove pitch of the disk 7 is narrow and in the case where it is wide. Thereby, with both of the two kinds of disks that have different groove pitches, there is no offset generated in the track error signal due to the shift in the lens. Further, the sum of the push-pull signal by the main beam and the push-pull signal by the third sub-beams is used as the lens position signal both in the case where the groove pitch of the disk 7 is narrow and in the case where it is wide.

Various push-pull signals related to detection of the radial tilt according to this exemplary embodiment are the same as those shown in FIG. 5. In this exemplary embodiment, the push-pull signal by the first or second sub-beams under track-servo can be used as the radial tilt error signal, as in the case of the fifth embodiment. With the use of the signal obtained by subtracting the track error signal from the push-pull signal by the first or second sub-beams as the radial tilt error signal, there is no offset generated in the radial tilt error signal by the residual error. Further, with the use of the signal obtained by subtracting the lens position signal from the push-pull signal by the first or second sub-beams as the radial tilt error signal, there is no offset generated in the radial tilt error signal by the shift in the lens. Furthermore, with the use of the signal obtained by subtracting the track error signal and the lens position signal from the push-pull signal by the first or second sub-beams as the radial tilt error signal, there is no offset generated in the radial tilt error signal caused by the residual error and the shift in the lens.

A thirteenth exemplary embodiment of the optical head according to the present invention is obtained by replacing the diffraction optical element 3u of the twelfth exemplary embodiment with a diffraction optical element 3v that is shown in FIG. 27.

FIG. 27 is a plan view of the diffraction optical element 3v. The diffraction optical element 3v is formed in a structure in which a diffraction grating, which is divided Into five regions 15i-15m by eight straight lines that are in parallel to the tangential direction of the disk 7 and are symmetrical with respect to the optical axis of the incident light, is formed on the whole surface including the effective diameter 6a of the objective lens 6 that is illustrated with a dotted line in the drawing. The grating direction in the diffraction grating in all the regions is in parallel to the radial direction of the disk 7, and the pattern of the grating in all the regions is in a linear form of an equivalent pitch. The phase of the grating in the regions 15i, 15k, 15m and the phase of the grating in the regions 15j, 15l are shifted from each other by 150 degrees. The incident light generates the zeroth order light and the positive and negative first order diffracted lights.

The pitch of the grating in the diffraction grating formed in the regions 15i-15m of the diffraction optical element 3v, the pitch of the grating of the diffraction grating formed in the region 13a of the diffraction optical element 3a, and the pitch of the grating of the diffraction grating formed in the region 13b of the diffraction optical element 3b become narrower in this order. Here, the main beam and the third sub-beams contain both the light transmitted through the inside of the region 13a of the diffraction optical element 3a and the light transmitted through the outer side thereof, and both the light transmitted through the inside of the region 13b of the diffraction optical element 3b and the light transmitted through the outer side thereof. The first sub-beams contain only the light diffracted on the inside the region 13a of the diffraction optical element 3a. The second sub-beams contain only the light diffracted on the inside the region 13b of the diffraction optical element 3b. As a result, the intensity distribution of the third sub-beams becomes the same as that of the main beam, the intensity of the first sub-beams in the peripheral part becomes weaker than that of the main beam, and the intensity of the second sub-beams in the peripheral part becomes weaker than that of the first sub-beams.

The order of the diffraction optical elements 3a, 3b and the diffraction optical element 3v may be inverted. Further, the diffraction optical elements 3a and 3b may be replaced with the diffraction optical elements 3c and 3d, respectively.

As in the case of the twelfth exemplary embodiment, a single light focusing spot as the main beam, two light focusing spots as the first sub-beams, two light focusing spots as the second sub-beams, and two light focusing spots as the third sub-beams are disposed on a same track of the disk 7 in this exemplary embodiment.

The pattern of the light-receiving parts of a photodetector and the layout of the optical spots on the photodetector according to this exemplary embodiment are the same as those shown in FIG. 25. With this exemplary embodiment, each of the focus error signal, the push-pull signal by the main beam, the push-pull signal by the first sub-beams, the push-pull signal by the second sub-beams, the push-pull signal by the third sub-beams, as well as a RF signal recorded in the disk 7 can be obtained, as in the case of the twelfth exemplary embodiment. As the track error signal, the signal obtained by subtracting the push-pull signal by the third sunbeams from the push-pull signal by the main beam is used.

Various push-pull signals related to detection of the track error signal according to this exemplary embodiment are the same as those shown in FIG. 13, because of the same reasons described above in the twelfth exemplary embodiment by referring to FIG. 26. In this exemplary embodiment, there is no offset generated in the track error signal by the shift in the lens, as in the case of the fifth exemplary embodiment. Further, the sum of the push-pull signal by the main beam and the push-pull signal by the third sub-beams can be used as the lens position signal.

Various push-pull signals related to detection of the radial tilt according to this exemplary embodiment are the same as those shown in FIG. 5. In this exemplary embodiment, the push-pull signal by the first or second sub-beams under track-servo can be used as the radial tilt error signal, as in the case of the fifth exemplary embodiment. With the use of the signal obtained by subtracting the track error signal from the push-pull signal by the first or second sub-beams as the radial tilt error signal, there is no offset generated in the radial tilt error signal by the residual error. Further, with the use of the signal obtained by subtracting the lens position signal from the push-pull signal by the first or second sub-beams as the radial tilt error signal, there is no offset generated in the radial tilt error signal by the shift in the lens. Furthermore, with the use of the signal obtained by subtracting the track error signal and the lens position signal from the push-pull signal by the first or second sub-beams as the radial tilt error signal, there is no offset generated in the radial tilt error signal caused by the residual error and the shift in the lens.

FIG. 28 shows sectional views of the diffraction optical elements 3a-3v. The outer part of the region 13a of the diffraction optical element 3a, the outer part of the region 13b of the diffraction optical element 3b, the outer part of the region 13c of the diffraction optical element 3c, the outer part of the region 13d of the diffraction optical element 3d, the outer part of the regions 13e, 13f of the diffraction optical element 3e, the outer part of the regions 13g, 13h of the diffraction optical element 3f are configured with a dielectric substance 18a formed on a substrate 17 as shown in FIG. 28A.

The inner part of the region 13a of the diffraction optical element 3a, the inner part of the region 13b of the diffraction optical element 3b, the inner part of the region 13c of the diffraction optical element 3c, the inner part of the region 13d of the diffraction optical element 3d, the region 13f of the diffraction optical element 3e, the region 13h of the diffraction optical element 3f, the whole surface of the diffraction optical element 3g, the whole surface of the diffraction optical element 3h, the whole surface of the diffraction optical element 3i, the whole surface of the diffraction optical element 3j, the whole surface of the diffraction optical element 3k, the whole surface of the diffraction optical element 3l, the region 13t of the diffraction optical element 3m, the region 13v of the diffraction optical element 3n, the region 13x of the diffraction optical element 3o, the region 13z of the diffraction optical element 3p, the regions 14c and 14d of the diffraction optical element 3q, the regions 14g-14j of the diffraction optical element 3r, the regions 14m and 14n of the diffraction optical element 39, the regions 14q and 14r of the diffraction optical element 3t, the regions 15a-15h of the diffraction optical element 3u, and the regions 15i-15m of the diffraction optical element 3v are configured with a dielectric substance 18b formed on the substrate 17 as shown in FIG. 28B.

The region 13e of the diffraction optical element 3e, the region 13g of the diffraction optical element 3f, the region 13s of the diffraction optical element 3m, the region 13u of the diffraction optical element 3n, the region 13w of the diffraction optical element 30, the region 13y of the diffraction optical element 3p, the regions 14a and 14b of the diffraction optical element 3q, the regions 14e and 14f of the diffraction optical element 3r, the regions 14k and 14l of the diffraction optical element 3s, the regions 14o and 14p of the diffraction optical element 3t are configured with a dielectric substance 18c formed on the substrate 17 as shown in FIG. 28C.

The dielectric substance 18a has a flat sectional shape and has height H0. The dielectric substance 18b has a sectional shape in which a line part with width P/2 and a space part with width P/2 are repeated. That is, the pitch of the grating is P. The average height of the line parts and the space parts is H0, and the difference in the heights thereof is 2H1. The dielectric substance 18c has a sectional shape in which a line part with width P/2-A, a space part with width A, a line part with width A, and a line part with width P/2-A are repeated. That is, the pitch of the grating is P. The average height of the line parts and the space parts is H0, and the difference in the heights thereof is 2H2.

It is assumed here that the wavelength of the semiconductor laser 1 is λ, the diffractive index of the dielectric substances 18a, 18b, and 18c is n. The transmittance of the region shown in FIG. 28A is 1. That is, almost 100% of the light making incident on the region shown in FIG. 28 transmits therethrough.

Following equations (1)-(4) apply, provided that the transmittance, the ±1st order diffraction efficiency, and the ±2nd order diffraction efficiency of the region shown in FIG. 28S are ηa0, ηa1, and ηa2, respectively.

ηa0=cos ²(φ1/2) (1)

ηa1=(2/π)² sin ²(φ1/2) (2)

ηa2=0 (3)

φ1=4π(n−1)H1/λ (4)

Assuming that φ1=0.194π, for example, ηa0 is 0.910, ηa1 is 0.036, and ηa2 is 0. That is, about 91.0% of the light making incident on the region shown in FIG. 28B transmits therethrough as the zeroth order light, about 3.6% each is diffracted as the positive and negative first order diffracted light, and no light is diffracted as the positive and negative second order diffracted light.

Following equations (5)-(8) apply, provided that the transmittance, the ±1st order diffraction efficiency, and the ±2nd order diffraction efficiency of the region shown in FIG. 28C are ηb0, ηb1, and ηb2, respectively.

ηb0=cos ²(φ2/2) (5)

ηb2=(2/π)² sin ²(φ2/2)sin ²[π(1−4A/P)2] (6)

ηb2=(1/π)² sin ²(φ2/2){1+ cos [π(1−4A/P)]}² (7)

φ2=4π(n−1)H2/λ (8)

Assuming that φ2=0.295π and A=0.142P, for example, ηb0 is 0.800, ηb1 is 0.032, and ηb2 is 0.030. That is, about 80.0% of the light making incident on the region shown in FIG. 28C is diffracted as the zeroth order light, about 3.2% each is diffracted as the positive and negative first order diffracted light, and about 3.0% each is diffracted as the positive and negative second order diffracted light.

FIG. 29 shows a fourteenth exemplary embodiment of the optical head according to the present invention. In this exemplary embodiment, the diffraction optical elements 3a and 3b of the first exemplary embodiment are replaced with diffraction optical elements 11a and 11b, respectively, variable wave plates 12a, 12b are added between the collimator lens 2 and the diffraction optical element 11a as well as between the diffraction optical element 11b and the polarizing beam splitter 4, and the photodetector 10a is replaced with a photodetector 10d. The variable wave plates 12a and 12b correspond to “intensity distribution changing device” depicted in the scope of the appended claims.

The diffraction optical elements 11a and 11b work to transmit a polarized light component of a specific direction out of the incident light, and to divide a polarized light component that is orthogonal to the aforementioned polarized light component into three rays of light, i.e., the transmission light and the positive and negative first order diffracted lights. Further, the variable wave plates 12a and 12b are liquid crystal optical elements including liquid crystal molecules, which work either to change or not to change the polarizing direction of the incident light by 90 degrees. Note here that the directions of the P-polarized light and the S-polarized light with respect to the polarizing beam splitter 4 are taken as the X-axis and the Y-axis, respectively, and the traveling direction of the light is taken as the Z-axis.

When no voltage is applied to the liquid crystal optical elements, the liquid crystal molecules are aligned in the direction of 45 degrees with respect to the X-axis and the Y-axis on an X-Y plane. Emitted light from the semiconductor laser 1 makes incident on the variable wave plate 12a as linearly polarized light of the X-axis direction When this light transmits through the liquid crystal optical elements, a phase difference is generated between a polarized light component of the direction in parallel to the liquid crystal molecules and a polarized light component of the direction orthogonal thereto. This phase difference is set as 180 degrees, so that the polarizing direction of the light transmitted through the liquid crystal optical elements is changed by 90 degrees. That is, emitted light from the variable wave plate 12a makes incident on the diffraction optical element 11a as the linearly polarized light of the Y-axis direction. The specific direction in the diffraction optical element 11a is the X-axis direction, so that the light is divided by the diffraction optical element 11a into three rays of light, i.e., the transmission light and the positive and negative first order diffracted lights, and those light beams make incident on the diffraction optical element 11b as the linearly polarized light of the Y-axis direction. The specific direction in the diffraction optical element 11b is the Y-axis direction, so that those light beams transmit therethrough and make incident on the variable wave plate 12b as the linearly polarized light of the Y-axis direction. When those light beams transmit through the liquid crystal optical elements, a phase difference is generated between a polarized light component of the direction in parallel to the liquid crystal molecules and a polarized light component of the direction orthogonal thereto. This phase difference is set as 180 degrees, so that the polarizing direction of the light transmitted through the liquid crystal optical elements is changed by 90 degrees. That is, emitted light from the variable wave plate 12b travels towards the polarizing beam splitter 4 as the linearly polarized light of the X-axis direction.

In the meantime, when a voltage is applied to the liquid crystal optical elements, the liquid crystal molecules are aligned in the Z-axis direction. Emitted light from the semiconductor laser 1 makes incident on the variable wave plate 12a as linearly polarized light of the X-axis direction. When this light transmits through the liquid crystal optical elements, no phase difference is generated. Thus, there is no change in the polarizing direction of the light that has transmitted through the liquid crystal optical elements. That is, the emitted light from the variable wave plate 12a makes incident on the diffraction optical element 11a as the linearly polarized light of the X-axis direction. The specific direction in the diffraction optical element 11a is the X-axis direction, so that the light transmits through the diffraction optical element 11a and makes incident on the diffraction optical element 11b as the linearly polarized light of the X-axis direction. The specific direction in the diffraction optical element 11b is the Y-axis direction, so that the light is divided by the diffraction optical element 11b into three rays of light, i.e., the transmission light and the positive and negative first order diffracted lights, and those light beams make incident on the variable wave plate 12b as the linearly polarized light of the X-axis direction. Since no phase difference is generated even after those light beams transmit through the liquid crystal optical elements, there is no change in the polarizing direction of the light that has transmitted through the liquid crystal optical elements. That is, emitted light from the variable wave plate 12b travels towards the polarizing beam splitter 4 as the linearly polarized light of the X-axis direction.

In both cases, the emitted light from the semiconductor laser 1 is divided by the diffraction optical elements 11a and 11b into three rays of light in total, i.e., a single ray of transmission light as a main beam, and two rays of diffraction light as sub-beams. The main beam is the transmission light from the diffraction optical elements 11a, 11b, the sub-beams are the positive and negative first order diffracted lights from the diffraction optical element 11a that are the transmission light from the diffraction optical element 11b, or the positive and negative first order diffracted lights from the diffraction optical element 11b that are the transmission tight from the diffraction optical element 11a.

The plan views of the diffraction optical elements 11a and 11b according to this exemplary embodiment are the same as those shown in FIG. 2A and FIG. 2B, respectively. However, the pitch of the grating in the diffraction grating formed in the region 13a of the diffraction optical element 11a is equivalent to that of the diffraction grating formed in the region 13b of the diffraction optical element 11b.

When no voltage is applied to the liquid crystal optical elements that configure the variable wave plates 12a, 12b, almost 87.3% of the light making incident on the inside the region 13a of the diffraction optical element 11a, for example, transmits therethrough as the zeroth order light, and about 5.1% each is diffracted as the positive and negative first order diffracted light. Further, almost 100% of the light making incident on the outer side of the region 13a transmits therethrough. In the meantime, almost 100% of the light making incident on the inside and outer side of the region 13b of the diffraction optical element 11b transmits therethrough. Here, the main beam contains both the light transmitted through the inside the region 13a of the diffraction optical element 11a and the light transmitted through the outer side thereof. The sub-beams contain only the light diffracted on the inside the region 13a of the diffraction optical element 11a. As a result, the intensity of the sub-beams in the peripheral part becomes weaker than that of the main beam.

Meanwhile, when a voltage is applied to the liquid crystal optical elements that configure the variable wave plates 12a, 12b, almost 87.3% of the light making incident on the inside the region 13b of the diffraction optical element 11b, for example, transmits therethrough as the zeroth order light, and about 5.1% each is diffracted as the positive and negative first order diffracted light. Further, almost 100% of the light making incident on the outer side of the region 13b transmits therethrough. In the meantime, almost 100% of the light making incident on the inside and outer side of the region 13a of the diffraction optical element 11a transmits therethrough. Here, the main beam contains both the light transmitted through the inside the region 13b of the diffraction optical element 11b and the light transmitted through the outer side thereof. The sub-beams contain only the light diffracted on the inside the region 13b of the diffraction optical element 11b. As a result, the intensity of the sub-beams in the peripheral part becomes weaker than that of the main beam.

The order of the diffraction optical elements 11a and 11b may be inverted. Further, instead of the diffraction optical elements 11a and 11b, diffraction optical elements that have the same plan views as those shown in FIG. 6A and FIG. 6B may be used.

FIG. 30 shows the layout of the light focusing spots on the disk 7. FIG. 30A shows a case where the groove pitch of the disk 7 is narrow, and FIG. 30B shows a case where it is wide.

When the groove pitch of the disk 7 is narrow, no voltage is applied to the liquid crystal optical elements that configure the variable wave plates 12a and 12b. Here, the light focusing spots 24a, 24b, and 24c correspond, respectively, to the transmission light from the diffraction optical elements 11a and 11b, to the positive first order diffracted light from the diffraction optical element 11a that is the transmission light from the diffraction optical element 11b, and to the negative first order diffracted light from the diffraction optical element 11a that is the transmission light from the diffraction optical element 11b. The light focusing spots 24a, 24b, and 24c are on a same track 22a. The light focusing spots 24b and 24c as the sub-beams have the larger diameter than that of the light focusing spot 24a as the main beam.

When the groove pitch of the disk 7 is wide, a voltage is applied to the liquid crystal optical elements that configure the variable wave plates 12a and 12b. Here, the light focusing spots 24a, 24b, and 24c correspond, respectively, to the transmission light from the diffraction optical elements 11a, 11b, to the positive first order diffracted light from the diffraction optical element 11b that is the transmission light from the diffraction optical element 11a, and to the negative first order diffracted light from the diffraction optical element 11b that is the transmission light from the diffraction optical element 11a. The light focusing spots 24a, 24b, and 24c are on a same track 22b. The light focusing spots 24h and 24c as the sub-beams have the larger diameter than that of the light focusing spot 24a as the main beam.

FIG. 31 shows the pattern of a light-receiving part of the photodetector 10d and layout of optical spots on the photodetector 10d. The optical spot 33a corresponds to transmission light from the diffraction optical elements 11a, 11b, and it is received by light-receiving parts 32a-32d which are divided into four by a dividing line that is in parallel to the tangential direction of the disk 7 passing through the optical axis and by a dividing line that is in parallel to the radial direction. The optical spot 33b corresponds to the positive first order diffracted light from the diffraction optical element 11a that is the transmission light from the diffraction optical element 11b in the case where a voltage is not applied to the liquid crystal optical elements that configure the variable wave plates 12a, 12b, and corresponds to the positive first order diffracted light from the diffraction optical element 11b that is the transmission light from the diffraction optical element 11a in the case where a voltage is applied. The light is received by light-receiving parts 32e and 32f which are divided into two by a dividing line that is in parallel to the radial direction of the disk 7 passing through the optical axis. The optical spot 33c corresponds to the negative first order diffracted light from the diffraction optical element 11a that is the transmission light from the diffraction optical element 11b in the case where a voltage is not applied to the liquid crystal optical elements that configure the variable wave plates 12a and 12b, and corresponds to the negative first order diffracted light from the diffraction optical element 11b that is the transmission light from the diffraction optical element 11a in the case where a voltage is applied. The light is received by light-receiving parts 32g and 32h which are divided into two by a dividing line that is in parallel to the radial direction of the disk 7 passing through the optical axis. The intensity distribution in the tangential direction of the disk 7 and the intensity distribution in the radial direction are switched from each other in the optical spots 33a-33c, because of the effects of the cylindrical lens 8 and the convex lens 9. The light-receiving parts 32a-32d and the light-receiving parts 32e-32h correspond to “first light-receiving part group” and “second light-receiving part group” depicted in the appended claims, respectively.

When outputs from the light-receiving parts 32a-32h are expressed as V32a-V32h, respectively, a focus error signal can be obtained by an arithmetic operation of (V32a+V32d)-(V32b+V32c) based on the astigmatism method. A push-pull signal by the main beam can be given by (V32a+V32b)-(V32c+V32d), and a push-pull signal by the sub-beams can be given by (V32e+V32g)-(V32f+V32h). The push-pull signal by the main beam is used as a track error signal. The RF signal recorded in the disk 7 can be obtained by an arithmetic operation of (V32a+V32b+V32c+V32d).

Various push-pull signals related to detection of the radial tilt according to this exemplary embodiment are the same as those shown in FIG. 5. In this exemplary embodiment, the push-pull signal by the sub-beams under track-servo can be used as the radial tilt error signal.

In this exemplary embodiment, when no voltage is applied to the liquid crystal optical elements that configure the variable wave plates 12a, 12b, NA for the sub-beams depends on the diameter of the region 13a of the diffraction optical element 11a. The NA for the sub-beam is so set that the absolute value of the radial tilt error signal for the disk with a narrow groove pitch becomes the maximum. In the mean time, when a voltage is applied to the liquid crystal optical elements that configure the variable wave plates 12a, 12b, NA for the sub-beams depends on the diameter of the region 13b of the diffraction optical element 11b. The NA for the sub-beams is so set that the absolute value of the radial tilt error signal for the disk with a wide groove pitch becomes the maximum. This makes it possible to detect the radial tilt with high sensitivity with both of the two kinds of disks having different groove pitches.

This exemplary embodiment uses the liquid crystal optical elements including liquid crystal molecules as the variable wave plates 12a and 12b. However, half wavelength plates having a rotary mechanism that rotates about the Z-axis can also be used as the variable wave plates 12a and 12b.

When the half wavelength plates are not rotated, the optical axis of the half wavelength plate is in parallel to the direction that makes 45 degrees with respect to the X-axis and the Y-axis on the X-Y plane. Emitted light from the semiconductor laser 1 makes incident on the variable wave plate 12a as linearly polarized light of the X-axis direction. When this light transmits through the half wavelength plates, a phase difference is generated between a polarized light component of the direction in parallel to the optical axis and a polarized light component of the direction orthogonal the aforementioned polarized light component. This phase difference is set as 180 degrees, so that the polarizing direction of the light transmitted through the half wavelength plate is changed by 90 degrees. That is, emitted light from the variable wave plate 12a makes incident on the diffraction optical element 11a as the linearly polarized light of the Y-axis direction. The specific direction in the diffraction optical element 11a is the X-axis direction, so that the light is divided by the diffraction optical element 11a into three rays of light, i.e., the transmission light and the positive and negative first order diffracted lights, and those light beams make incident on the diffraction optical element 11b is the linearly polarized light of the Y-axis direction. The specific direction in the diffraction optical element 11b is the Y-axis direction, so that those light beams transmit therethrough and make incident on the variable wave plate 12b as the linearly polarized light of the Y-axis direction. When those light beams transmit through the halt wavelength plates, a phase difference is generated between a polarized light component of the direction in parallel to the optical axis and a polarized light component of the direction orthogonal thereto. This phase difference is set as 180 degrees, so that the polarizing direction of the light transmitted through the half wavelength plates is changed by 90 degrees. That is, emitted light from the variable wave plate 12b travels towards the polarizing beam splitter 4 as the linearly polarized light of the X-axis direction.

In the meantime, when the half wavelength plate is rotated by 45 degrees, the optical axis of the half wavelength plate becomes in parallel to the X-axis direction or the Y-axis direction on the X-Y plane. Emitted light from the semiconductor laser 1 makes incident on the variable wave plate 12a as linearly polarized light of the X-axis direction. When this light transmits through the half wavelength plate, no phase difference is generated. Thus, there is no change in the polarizing direction of the light that has transmitted through the half wavelength plate. That is, the emitted light from the variable wave plate 12a makes incident on the diffraction optical element 11a as the linearly polarized light of the X-axis direction. The specific direction in the diffraction optical element 11a is the X-axis direction, so that the light transmits through the diffraction optical element 11a and makes incident on the diffraction optical element 11b as the linearly polarized light of the 7-axis direction. The specific direction in the diffraction optical element 11b is the Y-axis direction, so that the light is divided by the diffraction optical element 11b into three rays of light, i.e., the transmission light and the positive and negative first order diffracted lights, and those light beams make incident on the variable wave plate 12b as the linearly polarized light of the X-axis direction. Since no phase difference is generated even after those light beams transmit through the half wavelength plates, there is no change in the polarizing direction of the light that has transmitted through the half wavelength plate. That is, emitted light from the variable wave plate 12b travels towards the polarizing beam splitter 4 as the linearly polarized light of the X-axis direction.

FIG. 32 shows a fifteenth exemplary embodiment of the optical head according to the present invention. In this exemplary embodiment, diffraction optical elements 11c, 11d are added between the diffraction optical elements 11a, 11b and the variable wave plate 12b of the fourteenth exemplary embodiment, and the photodetector 10d is replaced with a photodetector 10a. The diffraction optical elements 11c and 11d work to transmit a polarized light component of a specific direction out of the incident light, and to divide a polarized light component that is orthogonal to the aforementioned polarized light component into three rays of light, i.e., the transmission light and the positive and negative first order diffracted lights.

The emitted light from the semiconductor laser 1 is divided by the diffraction optical elements 11a, 11b, 11c, and 11d into five rays of light in total, i.e., a single ray of transmission light as the main beam, two rays of diffraction light as the first sub-beams, and two rays of diffraction light as the second sub-beams. When no voltage is applied to the liquid crystal optical elements, the main beam is the transmission light from the diffraction optical elements 11a, 11b, 11c, and 11d/the first sub-beams are the positive and negative first order diffracted lights from the diffraction optical element 11a that are the transmission light from the diffraction optical element 11b, 11c, and 11d, and the second sub-beams are the positive and negative first order diffracted lights from the diffraction optical element 11c that are the transmission light from the diffraction optical element 11a, 11b, and 11d. In the meantime, when a voltage is applied to the liquid crystal optical elements, the main beam is the transmission light from the diffraction optical elements 11a, 11b, 11c, and 11d, the first sub-beams are the positive and negative first order diffracted lights from the diffraction optical element 11b that are the transmission light from the diffraction optical element 11a, 11c, and 11d, and the second sub-beams are the positive and negative first order diffracted lights from the diffraction optical element 11d that are the transmission light from the diffraction optical element 11a, 11b, and 11c.

The plan views of the diffraction optical elements 11a and 11b according to this exemplary embodiment are the same as those shown in FIG. 2A and FIG. 2B, respectively. However, the pitch of the grating in the diffraction grating formed in the region 13a of the diffraction optical element 11a is equivalent to that of the diffraction grating formed in the region 13b of the diffraction optical element 11b. Further, the direction of the diffraction grating formed in the region 13a of the diffraction optical element 11a and the direction of the diffraction grating formed in the region 13b of the diffraction optical element 11b are slightly tilted with respect to the radial direction of the disk 7.

The plan views of the diffraction optical elements 11c and 11d according to this exemplary embodiment are the same as those shown in FIG. 10A and FIG. 10B, respectively. However, the pitch of the grating in the diffraction grating formed on the whole surface of the diffraction optical element 11c is equivalent to that of the diffraction grating formed on the whole surface of the diffraction optical element 11d.

When no voltage is applied to the liquid crystal optical elements that configure the variable wave plates 12a, 12b, almost 87.3% of the light making incident on the diffraction optical element 11c, for example, transmits therethrough as the zeroth order light, and about 5.1% each is diffracted as the positive and negative first order diffracted light. In the meantime, almost 100% of the light making incident on the diffraction optical element 11d transmits therethrough. The pitch of the diffraction grating formed on the whole surface of the diffraction optical element 11c is wider than that of the diffraction grating formed in the region 13a of the diffraction optical element 11a. Here, the main beam and the second sub-beams contain both the light transmitted through the inside the region 13a of the diffraction optical element 11a and the light transmitted through the outer side thereof. The first sub-beams contain only the light diffracted on the inside the region 13a of the diffraction optical element 11a. As a result, the intensity distribution of the second sub-beams is the same as that of the main beam, and the intensity of the first sub-beams in the peripheral part becomes weaker than that of the main beam.

Meanwhile, when a voltage is applied to the liquid crystal optical elements that configure the variable wave plates 12a, 12b, almost 87.3% of the light making incident on the diffraction optical element 11d, for example, transmits therethrough as the zeroth order light, and about 51% each is diffracted as the positive and negative first order diffracted light. In the meantime, almost 100% of the light making incident on the diffraction optical element 11c transmits therethrough. The pitch of the diffraction grating formed on the whole surface of the diffraction optical element 11d is wider than that of the diffraction grating formed in the region 13b of the diffraction optical element 11b. Here, the main beam and the second beams contain both the light transmitted through the inside the region 13b of the diffraction optical element 11b and the light transmitted through the outer side thereof. The first sub-beams contain only the light diffracted on the inside the region 13b of the diffraction optical element 11b. As a result, the intensity distribution of the second sub-beams is the same as that of the main beam, and the intensity of the first sub-beams in the peripheral part becomes weaker than that of the main beam.

The order of the diffraction optical elements 11c and 11d may be inverted. Further, the order of the diffraction optical elements 11a, 11b and the diffraction optical elements 11c, 11d may be inverted. Furthermore, instead of the diffraction optical elements 11a and 11b, diffraction optical elements that have the same plan views as those shown in FIG. 6A and FIG. 6B may be used.

FIG. 33 shows the layout of the light focusing spots on the disk 7. FIG. 33A shows a case where the groove-itch of the disk 7 is narrow, and FIG. 33B shows a case where it is wide.

When the groove pitch of the disk 7 is narrow, no voltage is applied to the liquid crystal optical elements that configure the variable wave plates 12a and 12b. Here, the light focusing spots 24a, 24d, 24e, 24f, and 24g correspond, respectively, to the transmission light from the diffraction optical elements 71a, 11b, 11c, and 11d, to the positive first order diffracted light from the diffraction optical element 11a that is the transmission light from the diffraction optical elements 11b, 11c, and 11d, to the negative first order diffracted light from the diffraction optical element 11a that is the transmission light from the diffraction optical element 11b, 11c, and 11d, to the positive first order diffracted light from the diffraction optical element 11c that is the transmission light from the diffraction optical elements 11a, 11b, and 11d, and to the negative first order diffracted light from the diffraction optical element 11c that is the transmission light from the diffraction optical elements 11a, 11b, and 11d. The light focusing spot 24a is on a track 22a (land or groove), the light focusing spot 24f is on a track (groove or land) right next to the track 22a on the right side, the light focusing spot 24g is on a track (groove or land) right next to the track 22a on the left side, the light focusing spot 24d is on a second track (land or groove) from the track 22a on the right side, and the light focusing spot 24e is on a second track (land or groove) from the track 22a on the left side. The light focusing spots 24f and 24g as the second sub-beams have the same diameter as that of the light focusing spot 24a as the main beam. Further, the light focusing spots 24d and 24e as the first sub-beams have the larger diameter than that of the light focusing spot 24a as the main beam.

When the groove pitch of the disk 7 is wide, a voltage is applied to the liquid crystal optical elements that configure the variable wave plates 12a and 12b. Here, the light focusing spots 24a, 24d, 24e, 24f, and 24g correspond, respectively, to the transmission light from the diffraction optical elements 11a, 11b, 11c, and 11d, to the positive first order diffracted light from the diffraction optical element 11b that is the transmission light from the diffraction optical elements 11a, 11c, and 11d, to the negative first order diffracted light from the diffraction optical element 11b that is the transmission light from the diffraction optical element 11a, 11c, and 11d, to the positive first order diffracted light from the diffraction optical element 11d that is the transmission light from the diffraction optical elements 11a, 11b, and 11c, and to the negative first order diffracted light from the diffraction optical element 11d that is the transmission light from the diffraction optical elements 11a, 11b, and 11c. The light focusing spot 24a is on a track 22b (land or groove), the light focusing spot 24f is on a track (groove or land) right next to the track 22b on the right side, the light focusing spot 24g is on a track (groove or land) right next to the track 22b on the left side, the light focusing spot 24d is on a second track (land or groove) from the track 22b on the right side, and the light focusing spot 24e is on a second track (land or groove) from the track 22b on the left side. The light focusing spots 24f and 24g as the second sub-beams have the same diameter as that of the light focusing spot 24a as the main beam. Further, the light focusing spots 24d and 24e as the first sub-beams have the larger diameter than that of the light focusing spot 24a as the main beam.

The pattern of the light-receiving parts of the photodetector and layout of the optical spots on the photodetector are the same as those shown in FIG. 4. The optical spot 27a corresponds to the transmission light from the diffraction optical elements 11a, 11b, 11c, 11d, and it is received by light-receiving parts 26a-26d which are divided into four by a dividing line that is in parallel to the tangential direction of the disk 7 passing through the optical axis and by a dividing line that is in parallel to the radial direction. The optical spot 27d corresponds to the positive first order diffracted light from the diffraction optical element 11a that is the transmission light from the diffraction optical elements 11b, 11c, and 11d in the case where no voltage is applied to the diffraction optical elements that configure the variable wave plates 12a and 12b, and corresponds to the positive first order diffracted light from the diffraction optical element 11b that is the transmission light from the diffraction optical elements 11a-11c, and 11d in the case where a voltage is applied. The light is received by light-receiving parts 26l and 26j which are divided into two by a dividing line that is in parallel to the radial direction of the disk 7 passing through the optical axis. The optical spot 27e corresponds the negative first order diffracted light from the diffraction optical element 11a that is the transmission light from the diffraction optical elements 11b, 11c, and 11d in the case where no voltage is applied to the diffraction optical elements that configure the variable wave plates 12a and 12b, and corresponds to the negative first order diffracted light from the diffraction optical element 11b that is the transmission light from the diffraction optical elements 11a, 11c, and 11d in the case where a voltage is applied. The light is received by light-receiving parts 26k and 26l which are divided into two by a dividing line that is in parallel to the radial direction of the disk 7 passing through the optical axis. The optical spot 27b corresponds the positive first order diffracted light from the diffraction optical element 11c that is the transmission light from the diffraction optical elements 11a, 11b, and 11d in the case where no voltage is applied to the diffraction optical elements that configure the variable wave plates 12a and 12b, and corresponds to the positive first order diffracted light from the diffraction optical element 11d that is the transmission light from the diffraction optical elements 11a, 11b, and 11c in the case where a voltage is applied. The light is received by light-receiving parts 26e and 26f which are divided into two by a dividing line that is in parallel to the radial direction of the disk 7 passing through the optical axis. The optical spot 27c corresponds the negative first order diffracted light from the diffraction optical element 11c that is the transmission light from the diffraction optical elements 11a, 11b, and 11d in the case where no voltage is applied to the diffraction optical elements that configure the variable wave plates 12a and 12b, and corresponds to the negative first order diffracted light from the diffraction optical element 11d that is the transmission light from the diffraction optical elements 11a, 11b, and 11c in the case where a voltage is applied. The light is received by light-receiving parts 26g and 26h which are divided into two by a dividing line that is in parallel to the radial direction of the disk 7 passing through the optical axis. The intensity distribution in the tangential direction of the disk 7 and the intensity distribution in the radial direction are switched from each other in the optical spots 27a-27e, because of the effects of the cylindrical lens 8 and the convex lens 9.

When outputs from the light-receiving parts 26a-26l are expressed as V26a-V26l, respectively, a focus error signal can be obtained by an arithmetic operation of (V26a+V26d)-(V26b+V26c) based on the astigmatism method. A push-pull signal by the main beam can be given by (V26a+V26b)-(V26c+V26d), a push-pull signal by the first sub-beams can be given by (V26i+V26k)-(V26j+V26l), and a push-pull signal by the second sub-beams can be given by (V26e+V26g)-(V26f+V26h). The signal obtained by subtracting the push-pull signal by the second sub-beams from the push-pull signal by the main beam is used as a track error signal. The RF signal recorded in the disk 7 can be obtained by an arithmetic operation of (V26a+V26b+V26c+V26d).

Various push-pull signals related to detection of the track error signal according to this exemplary embodiment are the same as those shown in FIG. 13. In this exemplary embodiment, there is no offset generated in the track error signal by the shift in the lens, as in the case of the fifth exemplary embodiment. Further, the sum of the push-pull signal by the main beam and the push-pull signal by the second sub-beams can be used as the lens position signal.

Various push-pull signals related to detection of the radial tilt according to this exemplary embodiment are the same as those shown in FIG. 5. In this exemplary embodiment, the push-pull signal by the first sub-beams under track-servo can be used as the radial tilt error signal, as in the case of the fourteenth exemplary embodiment. With the use of the signal obtained by subtracting the track error signal from the push-pull signal by the first sub-beams as the radial tilt error signal, there is no offset generated in the radial tilt error signal by the residual error. Further, with the use of the signal obtained by subtracting the lens position signal from the push-pull signal by the first sub-beams as the radial tilt error signal, there is no offset generated in the radial tilt error signal by the shift in the lens. Furthermore, with the use of the signal obtained by subtracting the track error signal and the lens position signal from the push-pull signal by the first sub-beams as the radial tilt error signal, there is no offset generated in the radial tilt error signal caused by the residual error and the shift in the lens.

A sixteenth exemplary embodiment of the optical head according to the present invention is obtained by replacing the diffraction optical elements 11c, 11d of the fifteenth exemplary embodiment, respectively, with diffraction optical elements 11e, 11f to be described later. The diffraction optical elements 11e and 11f work to transmit a polarized light component of a specific direction out of the incident light, and to divide a polarized light component that is orthogonal to the aforementioned polarized light component into three rays of light, i.e., the transmission light and the positive and negative first order diffracted lights.

The plan views of the diffraction optical elements 11e and 11f according to this exemplary embodiment are the same as those shown in FIG. 14A and FIG. 14B, respectively. However, the pitch of the grating in the diffraction grating formed on the whole surface of the diffraction optical element 11e is equivalent to that of the diffraction grating formed on the whole surface of the diffraction optical element 11f.

When no voltage is applied to the liquid crystal optical elements that configure the variable wave plates 12a, 12b, the light making incident on the diffraction optical element 11e generates the zeroth order light and the positive and negative first order diffracted lights. The pitch of the diffraction grating formed on the whole surface of the diffraction optical element 11e is wider than that of the diffraction grating formed in the region 13a of the diffraction optical element 11a. Here, the main beam and the second sub-beams contain both the light transmitted through the inside the region 13a of the diffraction optical element 11a and the light transmitted through the outer side thereof. The first sub-beams contain only the light 2a diffracted on the inside the region 13a of the diffraction optical element 11a. As a result, the intensity distribution of the second sub-beams is the same as that of the main beam, and the intensity of the first sub-beams in the peripheral part becomes weaker than that of the main beam.

In the meantime, when a voltage is applied to the liquid crystal optical elements that configure the variable wave plates 12a, 12b, the light making incident on the diffraction optical element 11f generates the zeroth order light and the positive and negative first order diffracted lights. The pitch of the diffraction grating formed on the whole surface of the diffraction optical element 11f is wider than that of the diffraction grating formed in the region 13b of the diffraction optical element 11b. Here, the main beam and the second sub-beams contain both the light transmitted through the inside the region 13b of the diffraction optical element 11b and the light transmitted through the outer side thereof. The first sub-beams contain only the light diffracted on the inside the region 13b of the diffraction optical element 11b. As a result, the intensity distribution of the second sub-beams is the same as that of the main beam, and the intensity of the first sub-beams in the peripheral part becomes weaker than that of the main beam.

The order of the diffraction optical elements 11e and 11f may be inverted. Further, the order of the diffraction optical elements 11a, 11b and the diffraction optical elements 11e, 11f may be inverted. Furthermore, instead of the diffraction optical elements 11a and 11b, diffraction optical elements that have the same plan views as those shown in FIG. 6A and FIG. GB may be used. Moreover, instead of the diffraction optical elements 11e and 11f, diffraction optical elements that have the same plan views as those shown in FIG. 17A and FIG. 17B may be used.

FIG. 34 shows the layout of the light focusing spots on the disk 7. FIG. 34A shows a case where the groove pitch of the disk 7 is narrow, and FIG. 34B shows a case where it is wide.

When the groove pitch of the disk 7 is narrow, no voltage is applied to the liquid crystal optical elements that configure the variable wave plates 12a and 12b. Here, the light focusing spots 24a, 24b, 24o, 24h, and 24i correspond, respectively, to the transmission light from the diffraction optical elements 11a, 11b, 11e, and 11f, to the positive first order diffracted light from the diffraction optical element 11a that is the transmission light from the diffraction optical elements 11b, 11e, and 11f, to the negative first order diffracted light from the diffraction optical element 11a that is the transmission light from the diffraction optical element 11b, 11e, and 11f, to the positive first order diffracted light from the diffraction optical element 11e that is the transmission light from the diffraction optical elements 11a, 11b, and 11f, and to the negative first order diffracted light from the diffraction optical element 11e that is the transmission light from the diffraction optical elements 11a, 11b, and 11f. The light focusing spots 24a, 24b, 24c, 24h, and 24i are on a same track 22a. The light focusing spots 24h and 24i as the second sub-beams have two peaks with the same intensity on the left side and right side of the radial direction of the disk 7. In the meantime, the light focusing spots 24b and 24c as the first sub-beams have the larger diameter than that of the light focusing spot 24a as the main beam.

When the groove pitch of the disk 7 is wide, a voltage is applied to the liquid crystal optical elements that configure the variable wave plates 12a and 12b. Here, the light focusing spots 24a, 24b, 24c, 24h, and 24i correspond, respectively, to the transmission light from the diffraction optical elements 11a, 11b, 11e, and 11f, to the positive first order diffracted light from the diffraction optical element 11b that is the transmission light from the diffraction optical elements 11a, 11e, and 11f, to the negative first order diffracted light from the diffraction optical element 11T that is the transmission light from the diffraction optical element 11a, 11e, and 11f, to the positive first order diffracted light from the diffraction optical element 11f that is the transmission light from the diffraction optical elements 11a, 11b, and 11e, and to the negative first order diffracted light from the diffraction optical element 11f that is the transmission light from the diffraction optical elements 11a, 11h, and 11e. The light focusing spots 24a, 24b, 24c, 24h, and 24i are on a same track 22b. The light focusing spots 24h and 24i as the second sub-beams have two peaks with the same intensity on the left side and right side of the radial direction of the disk 7. In the meantime, the light focusing spots 24b and 24c as the first sub-beams have the larger diameter than that of the light focusing spot 24a as the main beam.

The pattern of the light-receiving parts of a photodetector and the layout of the optical spots on the photodetector according to this exemplary embodiment are the same as those shown in FIG. 4. With this exemplary embodiment, each of the focus error signal, the push-pull signal by the main beam, the push-pull signal by the first sub-beams, the push-pull signal by the second sub-beams, as well as a RF signal recorded in the disk 7 can be obtained, as in the case of the fifteenth exemplary embodiment. As the track error signal, the signal obtained by subtracting the push-pull signal by the second sub-beams from the push-pull signal by the main beam is used.

Various push-pull signals related to detection of the track error signal according to this exemplary embodiment are the same as those shown in FIG. 13, because of the same reasons described above in the sixth exemplary embodiment by referring to FIG. 16. In this exemplary embodiment, there is no offset generated in the track error signal by the shift in the lens, as in the case of the fifteenth exemplary embodiment. Further, the sum of the push-pull signal by the main beam and the push-pull signal by the second sub-beams can be used as the lens position signal.

Various push-pull signals related to detection of the radial tilt according to this exemplary embodiment are the same as those shown in FIG. 5. In this exemplary embodiment, the push-pull signal by the first sub-beams under track-servo can be used as the radial tilt error signal, as in the case of the fifteenth exemplary embodiment. With the use of the signal obtained by subtracting the track error signal from the push-pull signal by the first sub-beams as the radial tilt error signal, there is no offset generated in the radial tilt error signal by the residual error. Further, with the use of the signal obtained by subtracting the lens position signal from the push-pull signal by the first sub-beams as the radial tilt error signal, there is no offset generated in the radial tilt error signal by the shift in the lens. Furthermore, with the use of the signal obtained by subtracting the track error signal and the lens position signal from the push-pull signal by the first sub-beams as the radial tilt error signal, there is no offset generated in the radial tilt error signal caused by the residual error and the shift in the lens.

As another exemplary embodiment of the optical head according to the present invention, the diffraction optical elements 11a, 11c of the fifteenth exemplary embodiment may be replaced with a single diffraction optical element 11g having the same plan view as the one shown in FIG. 18A, and the diffraction optical elements 11b, 11d may be replaced with a single diffraction optical element 11h having the same plan view as the one shown in FIG. 18B. The diffraction optical elements 11g and 11h work to transmit a polarized light component of a specific direction out of the incident light, and to divide a polarized light component that is orthogonal to the aforementioned polarized light component into five rays of light, i.e., the transmission light, the positive and negative first order diffracted lights, and the positive and negative second order diffracted lights.

As another exemplary embodiment of the optical head according to the present invention, the diffraction optical elements 11a, 11c of the fifteenth exemplary embodiment may be replaced with a single diffraction optical element 11i having the same plan view as the one shown in FIG. 19A, and the diffraction optical elements 11b, 11d may be replaced with a single diffraction optical element 11j having the same plan view as the one shown in FIG. 19B. The diffraction optical elements 11i and 11j work to transmit a polarized light component of a specific direction out of the incident light, and to divide a polarized light component that is orthogonal to the aforementioned polarized light component into five rays of light, i.e., the transmission light, the positive and negative first order diffracted lights, and the positive and negative second order diffracted light.

As another exemplary embodiment of the optical head according to the present invention, the diffraction optical elements 11a, 11e of the sixteenth exemplary embodiment may be replaced with a single diffraction optical element 11k having the same plan view as the one shown in FIG. 20A, and the diffraction optical elements 11b-11f may be replaced with a single diffraction optical element 11l having the same plan view as the one shown in FIG. 20B. The diffraction optical elements 11k and 11l work to transmit a polarized light component of a specific direction out of the incident light, and to divide a polarized light component that is orthogonal to the aforementioned polarized light component into five rays of light, i.e., the transmission light, the positive and negative first order diffracted lights, and the positive and negative second order diffracted lights.

As another exemplary embodiment of the optical head according to the present invention, the diffraction optical elements 11a, 11e of the sixteenth exemplary embodiment may be replaced with a single diffraction optical element 11m having the same plan view as the one shown in FIG. 21A, and the diffraction optical elements 11b, 11f may be replaced with a single diffraction optical element 11n having the same plan view as the one shown in FIG. 21B. The diffraction optical elements 11m and 11n work to transmit a polarized light component of a specific direction out of the incident light, and to divide a polarized light component that is orthogonal to the aforementioned polarized light component into five rays of light, i.e., the transmission light, the positive and negative first order diffracted lights, and the positive and negative second order diffracted lights.

FIG. 35 shows a seventeenth exemplary embodiment of the optical head according to the present invention. In this exemplary embodiment, diffraction optical elements 11c, 11d of the fifteenth exemplary embodiment are replaced with a single diffraction optical element 3u that is provided between the variable wave plate 12b and the polarizing beam splitter 4.

The emitted light from the semiconductor laser 1 is divided by the diffraction optical elements 11a, 11b, and 3u into five rays of light in total, i.e., a single ray of transmission light as the main beam, two rays of diffraction light as the first sub-beams, and two rays of diffraction light as the second sub-beams. When no voltage is applied to the liquid crystal optical elements, the main beam is the transmission light from the diffraction optical elements 11a, 11b, and 3u, the first sub-beams are the positive and negative first order diffracted lights from the diffraction optical element 11a that is the transmission light from the diffraction optical element 11b and 3u, and the second sub-beams are the positive and negative first order diffracted lights from the diffraction optical element 3u that is the transmission light from the diffraction optical element 11a and 11b. In the meantime, when a voltage is applied to the liquid crystal optical elements, the main beam is the transmission light from the diffraction optical elements 11a, 11b, and 3u, the first sub-beams are the positive and negative first order diffracted lights from the diffraction optical element 11b that is the transmission light from the diffraction optical element 11a and 3u, and the second sub-beams are the positive and negative first order diffracted lights from the diffraction optical element 3u that is the transmission light from the diffraction optical element 11a and 11b.

The plan views of the diffraction optical elements 11a and 11b according to this exemplary embodiment are the same as those shown in FIG. 2A and FIG. 2E, respectively. However, the pitch of the grating in the diffraction grating formed in the region 13a of the diffraction optical element 11a is equivalent to that of the diffraction grating formed in the region 13T of the diffraction optical element 11b. Further, the plan view of the diffraction optical element 3u of this exemplary embodiment is the same as the one shown in FIG. 23.

When no voltage is applied to the liquid crystal optical elements that configure the variable wave plates 12a, 12b, the pitch of the diffraction grating formed in the regions 15a-15h of the diffraction optical element 3u is wider than that of the diffraction grating formed in the region 13a of the diffraction optical element 11a. Here, the main beam and the second sub-beams contain both the light transmitted through the inside the region 13a of the diffraction optical element 11a and the light transmitted through the outer side thereof. The first sub-beams contain only the light diffracted on the inside the region 13a of the diffraction optical element 11a. As a result, the intensity distribution of the second sub-beams is the same as that of the main beam, and the intensity of the first sub-beams in the peripheral part becomes weaker than that of the main beam.

In the meantime, when a voltage is applied to the liquid crystal optical elements that configure the variable wave plates 12a and 12b, the pitch of the diffraction grating formed in the regions 15a-15h of the diffraction optical element 3u is wider than that of the diffraction grating formed in the region 13b of the diffraction optical element 11b. Here, the main beam and the second sub-beams contain both the light transmitted through the inside the region 13b of the diffraction optical element 11b and the light transmitted through the outer side thereof. The first sub-beams contain only the light diffracted on the inside the region 13b of the diffraction optical element 11b. As a result, the intensity distribution of the second sub-beams is the same as that of the main beam, and the intensity of the first sub-beams in the peripheral part becomes weaker than that of the main beam.

The order of the variable wave plate 12a, the diffraction optical elements 11a, 11b and the variable wave plate 12b, the diffraction optical element 3u may be inverted. Further, instead of the diffraction optical elements 11a and 11b, diffraction optical elements that have the same plan views as those shown in FIG. 6A and FIG. 6B may be used. Furthermore/the diffraction optical element 3u may be replaced with a diffraction optical element 3v.

FIG. 36 shows the layout of the light focusing spots on the disk 7. FIG. 36A shows a case where the groove pitch of the disk 7 is narrow, and FIG. 36B shows a case where it is wide.

When the groove pitch of the disk 7 is narrow, no voltage is applied to the liquid crystal optical elements that configure the variable wave plates 12a and 12b. Here, the light focusing spots 24a, 24b, 24c, 24j, and 24k correspond, respectively, to the transmission light from the diffraction optical elements 11a, 11b, and 3u, to the positive first order diffracted light from the diffraction optical element 11a that is the transmission light from the diffraction optical elements 11b and 3u, to the negative first order diffracted light from the diffraction optical element 11a that is the transmission light from the diffraction optical element 11b and 3u, to the positive first order diffracted light from the diffraction optical element 3u that is the transmission light from the diffraction optical elements 11a and 11b, and to the negative first order diffracted light from the diffraction optical element 3u that is the transmission light from the diffraction optical elements 11a and 11b. The light focusing spots 24a, 24b, 24c, 24j, and 24k are on a same track 22a. The light focusing spots 24j and 24k as the second sub-beams have two peaks with the same intensity on the left side and right side of the radial direction of the disk 7. In the meantime, the light focusing spots 24b and 24c as the first sub-beams have the larger diameter than that of the light focusing spot 24a as the main beam.

When the groove pitch of the disk 7 is wide, a voltage is applied to the liquid crystal optical elements that configure the variable wave plates 12a and 12b. Here, the light focusing spots 24a, 24b, 24c, 24j, and 24k correspond, respectively, to the transmission light from the diffraction optical elements 11a, 11b, and 3u, to the positive first order diffracted light from the diffraction optical element 11b that is the transmission light from the diffraction optical elements 11a, 3u, to the negative first order diffracted light from the diffraction optical element 11b that is the transmission light from the diffraction optical element 11a and 3u, to the positive first order diffracted light from the diffraction optical element 3u that is the transmission light from the diffraction optical elements 11a and 11b, and to the negative first order diffracted light from the diffraction optical element 3u that is the transmission light from the diffraction optical elements 11a and 11b. The light focusing spots 24a, 24b, 24c, 24j, and 24k are on a same track 22b. The light focusing spots 24j and 24k as the second sub-beams have two peaks with the same intensity on the left side and right side of the radial direction of the disk 7. In the meantime, the light focusing spots 24b and 24c as the first sub-beams have the larger diameter than that of the light focusing spot 24a as the main beam.

The pattern of the light-receiving parts of a photodetector and the layout of the optical spots on the photodetector according to this exemplary embodiment are the same as those shown in FIG. 4. With this exemplary embodiment, each of the focus error signal, the push-pull signal by the main beam, the push-pull signal by the first sub-beams, the push-pull signal by the second sub-beams, as well as a RF signal recorded in the disk 7 can be obtained, as in the case of the fifteenth exemplary embodiment. As the track error signal, the signal obtained by subtracting the push-pull signal by the second sub-beams from the push-pull signal by the main beam is used.

Various push-pull signals related to detection of the track error signal according to this exemplary embodiment are the same as those shown in FIG. 13, because of the same reasons described above in the twelfth exemplary embodiment by referring to FIG. 26. In this exemplary embodiment, there is no offset generated in the track error signal by the shift in the lens, as in the case of the fifteenth exemplary embodiment. Further, the sum of the push-pull signal by the main beam and the push-pull signal by the second sub-beams can be used as the lens position signal.

Various push-pull signals related to detection of the radial tilt according to this exemplary embodiment are the same as those shown in FIG. 5. In this exemplary embodiment, the push-pull signal by the first sub-beams under track-servo can be used as the radial tilt error signal, as in the case of the fifteenth exemplary embodiment. With the use of the signal obtained by subtracting the track error signal from the push-pull signal by the first sub-beams as the radial tilt error signal, there is no offset generated in the radial tilt error signal by the residual error. Further, with the use of the signal obtained by subtracting the lens position signal from the push-pull signal by the first sub-beams as the radial tilt error signal, there is no offset generated in the radial tilt error signal by the shift in the lens. Furthermore, with the use of the signal obtained by subtracting the track error signal and the lens position signal from the push-pull signal by the first sub-beams as the radial tilt error signal, there is no offset generated in the radial tilt error signal caused by the residual error and the shift in the lens.

FIG. 37 shows sectional views of the diffraction optical elements 11a-11m. The outer part of the region 13a of the diffraction optical element 11a and the outer part of the region 13b of the diffraction optical element 11b are configured to have a structure in which a liquid crystal polymer 20a exhibiting birefringence and a filler 21a are sandwiched between substrates 19a and 19b, as shown in FIG-37A.

The inner part of the region 13a of the diffraction optical element 11a, the inner part of the region 13b of the diffraction optical element 11b, the whole surface of the diffraction optical element 11c, the whole surface of the diffraction optical element 11d, the whole surface of the diffraction optical element 11e, the whole surface of the diffraction optical element 11f, the region 13t of the diffraction optical element 11g, the region 13v of the diffraction optical element 11h, the region 13x of the diffraction optical element 11i, the region 13z of the diffraction optical element 11j, the regions 14c, 14d of the diffraction optical element 11k, the regions 14g-14j of the diffraction optical element 11l, the regions 14m, 14n of the diffraction optical element 11m, and the regions 14q, 14r of the diffraction optical element 11n are configured to have a structure in which a liquid crystal polymer 20b exhibiting birefringence and a filler 21b are sandwiched between the substrates 19a and 19b, as shown in FIG. 37B.

The region 13s of the diffraction optical element 11g, the region 13u of the diffraction optical element 11h, the region 13w of the diffraction optical element 11i, the region 13y of the diffraction optical element 11j, the regions 14a, 14b of the diffraction optical element 11k, the regions 14e, 14f of the diffraction optical element 11l, the regions 14k, 14l of the diffraction optical element 11m, the regions 14o, 14p of the diffraction optical element 11n are configured to have a structure in which liquid crystal polymer 20c exhibiting birefringence and a filler 21c are sandwiched between substrates 11a and 19b, as shown in FIG. 37C.

The liquid crystal polymer 20a has a flat sectional shape and has height H0. The liquid crystal polymer 20b has a sectional shape in which a line part with width P/2 and a space part with width P/2 are repeated. That is, the pitch of the grating is P. The average height of the line parts and the space parts is H0, and the difference in the heights thereof is 2H1. The liquid crystal polymer 20c has a sectional shape in which a line part with width P/2-A, a space part with width A, a line part with width A, and a line part with width P/2-A are repeated. That is, the pitch of the grating is P. The average height of the line parts and the space parts is H0, and the difference in the heights thereof is 2H2.

It is assumed here that the wavelength of the semiconductor laser 1 is λ, the difference between the diffractive index of the liquid crystal polymers 20a, 20b, 20c for ordinary light and the diffractive index of the fillers 21a, 21b, 21c is Δno, and the difference between the diffractive index of the liquid crystal polymers 20a, 20b, 20c for abnormal light and the diffractive index of the fillers 21a, 21b, 21c is Δne. Here, the transmittance of the region shown in FIG. 37A is 1 for a polarized light component of the same direction as that of the ordinary light. That is, almost 100% of the light making incident on the regions shown in FIG. 37 transmits therethrough. Further, the transmittance of the region shown in FIG. 37A is 1 for a polarized light component of the same direction as that of the abnormal light. That is, almost 100% at the light making incident on the regions shown in FIG. 37 transmits therethrough.

The above-described equations (1)-(3) apply, provided that the transmittance, the 1st order diffraction efficiency, and the ˜2nd order diffraction efficiency of the region shown in FIG. 37B are ηa0, ηa1, and ηa2, respectively. Further, following equations (9) and (10) apply for the ordinal light and the abnormal light, respectively.

φ1=4πΔnoH1/λ (9)

φ1=4πΔneH1/λ (10)

Assuming that φ1=0, for example, ηa0 is 0.1, ηa1 is 0, and ηa2 is 0 for the polarized light component of the same direction as that of the ordinary light. That is, almost 100% of the light making incident on the region shown in FIG. 37B transmits therethrough. Further, assuming that φ1=0.194π, ηa0 is 0.910, ηa1 is 0.036, and ηa2 is 0 for the polarized light component of the same direction as that of the abnormal light. That is, about 91.0% of the light making incident on the region shown in FIG. 37B transmits therethrough as the zeroth order light, about 3.6% each is diffracted as the positive and negative first order diffracted light, and no light diffracted as the positive and negative second order diffracted light.

The above-described equations (5) (7) apply, provided that the transmittance, the ±1st order diffraction efficiency, and the ±2nd order diffraction efficiency of the region shown in FIG. 37C are ηb0, ηb1, and ηb2, respectively. Further, following equations (11) and (12) apply for the ordinary light and the abnormal light, respectively.

φ2=4πΔnoH2/λ (11)

φ2=4πΔneH2/λ (12)

Assuming that φ2=0, for example, ηb0 is 1, ηb1 is 0, and ηb2 is 0 for the polarized light component of the same direction as that of the ordinary light. That is, almost 100% of the light making incident on the region shown in FIG. 37C transmits therethrough. Further, assuming that φ2=0.25π and A=0.142P, ηb0 is 0.300, ηb1 is 0.032, and ηb2 is 0.030 for the polarized light component of the same direction as that of the abnormal light. That is, about 80.0% of the light making incident on the region shown in FIG. 37C transmits therethrough as the zeroth order light, about 3.2% each is diffracted as the positive and negative first order diffracted light, and about 3.0% each is diffracted as the positive and negative second order diffracted light.

FIG. 38 shows a first exemplary embodiment of an optical information recording/reproducing device according to the present invention. This exemplary embodiment is obtained by adding an arithmetic operation circuit 42 and a driving circuit 43a to the first exemplary embodiment of the optical head according to the present invention shown in FIG. 1. The arithmetic operation circuit 42 performs arithmetic operation of a radial tilt error signal based on outputs from each light receiving part of the photodetector 10a. The driving circuit 43a drives the objective lens 6 (surrounded by a dotted line in the drawing) in the radial direction of the disk 7 by an actuator, not shown, so that the radial tilt error signal becomes 0. With this, the radial tilt of the disk 7 can be corrected, thereby eliminating a bad influence on the recording/reproducing property. The arithmetic operation circuit 42 corresponds to “arithmetic operation device” depicted in the scope of the appended claims, and the driving circuit 43a and the actuator (not shown) correspond to “correcting device” of the same.

FIG. 39 shows a second exemplary embodiment of the optical information recording/reproducing device according to the present invention. This exemplary embodiment is obtained by adding an arithmetic operation circuit 42 and a driving circuit 43b to the first exemplary embodiment of the optical head according to the present invention shown in FIG. 1. The arithmetic operation circuit 42 performs arithmetic operation of a radial tilt error signal based on outputs from each light receiving part of the photodetector 10a. The driving circuit 43a drives the entire optical head (surrounded by a dotted line in the drawing) in the radial direction of the disk 7 by an actuator (for example, a motor), not shown, so that the radial tilt error signal becomes 0. With this, the radial tilt of the disk 7 can be corrected, thereby eliminating a bad influence on the recording/reproducing property. The arithmetic operation circuit 42 corresponds to “arithmetic operation device” depicted in the scope of the appended claims, and the driving circuit 43b and the actuator (not shown) correspond to “correcting device” of the same.

FIG. 40 shows a third exemplary embodiment of the optical information recording/reproducing device according to the present invention. This exemplary embodiment is obtained by adding an arithmetic operation circuit 42, a driving circuit 43c, and a liquid crystal optical element 44 to the first exemplary embodiment of the optical head according to the present invention shown in FIG. 1. The arithmetic operation circuit 42 performs arithmetic operation of a radial tilt error signal based on outputs from each light receiving part of the photodetector 10a. The driving circuit 43c applies a voltage to the liquid crystal optical element 44 (surrounded by a dotted line in the drawing), so that the radial tilt error signal becomes 0. The liquid crystal optical element 44 is divided into a plurality of regions, and the comma aberration for the transmission light changes when the voltage to be applied to each region is changed. Thus, a comma aberration for offsetting the comma aberration caused due to the radial tilt of the disk 7 is generated by the liquid crystal optical element 44 through adjusting the voltage to be applied to the liquid crystal optical element 44. With this, the radial tilt of the disk 7 can be corrected, thereby eliminating a bad influence on the recording/reproducing property. The arithmetic operation circuit 42 corresponds to “arithmetic operation device” depicted in the scope of the appended claims, and the driving circuit 43c and the liquid crystal optical element 44 correspond to “correcting device” of the same

In the first-third exemplary embodiments, the sign of the radial tilt error signal becomes opposite for the case where track-servo is applied to the lands and for the case where the track-servo is applied to the grooves. Therefore, the polarity of the circuits configured with the arithmetic operation circuit 42 and the driving circuits 43a-43c for correcting the radial tilt is changed for the lands and for the grooves.

As the optical information recording/reproducing device according to the present invention, there is also considered a form that is obtained by adding an arithmetic operation circuit, a driving circuit, and the like to the second-seventeenth exemplary embodiments of the optical head according to the present invention.

In the form obtained by adding the arithmetic operation circuit, the driving circuit, and the like to the fourteenth-seventeenth exemplary embodiments of the optical head according to the present invention, a control circuit (corresponds to “control device” depicted in the scope of the appended claims) for controlling the variable wave plates 12a and 12b are to be added further. In a case where the variable wave plates 12a and 12b are liquid crystal optical elements including liquid crystal molecules, this control circuit does not apply a voltage to the liquid crystal optical elements that configure the variable wave plates 12a and 12b, when the groove pitch of the disk 7 is narrow. The control circuit applies a voltage to the liquid crystal optical elements that configure the variable wave plates 12a and 12b, when the groove pitch of the disk 7 is wide. Further, in a case where the variable wave plates 12a and 12b are half wavelength plates having a rotating mechanism that rotates about the Z-axis, the control circuit does not rotate the half wavelength plates that configure the variable wave plates 12a and 12 when the groove pitch of the disk 7 is narrow. The control circuit rotates the half wavelength plates that configure the variable wave plates 12a and 12 by 45 degrees, when the groove pitch of the disk 7 is wide.

### BRIEF DESCRIPTION OF THE DRAWINGS

FIG. 1 is a block diagram showing a first exemplary embodiment of an optical head according to the invention;

FIG. 2 shows plan views showing diffraction optical elements of the first exemplary embodiment of the optical head according to the invention;

FIG. 3 shows plan views showing layouts of light focusing spots on a disk according to the first exemplary embodiment of the optical head of the invention;

FIG. 4 is a plan view showing a pattern of light-receiving parts of a photodetector and a layout of optical spots on the photodetector according to the first exemplary embodiment of the optical head of the invention;

FIG. 5 shows waveforms of various push-pull signals related to detection of radial tilt according to the first exemplary embodiment of the optical head of the invention;

FIG. 6 shows plan views showing diffraction optical elements of a second exemplary embodiment of the optical head according to the invention;

FIG. 7 shows a plan view showing a diffraction optical element of a third exemplary embodiment of the optical head according to the invention;

FIG. 8 shows a plan view showing a diffraction optical element of a fourth exemplary embodiment of the optical head according to the invention;

FIG. 9 is a block diagram showing a fifth exemplary embodiment of the optical head according to the invention;

FIG. 10 show plan views showing diffraction optical elements of the fifth exemplary embodiment of the optical head according to the invention;

FIG. 11 shows plan views showing layouts of light focusing spots on a disk according to the fifth exemplary embodiment of the optical head of the invention;

FIG. 12 is a plan view showing a pattern of light-receiving parts of a photodetector and a layout of optical spots on the photodetector according to the fifth exemplary embodiment of the optical head of the invention;

FIG. 13 shows waveforms of various push-pull signals related to a track error signal and a lens position signal according to the fifth exemplary embodiment of the optical head of the invention;

FIG. 14 shows plan views showing diffraction optical elements according to a sixth exemplary embodiment of the invention;

FIG. 15 shows plan views showing layouts of optical spots on a disk according to the sixth exemplary embodiment of the optical head of the invention;

FIG. 16 shows illustrations of phases of sub-beams reflected by a disk and phases of sub-beams diffracted by the disk according to the sixth exemplary embodiment of the optical head of the invention;

FIG. 17 shows plan views showing diffraction optical elements according to a seventh exemplary embodiment of the invention; to FIG. 18 shows plan views showing diffraction optical elements according to an eighth exemplary embodiment of the invention;

FIG. 19 shows plan views showing diffraction optical elements according to a ninth exemplary embodiment of the invention;

FIG. 20 shows plan views showing diffraction optical elements according to a tenth exemplary embodiment of the invention;

FIG. 21 shows plan views showing diffraction optical elements according to an eleventh exemplary embodiment of the invention;

FIG. 22 is a block diagram showing a twelfth exemplary embodiment of the optical head according to the invention;

FIG. 23 shows a plan view showing a diffraction optical element according to the twelfth exemplary embodiment of the invention;

FIG. 24 shows plan views showing layouts of light focusing spots on a disk according to the twelfth exemplary embodiment of the optical head of the invention;

FIG. 25 is a plan view showing a pattern of light-receiving parts of a photodetector and a layout of optical spots on the photodetector according to the twelfth exemplary embodiment of the optical head of the invention;

FIG. 26 shows illustrations of phases of sub-beams reflected by a disk and phases of sub-beams diffracted by the disk according to the twelfth exemplary embodiment of the optical head of the invention;

FIG. 27 shows a plan view showing a diffraction optical element according to a thirteenth exemplary embodiment of the invention;

FIG. 28 shows sectional views showing diffraction optical elements according to the first thirteenth exemplary embodiments of the invention;

FIG. 29 is a block diagram showing a fourteenth exemplary embodiment of the optical head according to the invention;

FIG. 30 shows plan views showing layouts of light focusing spots on a disk according to the fourteenth exemplary embodiment of the optical head of the invention;

FIG. 31 is a plan view showing a pattern of light-receiving parts of a photodetector and a layout of optical spots on the photodetector according to the fourteenth exemplary embodiment of the optical head of the invention;

FIG. 32 is a block diagram showing a fifteenth exemplary embodiment of the optical head according to the invention;

FIG. 33 shows plan views showing layouts of light focusing spots on a disk according to the fifteenth exemplary embodiment of the optical head of the invention;

FIG. 34 shows plan views showing layouts of light focusing spots on a disk according to the sixteenth exemplary embodiment of the optical head of the invention;

FIG. 35 is a block diagram showing a seventeenth exemplary embodiment of the optical head according to the invention;

FIG. 36 shows plan views showing layouts of light focusing spots on a disk according to the seventeenth exemplary embodiment of the optical head of the invention;

FIG. 37 shows sectional views showing diffraction optical elements according to the fourteenth seventeenth exemplary embodiments of the invention;

FIG. 38 is a block diagram showing a first exemplary embodiment of an optical information recording/reproducing device according to the invention;

FIG. 39 is a block diagram showing a second exemplary embodiment of the optical information recording/reproducing device according to the invention;

FIG. 40 is a block diagram showing a third exemplary embodiment of the optical information recording/reproducing device according to the invention;

FIG. 41 is a block diagram showing a conventional optical head;

FIG. 42 shows a plan view showing a diffraction optical element of the conventional optical;

FIG. 43 shows plan views showing layouts of light focusing spots on a disk of the conventional optical head;

FIG. 44 is a plan view showing a pattern of light-receiving parts of a photodetector and a layout of optical spots on the photodetector in the conventional optical head;

FIG. 45 shows waveforms of various push-pull signals related to detection of radial tilt in the conventional optical head; and

FIG. 46 shows graphs showing examples of calculating the relation between NA of sub-beams and a radial tilt error signal.

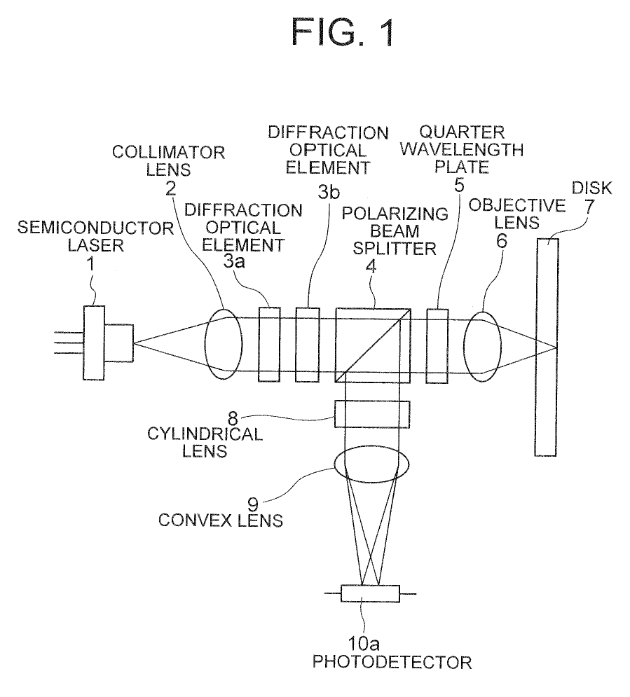

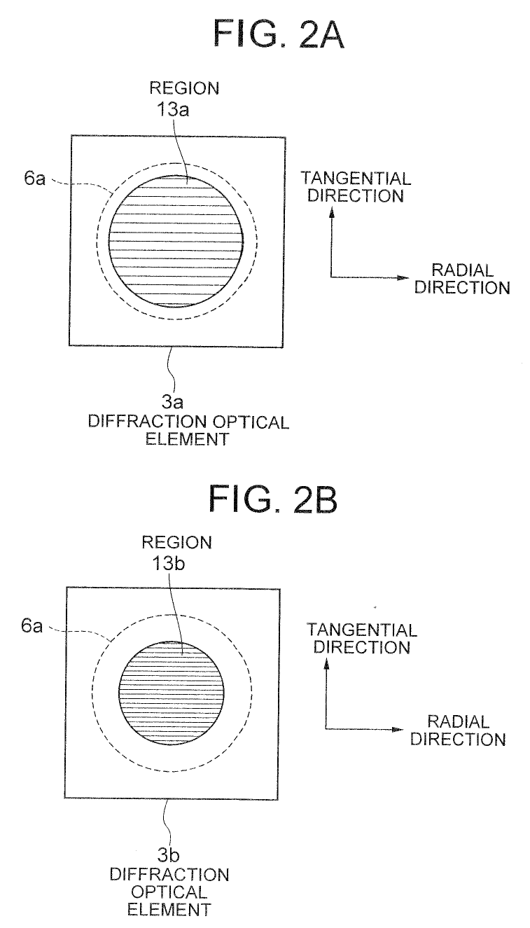

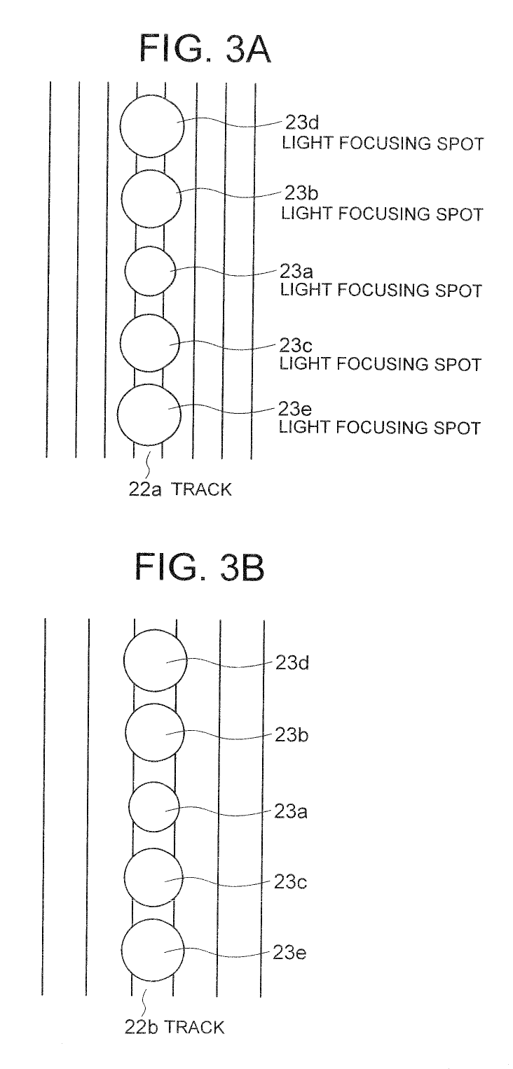

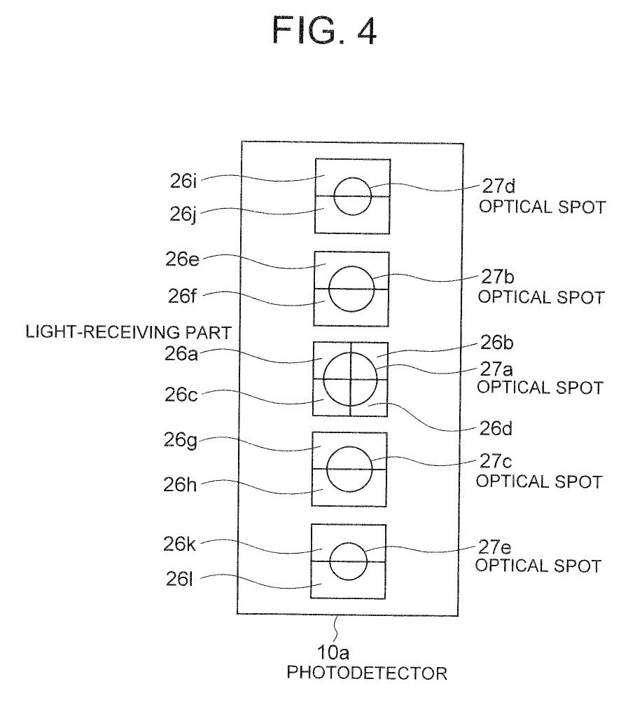

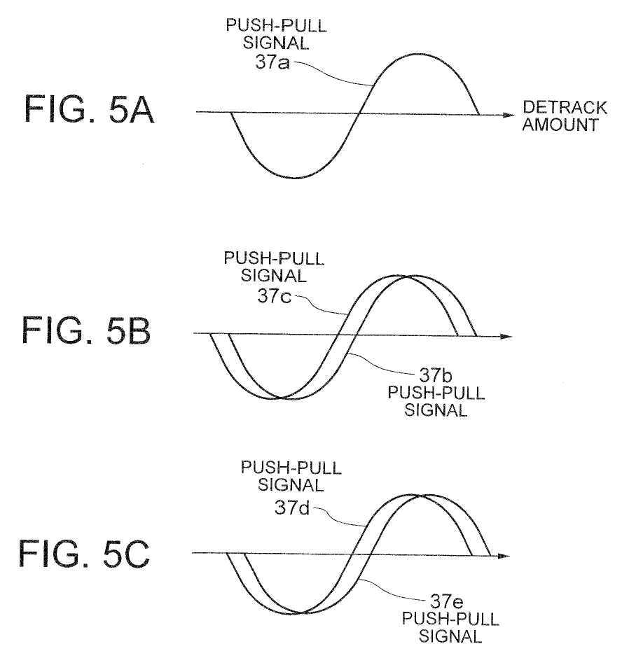

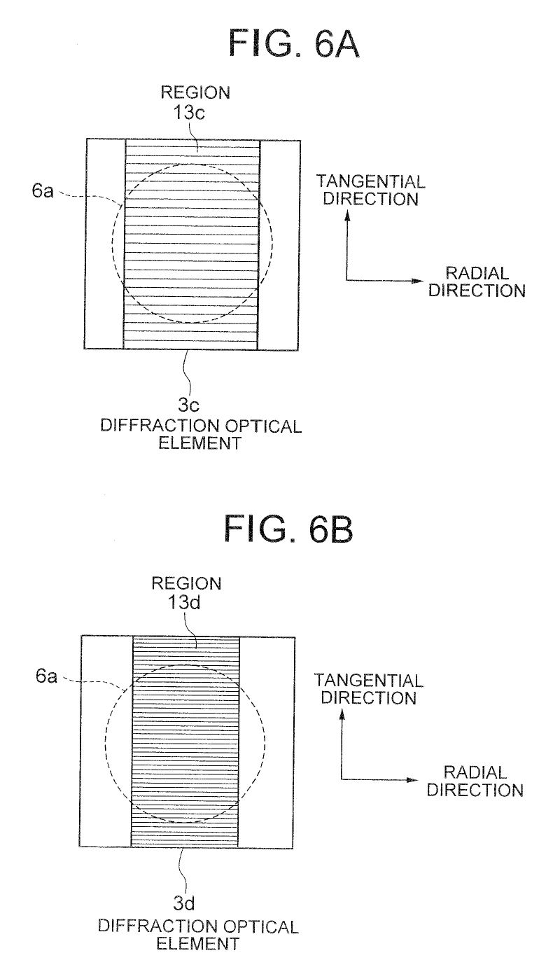

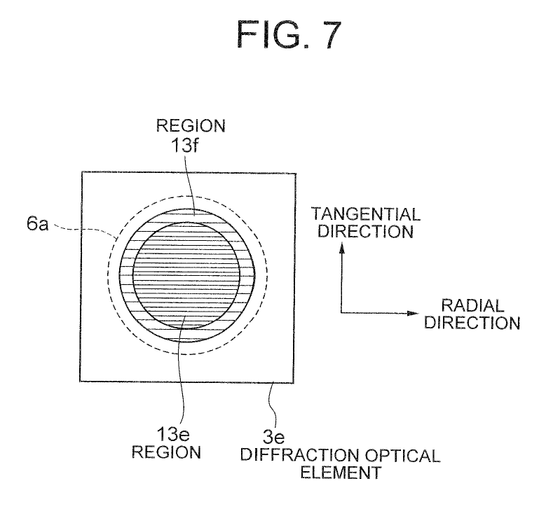

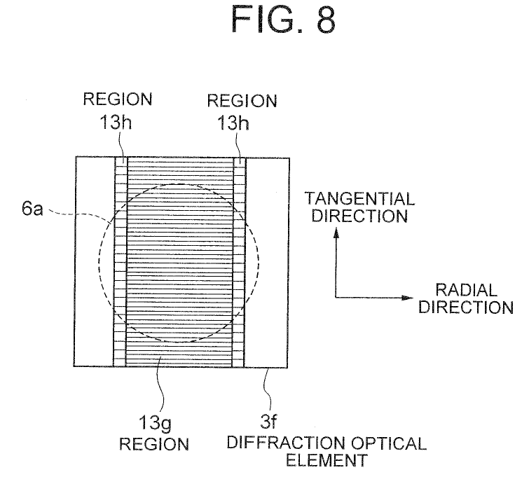

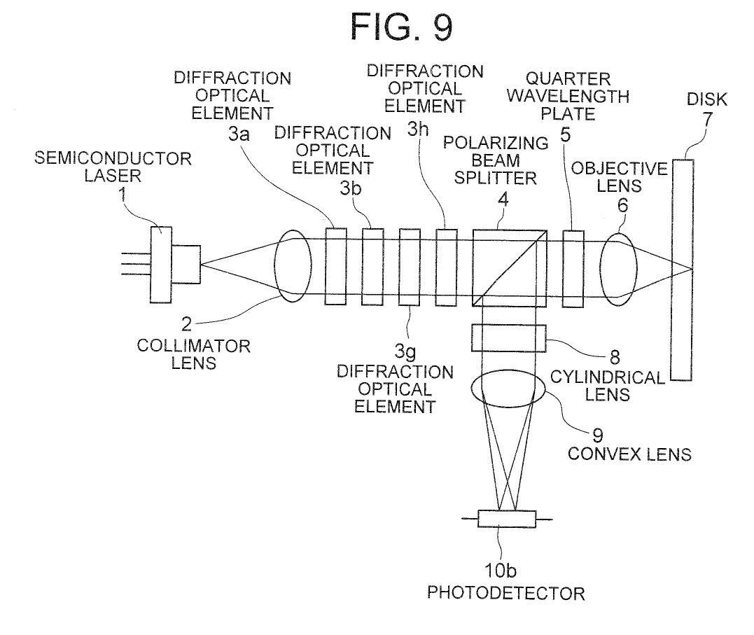

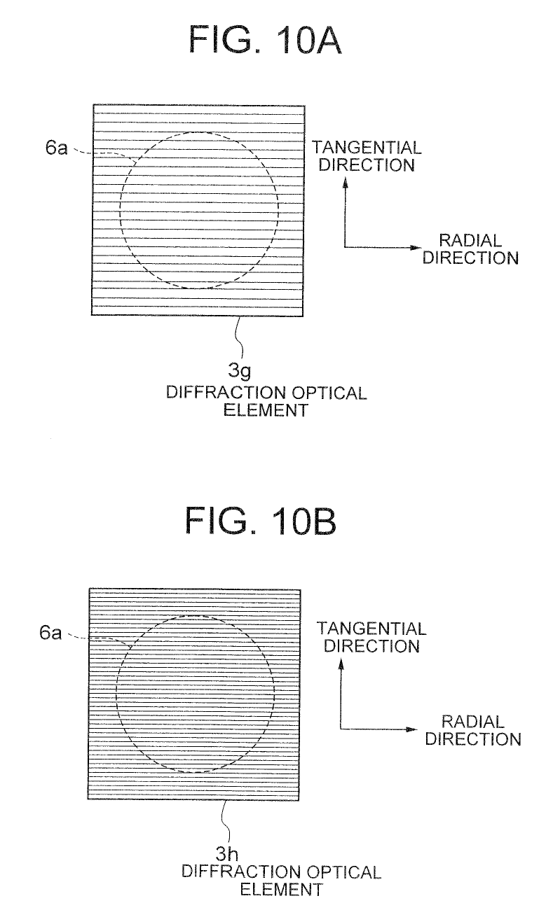

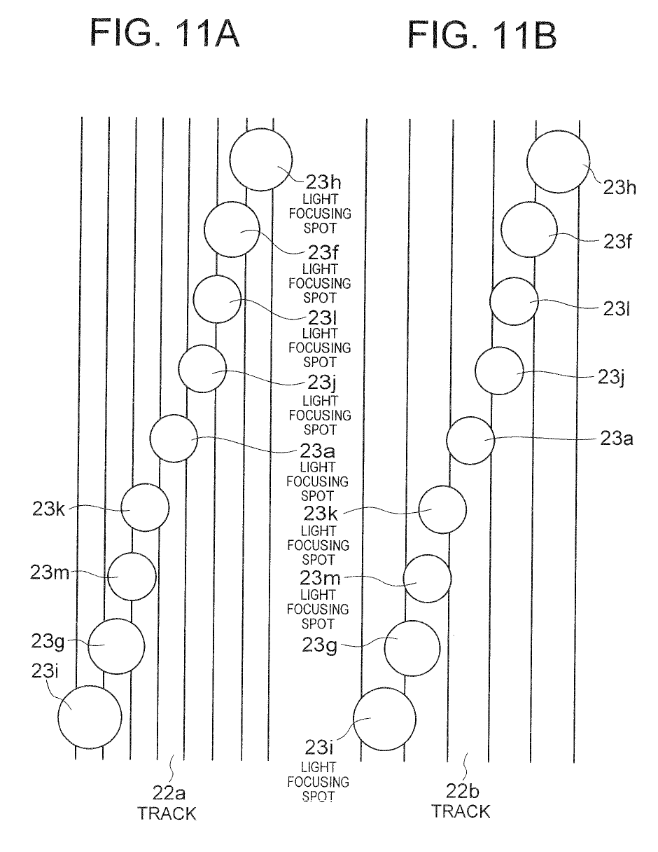

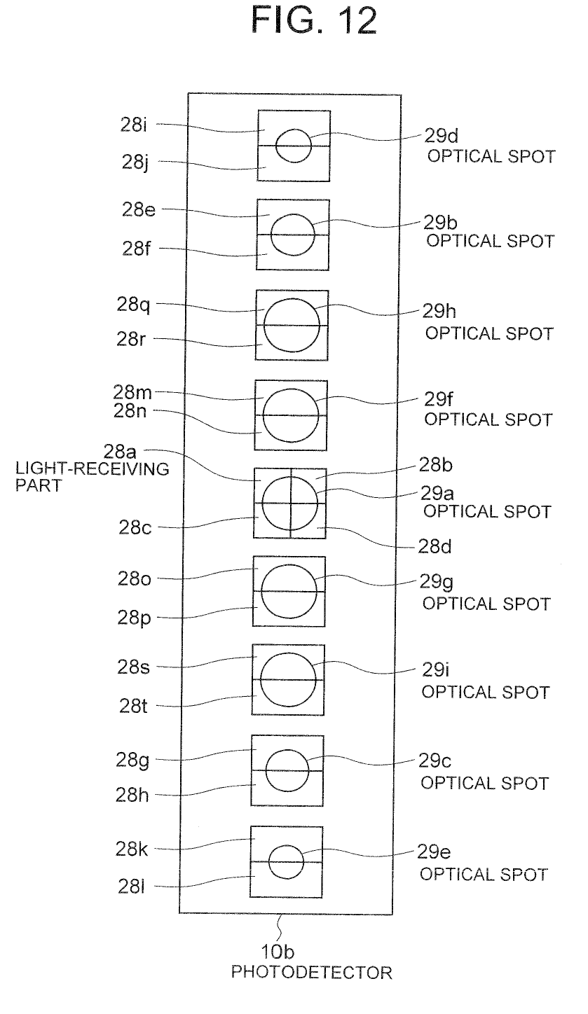

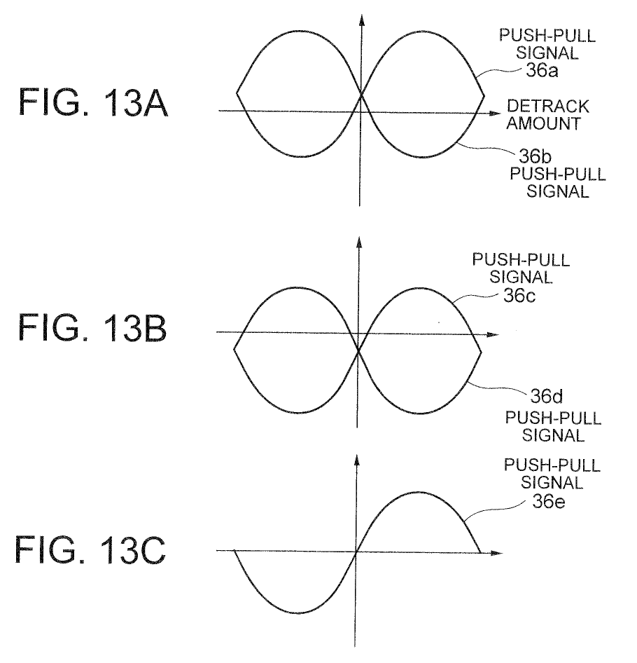

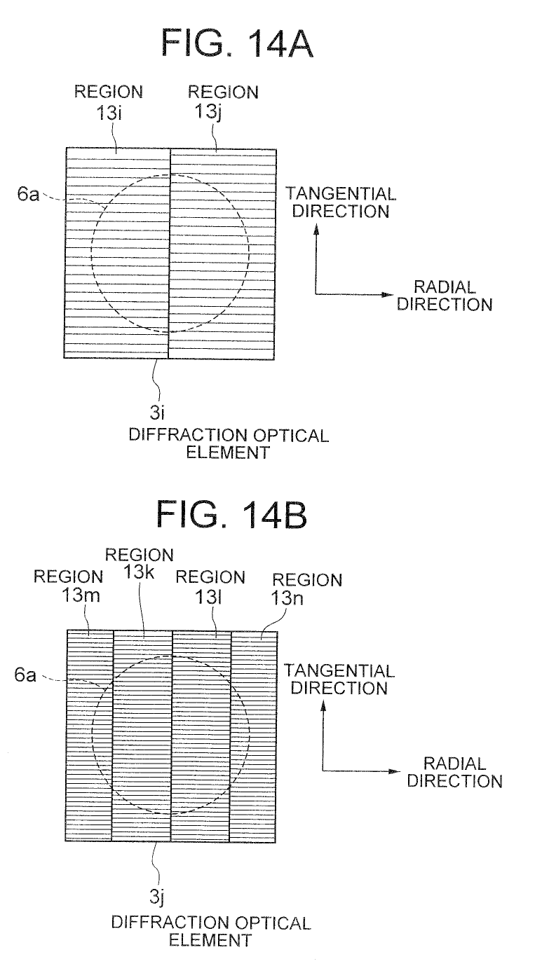

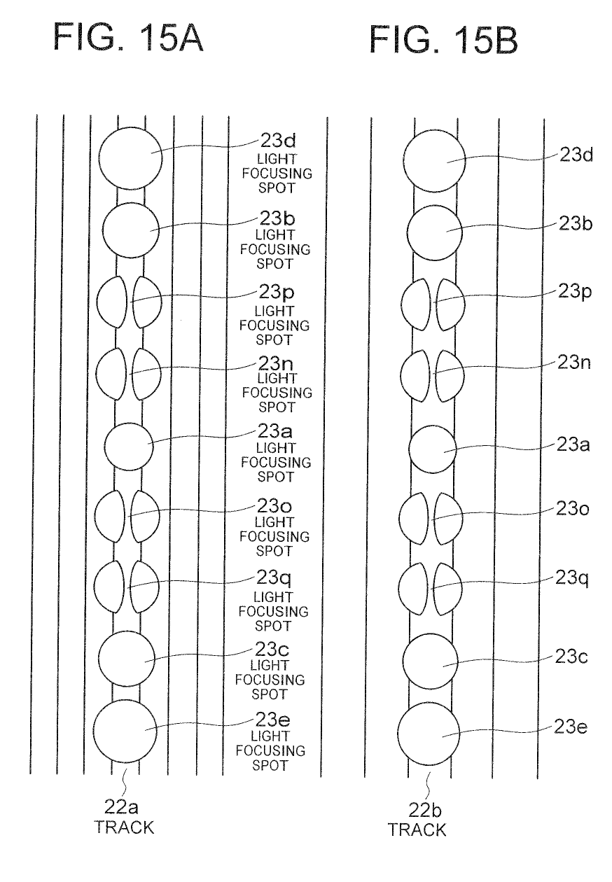

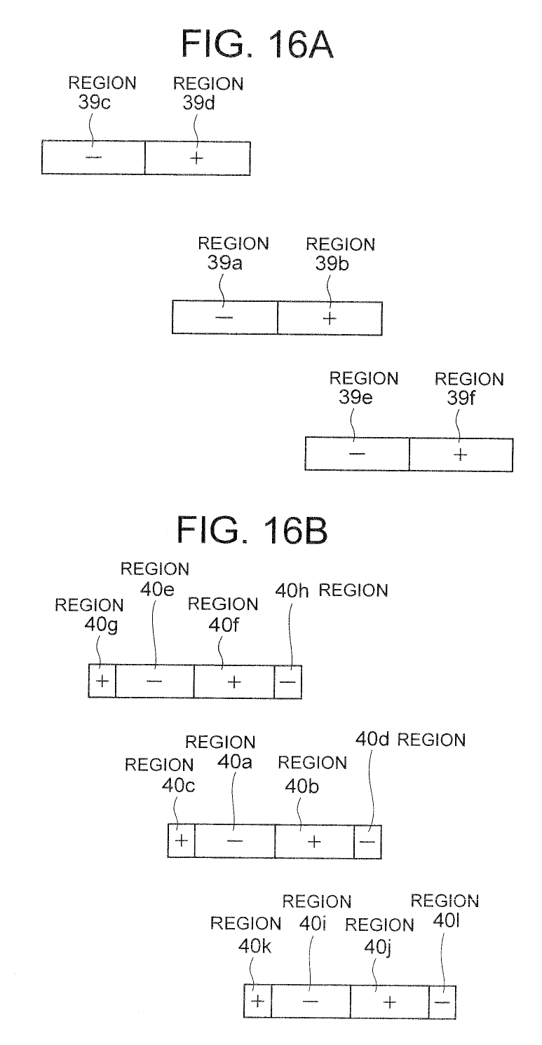

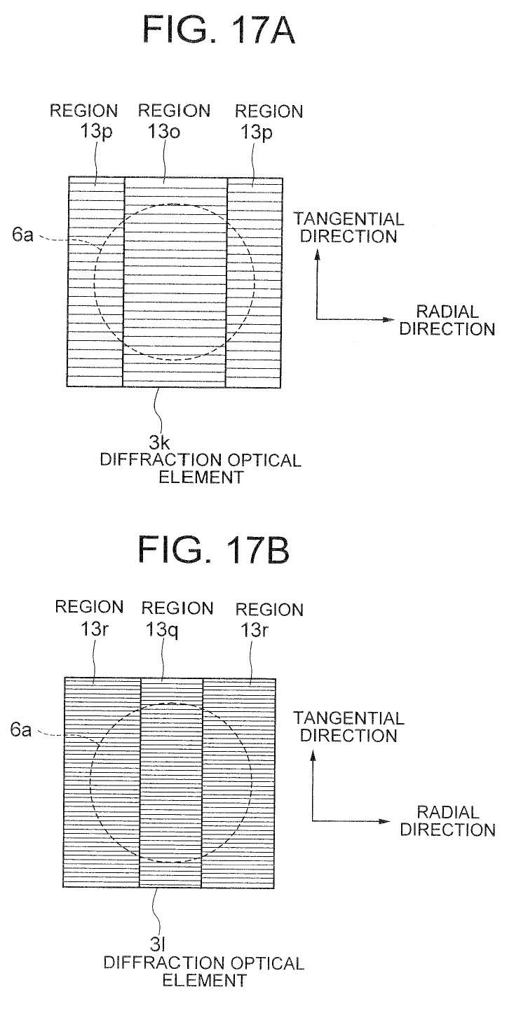

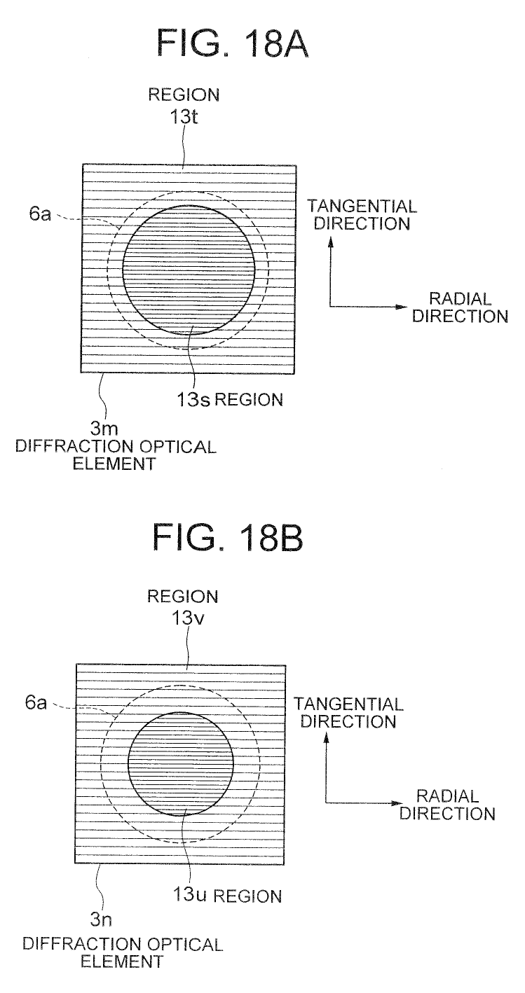

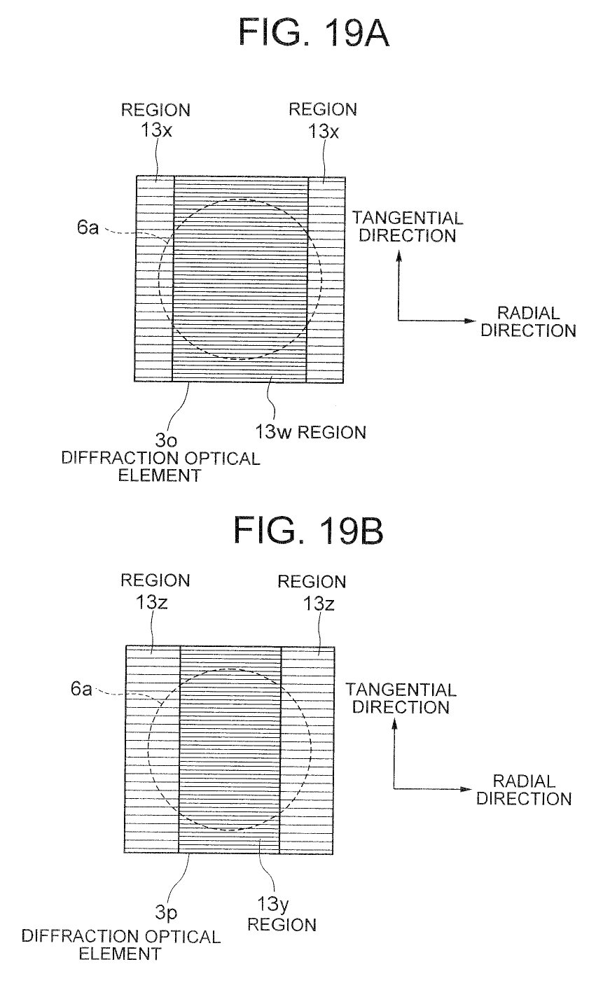

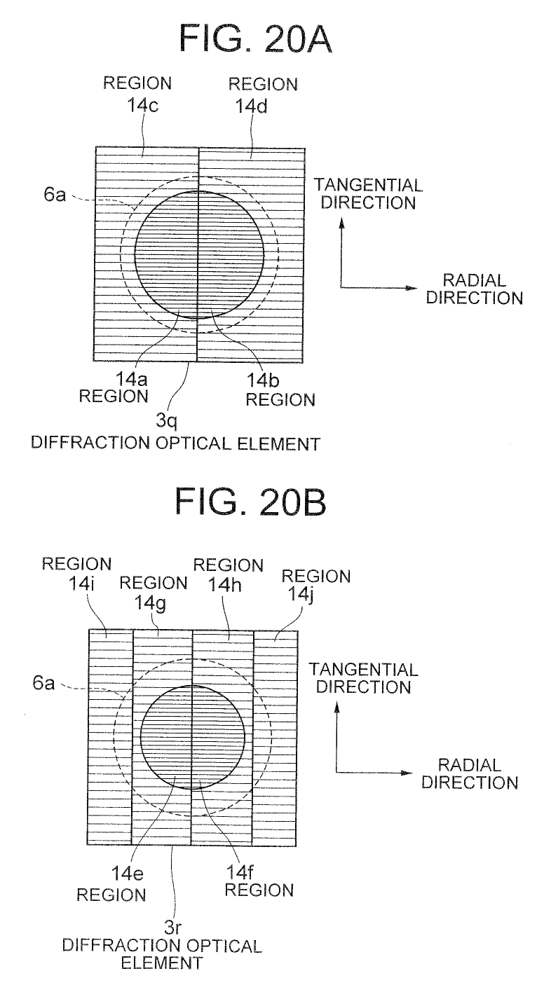

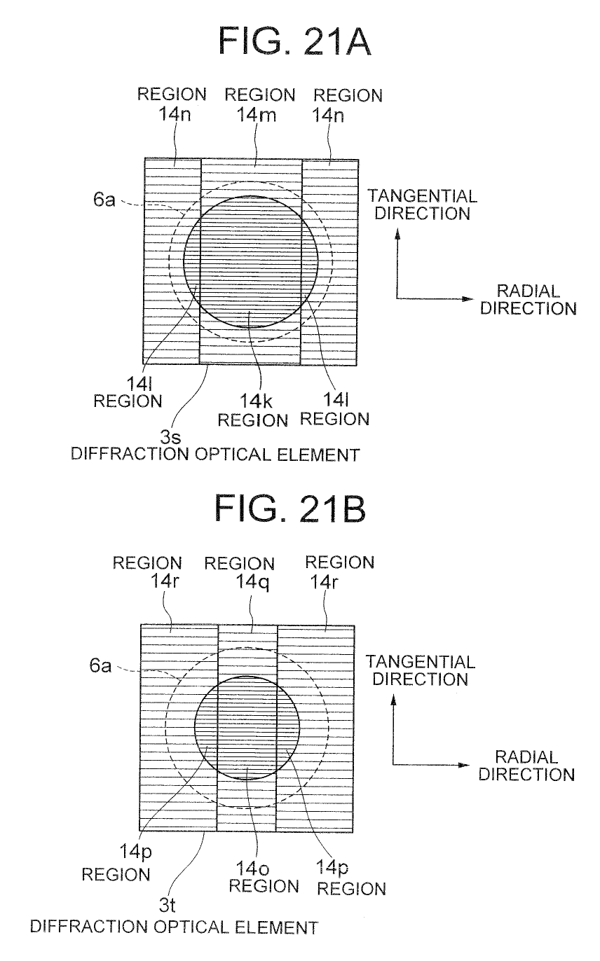

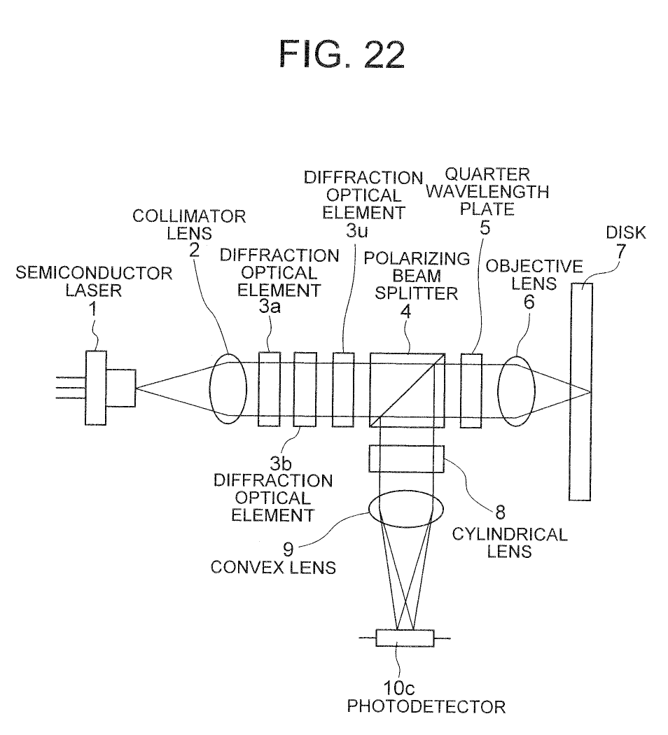

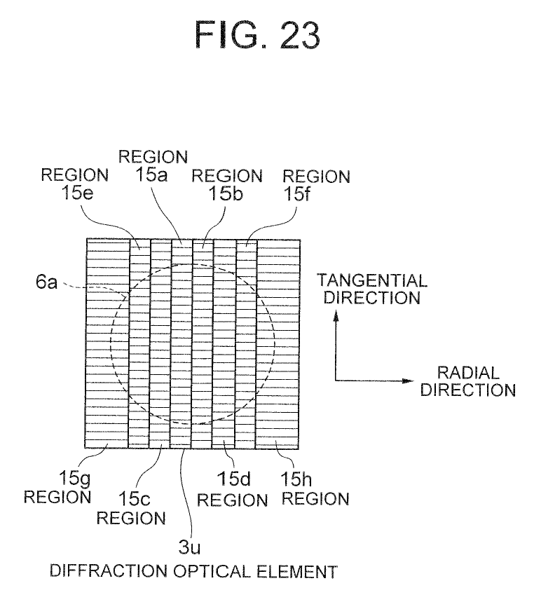

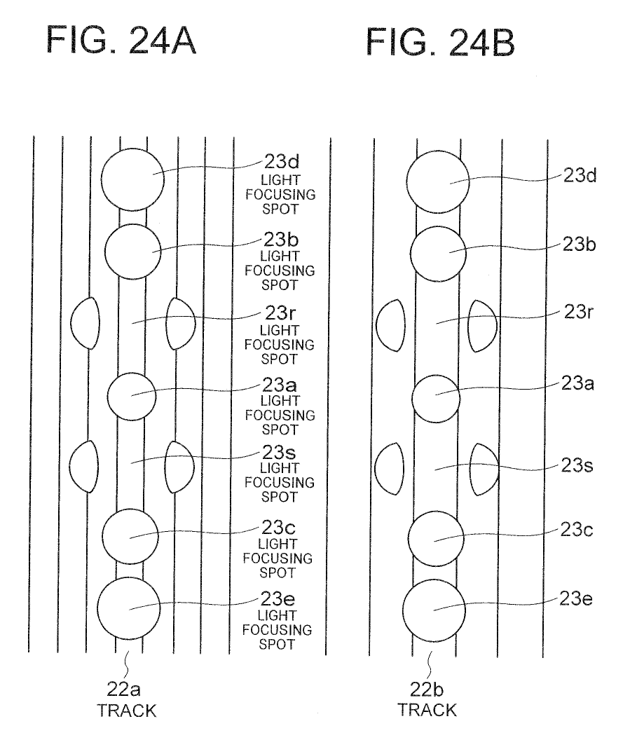

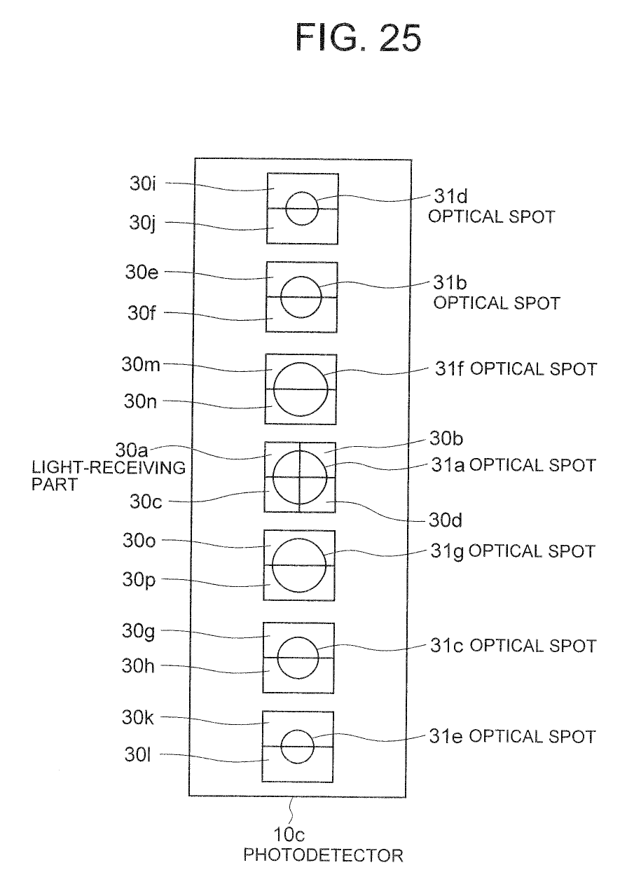

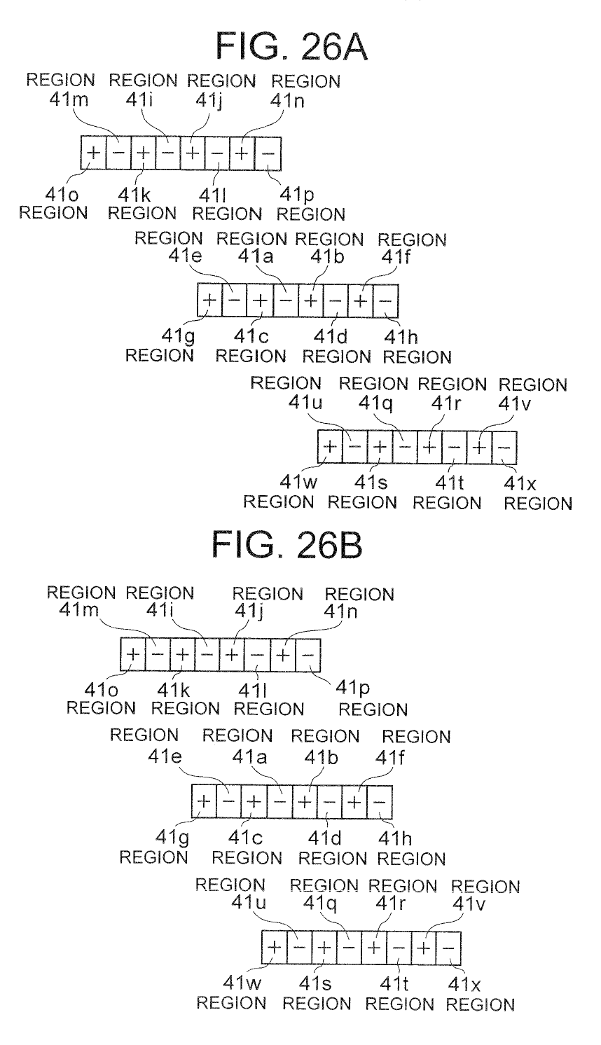

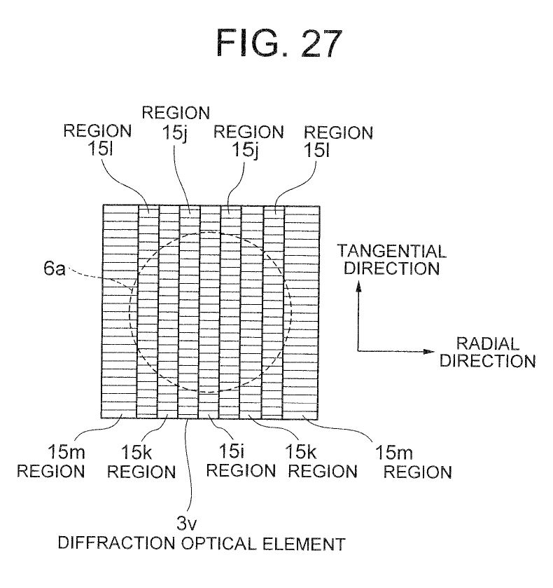

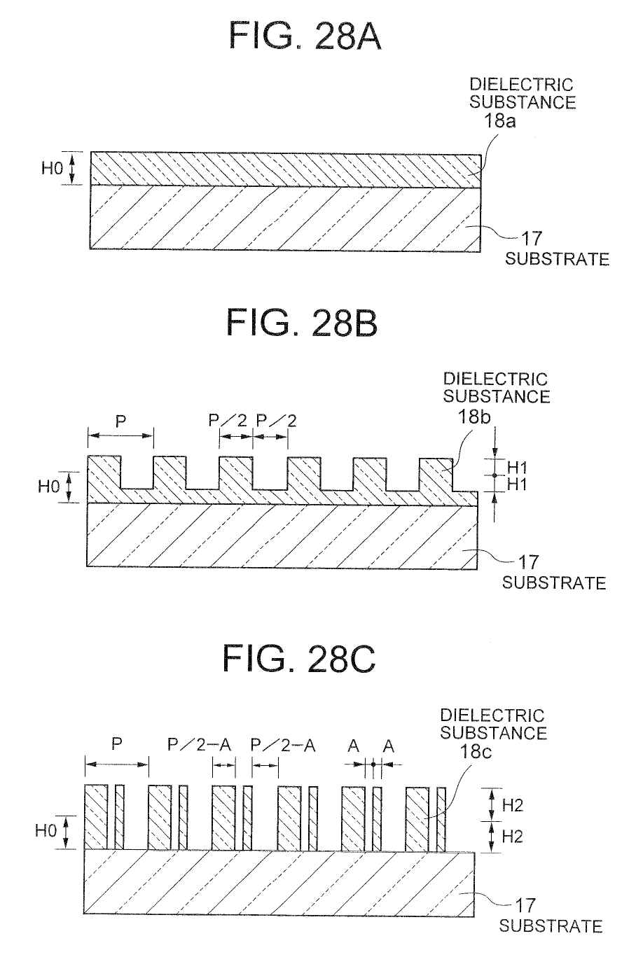

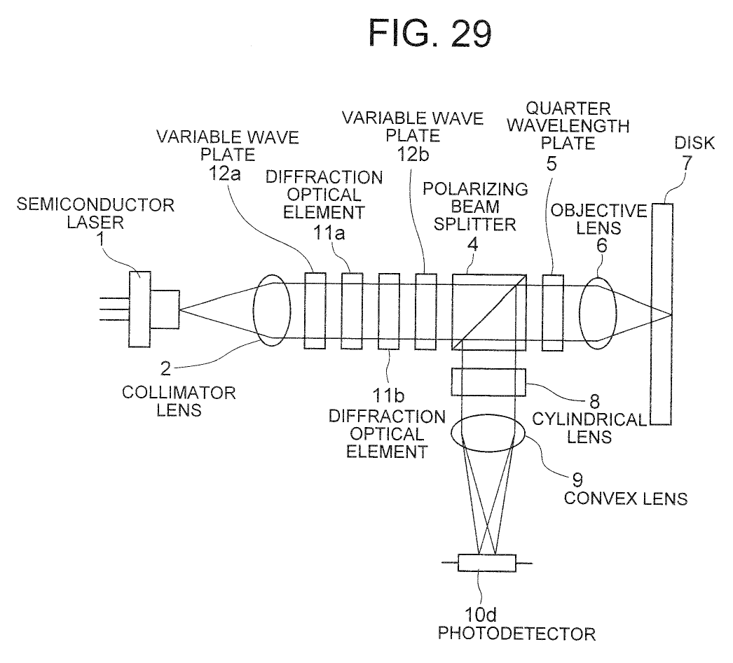

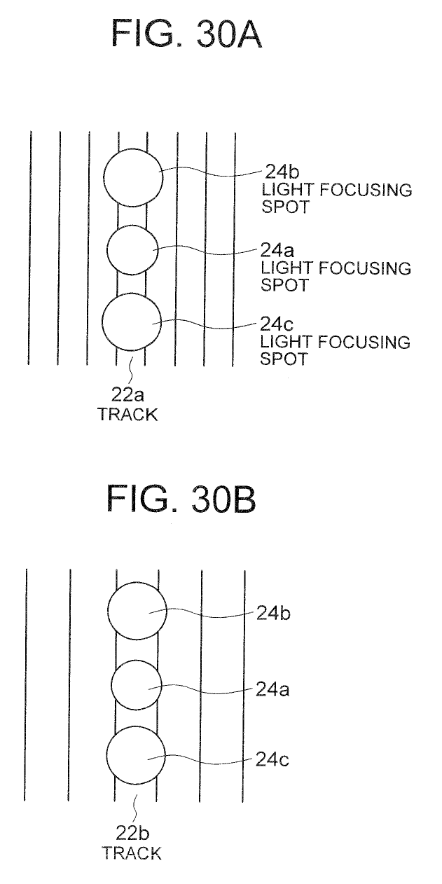

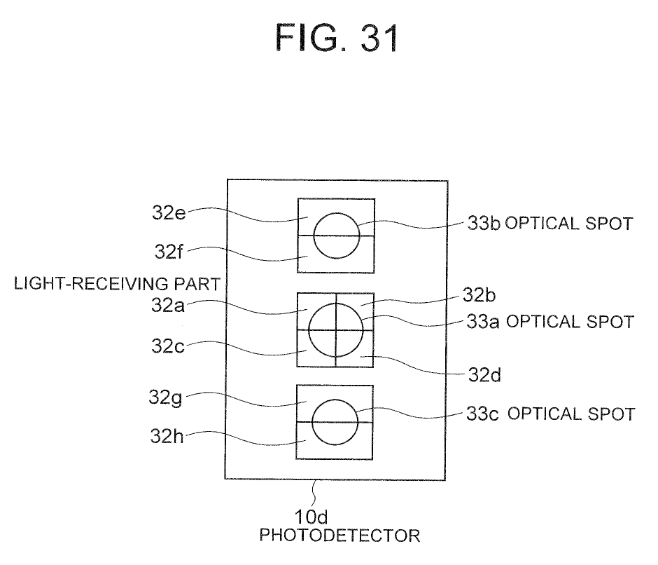

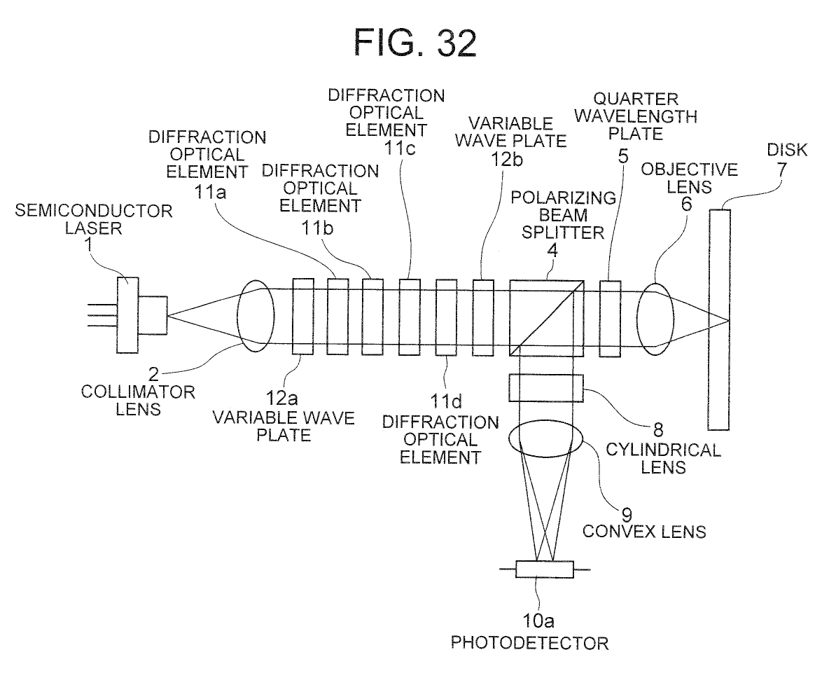

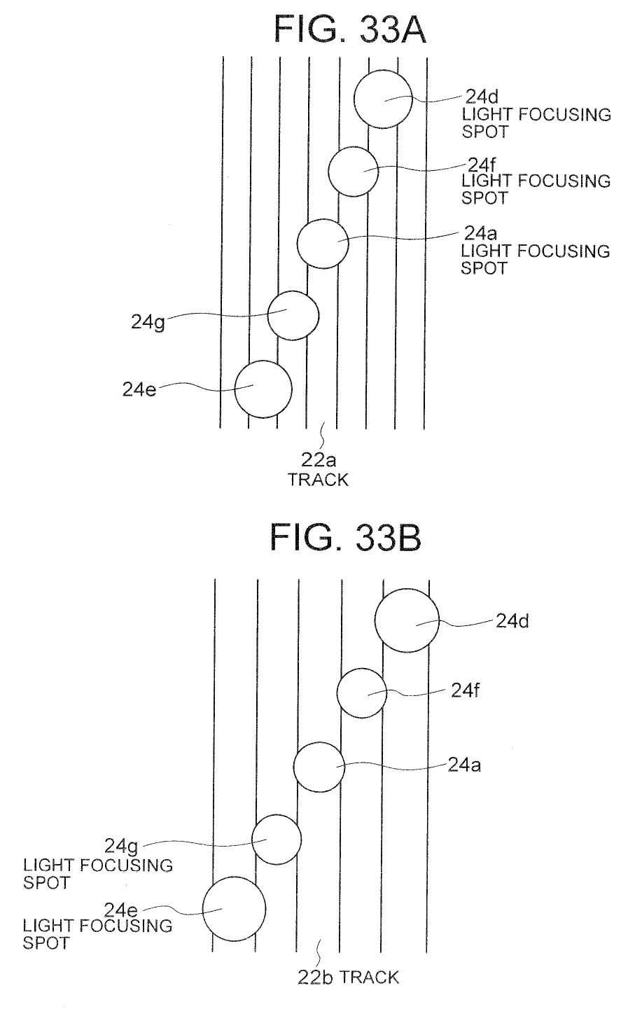

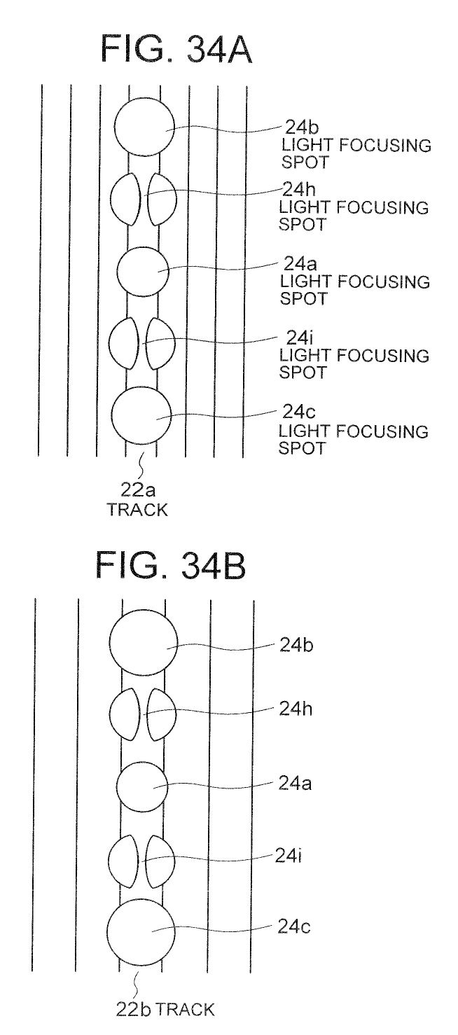

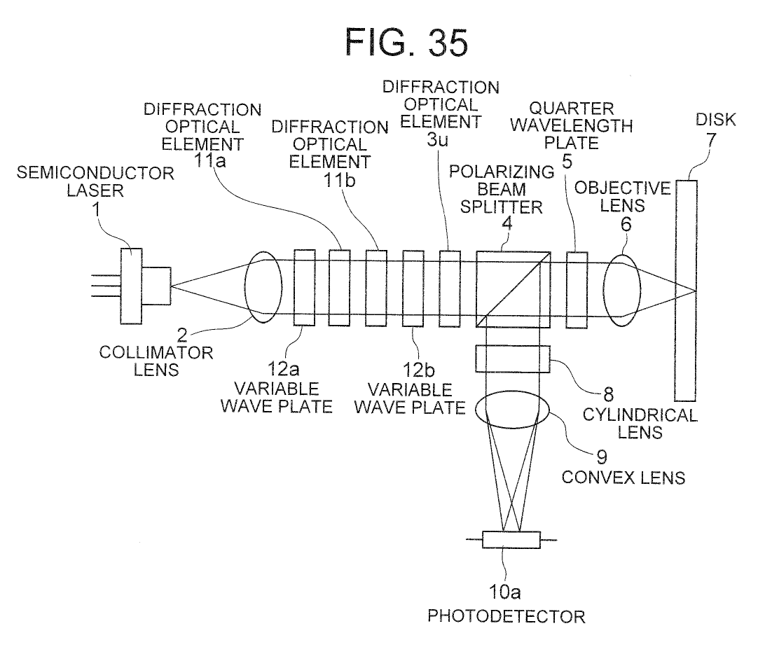

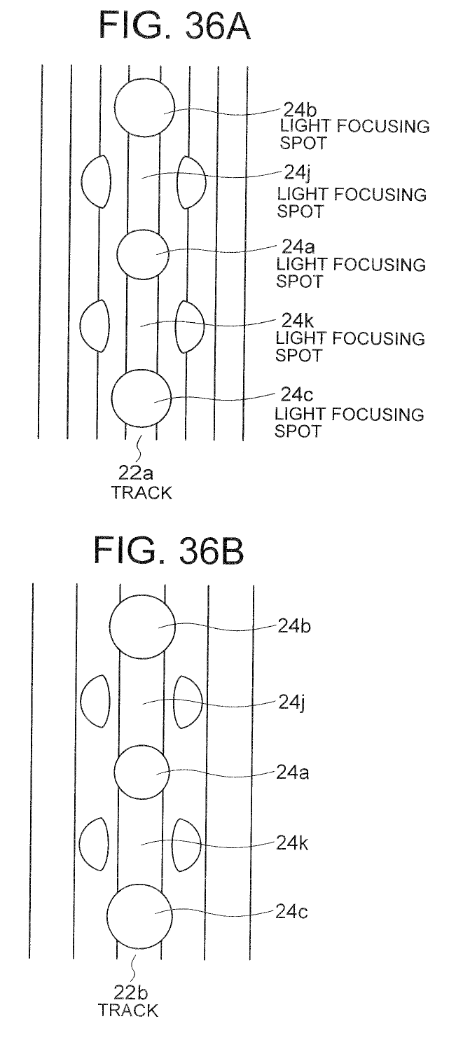

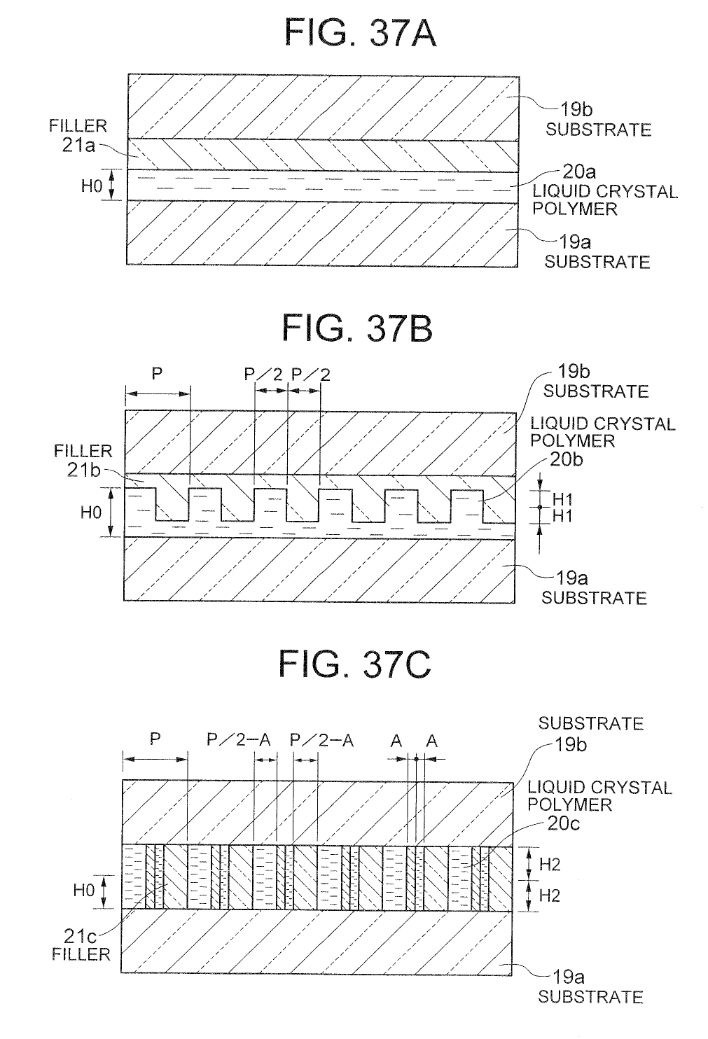

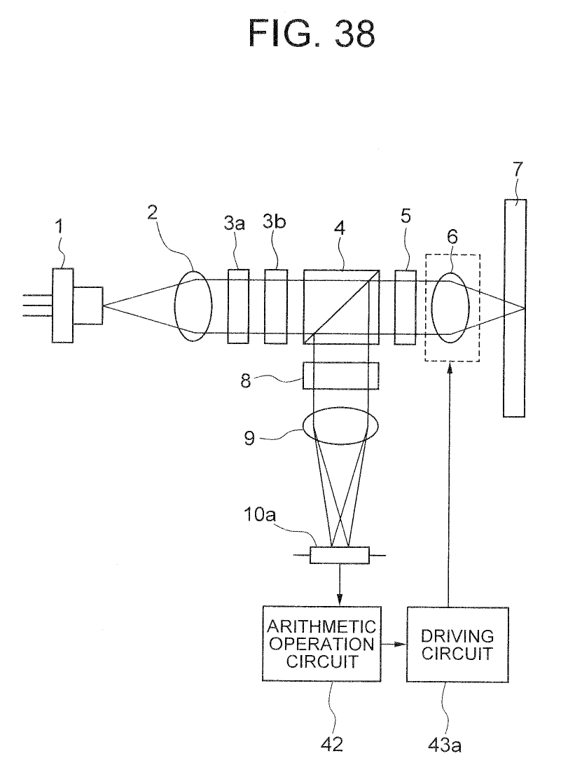

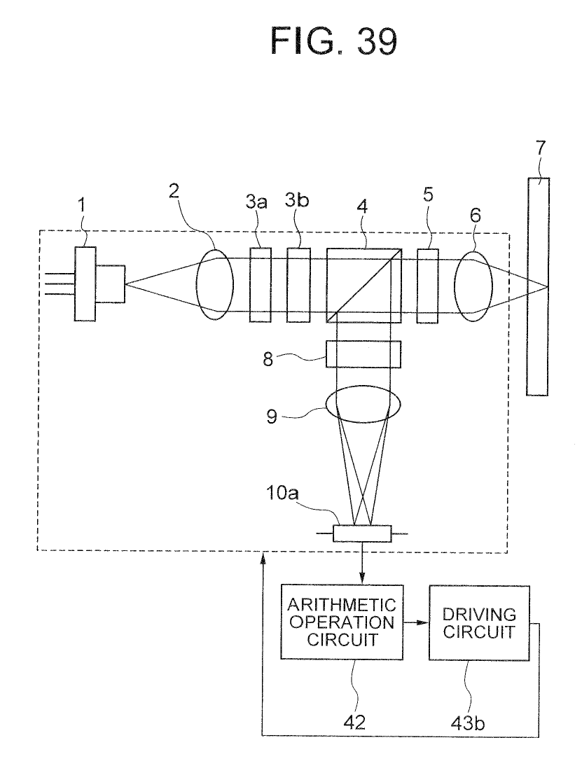

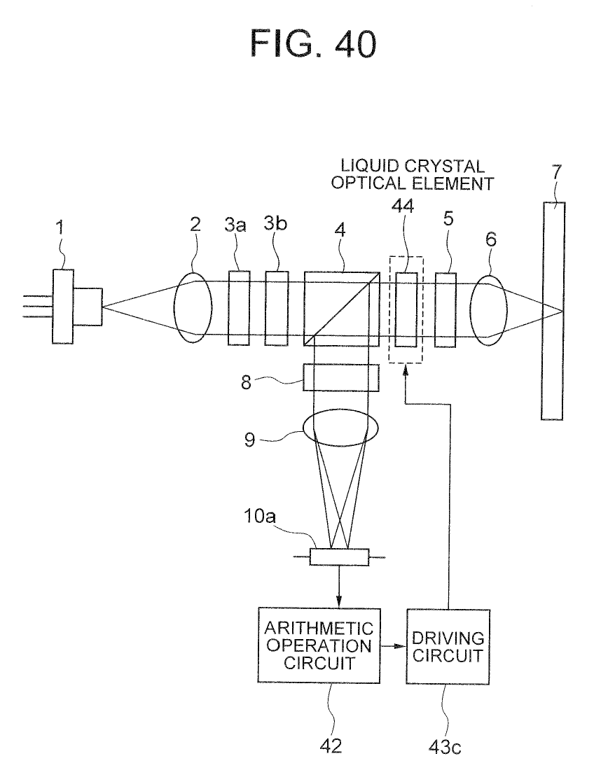

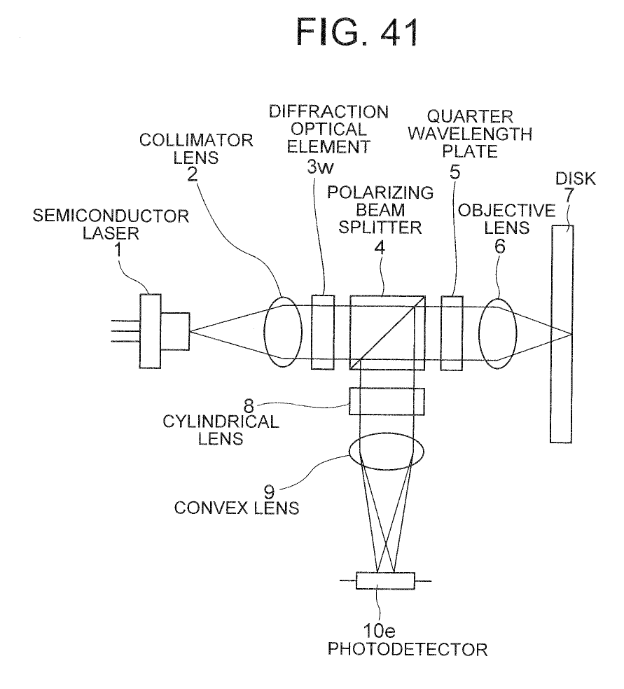

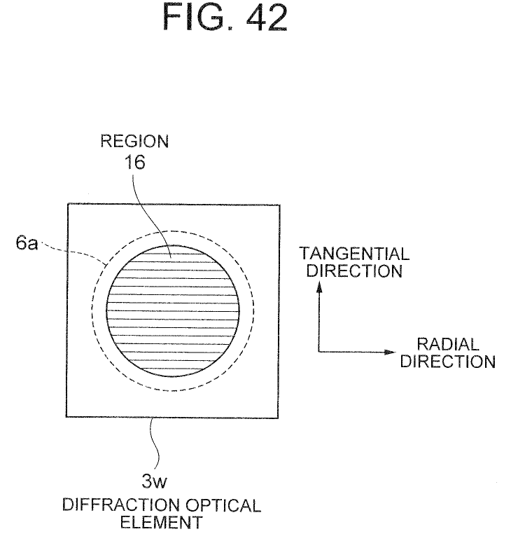

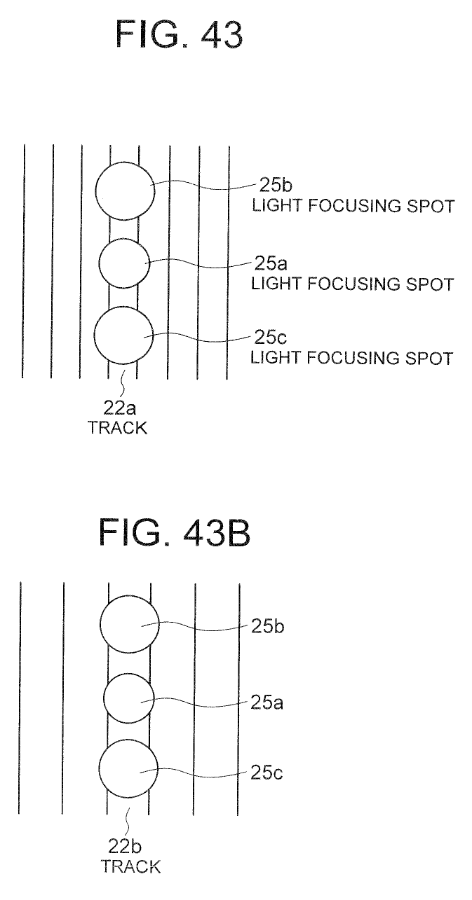

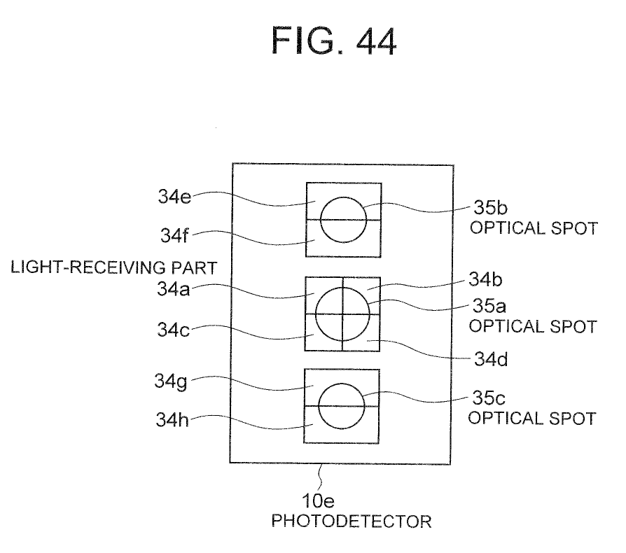

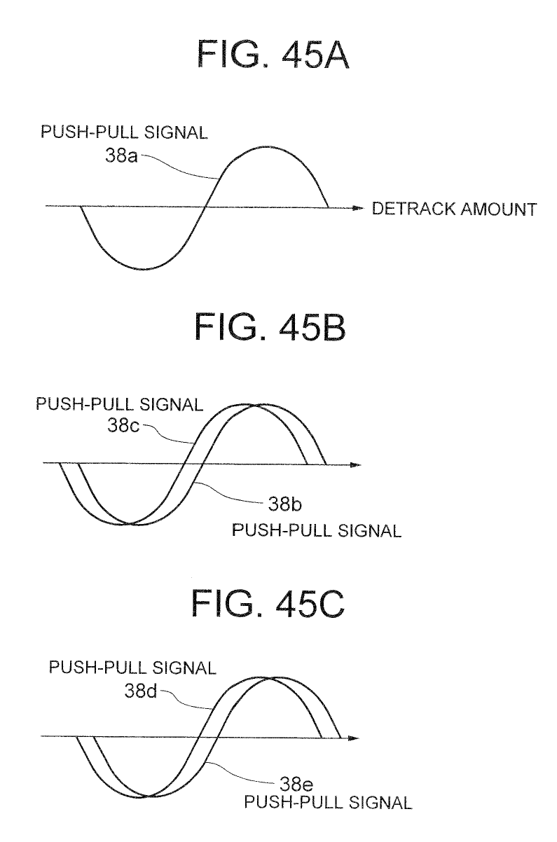

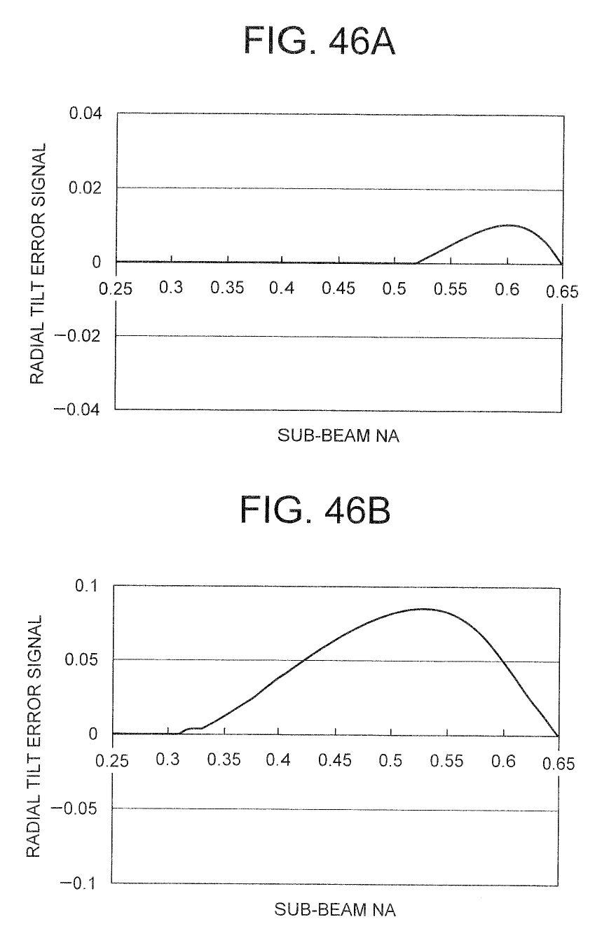

### REFERENCE NUMERALS

1 Semiconductor laser (light source)
2 Collimator lens
3a-3w Diffraction optical elements
4 Polarizing beam splitter
5 quarter wavelength plate
6 Objective lens
7 Disk (Optical recording medium)
8 Cylindrical lens
9 Convex lens
10a-10e Photodetector
11a-11n Diffraction optical element
12a, 12b Variable wave plate (intensity distribution changing device)
13a-13z Region
14a-14p Region
15a-15m Region
16 Region
17 Substrate
18a-18c Dielectric substance
19a, 19b Substrate
20a-20c Liquid crystal polymer
21a-21c Filler
22a, 22b Track
23a-23s Light focusing spot
24a-24k Light focusing spot
25a-25c Light focusing spot
26a-26l Light-receiving part
27a-27e Optical spot
28a-28t Light-receiving part
29a-29i Optical spot
30a-30p Light-receiving part
31a-31g Optical spot
32a-32h Light-receiving part
23a-33c Optical spot
34a-34h Light-receiving part
35a-35c Optical spot
36a-36e Push-pull signal
37a-37c Push-pull signal
38a-38e Push-pull signal
39a-39f Region
40a-401 Region
41a-41x Region
42 Arithmetic operation circuit (arithmetic operation device)
43a-43c Driving circuit (correcting device)
44 Liquid crystal optical element (correcting device)

1-20. (canceled)

21. An optical head, comprising a light source, an objective lens for converging emitted light from the light source onto a disk-type optical recording medium, a diffraction optical element provided between the light source and the objective lens, and a photodetector for receiving reflected light from the optical recording medium, the optical head using, as the optical recording medium, a first optical recording medium having grooves with a first pitch for forming a track and a second optical recording medium having grooves with a second pitch for forming a track, wherein:
the diffraction optical element has a function of generating, from the emitted light from the light source, a main beam, a first sub-beam group having an intensity distribution that corresponds to the first optical recording medium, and a second sub-beam group having an intensity distribution that corresponds to the second optical recording medium, which are converged on the optical recording medium by the objective lens; and
the photodetector has a first light-receiving part group for receiving reflected light of the main beam that is reflected by the optical recording medium, a second light-receiving part group for receiving reflected light of the first sub-beam group that is reflected by the optical recording medium, and a third light-receiving part group for receiving reflected light of the second sub-beam group that is reflected by the optical recording medium.

22. The optical head as claimed in claim 21, wherein:
the diffraction optical element has a first diffraction grating formed in a first region on an inner side of a first boundary line on a first plane that is perpendicular to an optical axis of incident light, and a second diffraction grating formed in a second region on an inner side of a second boundary line on a second plane which is perpendicular to the optical axis of the incident light and is different from the first plane in terms of a position in optical-axis direction;
a width of the first region in a radial direction of the optical recording medium is narrower than an effective diameter of the objective lens, and a width of the second region in the radial direction of the optical recording medium is narrower the width of the first region; and
transmission light from the first and second planes is considered as the main beam, a first diffraction light group from the first diffraction grating is considered as the first sub-beam group, and a second diffraction light group from the second diffraction grating is considered as the second sub-beam group.

23. The optical head as claimed in claim 21, wherein:
the diffraction optical element has, on a single plane that is perpendicular to an optical axis of incident light, a first diffraction grating formed in a first region that is on an inner side of a first boundary line and on an outer side of a second boundary line, and a second diffraction grating formed in a second region on an inner side of the second boundary line;
a width of a region in which the first and second regions are combined in a radial direction of the optical recording medium is narrower than an effective diameter of the objective lens, and a width of the second region in the radial direction of the optical recording medium is narrower than the width of the region in which the first and second regions are combined; and
transmission light from the single plane is considered as the main beam, a first diffraction light group from the first diffraction grating and the second diffraction grating is considered as the first sub-beam group, and a second diffraction light group from the second diffraction grating is considered as the second sub-beam group.

24. The optical head as claimed in claim 21, wherein:
the diffraction optical element further generates, from the emitted light from the light source, a third sub-beam group and a fourth sub-beam group whose intensity distributions normalized by the intensity on the optical axis are the same as that of the main beam, which are converged by the objective lens on the optical recording medium; and
the photodetector further has a fourth light-receiving part group for receiving reflected light of the third sub-beam group reflected by the optical recording medium, and a fifth light-receiving part group for receiving reflected light of the fourth sub-beam group reflected by the optical recording medium.

25. The optical head as claimed in claim 24, wherein:
the diffraction optical element has a first diffraction grating formed in a first region on an inner side of a first boundary line on a first plane that is perpendicular to an optical axis of incident light, a second diffraction grating formed in a second region on an inner side of a second boundary line on a second plane which is perpendicular to the optical axis of the incident light and is different from the first plane in terms of a position in optical-axis direction, a third diffraction grating formed on a third plane which is perpendicular to the optical axis of the incident light and is different from the first and second planes in terms of a position in optical-axis direction, and a fourth diffraction grating formed on a fourth plane which is perpendicular to the optical axis of the incident light and is different from the first, second, and third planes in terms of a position in optical-axis direction;
a width of the first region in a radial direction of the optical recording medium is narrower than an effective diameter of the objective lens, and a width of the second region in the radial direction of the optical recording medium is narrower than the width of the first region; and
transmission light from the first, second, third, and fourth planes is considered as the main beam, a first diffraction light group from the first diffraction grating is considered as the first sub-beam group, a second diffraction light group from the second diffraction grating is considered as the second sub-beam group, a third diffraction light group from the third diffraction grating is considered as the third sub-beam group, and a fourth diffraction light group from the fourth diffraction grating is considered as the fourth sub-beam group.

26. The optical head as claimed in claim 24, wherein:
the diffraction optical element has a first diffraction grating formed in a first region that is on an inner side of a first boundary line and on an outer side of a second boundary line on a first plane that is perpendicular to an optical axis of incident light, a second diffraction grating formed in a second region on an inner side of the second boundary line, a third diffraction grating formed on a second plane which is perpendicular to the optical axis of the incident light and is different from the first plane in terms of a position in optical-axis direction, and a fourth diffraction grating formed on a third plane that is perpendicular to the optical axis of the incident light and is different from the first and second planes in terms of a position in optical-axis direction;
a width of a region in which the first and second regions are combined in a radial direction of the optical recording medium is narrower than an effective diameter of the objective lens, and a width of the second region in the radial direction of the optical recording medium is narrower than the width of the region in which the first and second regions are combined; and
transmission light from the first, second, and third planes is considered as the main beam, a first diffraction light group from the first and second diffraction gratings is considered as the first sub-beam group, a second diffraction light group from the second diffraction grating is considered as the second sub-beam group, a third diffraction light group from the third diffraction grating is considered as the third sub-beam group, and a fourth diffraction light group from the fourth diffraction grating is considered as the fourth sub-beam group.

27. The optical head as claimed in claim 24, wherein:
the diffraction optical element has a first diffraction grating formed in a first region on an inner side of a first boundary line on a first plane that is perpendicular to an optical axis of incident light, a second diffraction grating formed on an outer side of the first boundary line, a third diffraction grating formed in a second region on an inner side of a second boundary line on a second plane which is perpendicular to the optical axis of the incident light and is different from the first plane in terms of a position in optical-axis direction, and a fourth diffraction grating formed on an outer side of the second boundary line;
a width of the first region in a radial direction of the optical recording medium is narrower than an effective diameter of the objective lens, and a width of the second region in the radial direction of the optical recording medium is narrower than the width of the first region; and
transmission light from the first and second planes is considered as the main beam, a first diffraction light group from the first diffraction grating is considered as the first sub-beam group, a second diffraction light group from the third diffraction grating is considered as the second sub-beam group, a third diffraction light group from the first and second diffraction gratings is considered as the third sub-beam group, and a fourth diffraction light group from the third and fourth diffraction gratings is considered as the fourth sub-beam group.

28. The optical head as claimed in claim 21, wherein:
the diffraction optical element further generates, from the emitted light from the light source, a third sub-beam group whose intensity distribution normalized by the intensity on the optical axis is the same as that of the main beam, which is converged by the objective lens on the optical recording medium; and
the photodetector further has a fourth light-receiving part group for receiving reflected light of the third sub-beam group reflected by the optical recording medium.

29. The optical head as claimed in claim 28, wherein:
the diffraction optical element has a first diffraction grating formed in a first region on an inner side of a first boundary line on a first plane that is perpendicular to an optical axis of incident light, a second diffraction grating formed in a second region on an inner side of a second boundary line on a second plane which is perpendicular to the optical axis of the incident light and is different from the first plane in terms of a position in optical-axis direction, and a third diffraction grating formed on a third plane which is perpendicular to the optical axis of the incident light and is different from the first and second planes in terms of a position in optical-axis direction;
a width of the first region in a radial direction of the optical recording medium is narrower than an effective diameter of the objective lens, and a width of the second region in the radial direction of the optical recording medium is narrower than the width of the first region; and
transmission light from the first, second, and third planes is considered as the main beam, a first diffraction light group from the first diffraction grating is considered as the first sub-beam group, a second diffraction light group from the second diffraction grating is considered as the second sub-beam group, and a third diffraction light group from the third diffraction grating is considered as the third sub-beam group.

30. The optical head as claimed in claim 28, wherein:
the diffraction optical element has a first diffraction grating formed in a first region that is on an inner side of a first boundary line and on an outer side of a second boundary line on a first plane that is perpendicular to an optical axis of incident light, a second diffraction grating formed in a second region on an inner side of the second boundary line, and a third diffraction grating formed on a second plane which is perpendicular to the optical axis of the incident light and is different from the first plane in terms of a position in optical-axis direction;
a width of a region in which the first and second regions are combined in a radial direction of the optical recording medium is narrower than an effective diameter of the objective lens, and a width of the second region in the radial direction of the optical recording medium is narrower than the width of the region in which the first and second regions are combined; and
transmission light from the first and second planes is considered as the main beam, a first diffraction light group from the first and second diffraction gratings is considered as the first sub-beam group, a second diffraction light group from the second diffraction grating is considered as the second sub-beam group, and a third diffraction light group from the third diffraction grating is considered as the third sub-beam group.

31. An optical head, comprising a light source, an objective lens for converging emitted light from the light source onto a disk-type optical recording medium, a diffraction optical element provided between the light source and the objective lens, and a photodetector for receiving reflected light from the optical recording medium, the optical head using, as the optical recording medium, a first optical recording medium having grooves with a first pitch for forming a track and a second optical recording medium having grooves with a second pitch for forming a track, wherein:
the diffraction optical element has a function of generating, from the emitted light from the light source, a main beam, a first sub-beam group having an intensity distribution that corresponds to the first optical recording medium, and a second sub-beam group having an intensity distribution that corresponds to the second optical recording medium, which are converged on the optical recording medium by the objective lens; and
the photodetector comprises a first light-receiving means group for receiving reflected light of the main beam that is reflected by the optical recording medium, a second light-receiving means group for receiving reflected light of the first sub-beam group that is reflected by the optical recording medium, and a third light-receiving means group for receiving reflected light of the second sub-beam group that is reflected by the optical recording medium.

32. An optical head, comprising a light source, an objective lens for converging emitted light from the light source onto a disk-type optical recording medium, a diffraction optical element provided between the light source and the objective lens, and a photodetector for receiving reflected light from the optical recording medium, the optical head using, as the optical recording medium, a first optical recording medium having grooves with a first pitch for forming a track and a second optical recording medium having grooves with a second pitch for forming a track, wherein:
the diffraction optical element has a function of generating, from the emitted light from the light source, a main beam and a first sub-beam group, which are converged on the optical recording medium by the objective lens; and
the photodetector has a first light-receiving part group for receiving reflected light of the main beam that is reflected by the optical recording medium, and a second light-receiving part group for receiving reflected light of the first sub-beam group that is reflected by the optical recording medium,
the optical head further comprising an intensity distribution changing device which cooperates with the diffraction optical element to change an intensity distribution of the first sub-beam group either to an intensity distribution corresponding to the first optical recording medium or to an intensity distribution corresponding to the second optical recording medium.

33. The optical head as claimed in claim 32, wherein:
the diffraction optical element has a first diffraction grating formed in a first region on an inner side of a first boundary line on a first plane that is perpendicular to an optical axis of incident light, and a second diffraction grating formed in a second region on an inner side of a second boundary line on a second plane which is perpendicular to the optical axis of the incident light and is different from the first plane in terms of a position in optical-axis direction;
a width of the first region in a radial direction of the optical recording medium is narrower than an effective diameter of the objective lens, and a width of the second region in the radial direction of the optical recording medium is narrower than the width of the first region; and
transmission light from the first and second planes is considered as the main beam, and a diffraction light group from the first diffraction grating or the second diffraction grating is considered as the first sub-beam group; and
the diffraction light group from the first diffraction grating has the intensity distribution corresponding to the first optical recording medium, and the diffraction light group from the second diffraction grating has the intensity distribution corresponding to the second optical recording medium.

34. The optical head as claimed in claim 33, wherein:
the diffraction optical element further generates, from the emitted light from the light source, a second sub-beam group whose intensity distribution normalized by the intensity on the optical axis is the same as that of the main beam, which is converged by the objective lens on the optical recording medium; and
the photodetector further has a third light-receiving part group for receiving reflected light of the second sub-beam group reflected by the optical recording medium.

35. The optical head as claimed in claim 34, wherein:
the diffraction optical element has a first diffraction grating formed in a first region on an inner side of a first boundary line on a first plane that is perpendicular to an optical axis of incident light, a second diffraction grating formed in a second region on an inner side of a second boundary line on a second plane which is perpendicular to the optical axis of the incident light and is different from the first plane in terms of a position in optical-axis direction, a third diffraction grating formed on a third plane which is perpendicular to the optical axis of the incident light and is different from the first and second planes in terms of a position in optical-axis direction, and a fourth diffraction grating formed on a fourth plane which is perpendicular to the optical axis of the incident light and is different from the first, second, and third planes in terms of a position in optical-axis direction;
a width of the first region in a radial direction of the optical recording medium is narrower than an effective diameter of the objective lens, and a width of the second region in the radial direction of the optical recording medium is narrower than the width of the first region; and
transmission light from the first, second, third, and fourth planes is considered as the main beam, a first diffraction light group from the first diffraction grating or the second diffraction grating is considered as the first sub-beam group, and a second diffraction light group from the third diffraction grating or the fourth diffraction grating is considered as the second sub-beam group; and
the first diffraction light group from the first diffraction grating has the intensity distribution corresponding to the first optical recording medium, and the first diffraction light group from the second diffraction grating has the intensity distribution corresponding to the second optical recording medium.

36. The optical head as claimed in claim 34, wherein:
the diffraction optical element has a first diffraction grating formed in a first region on an inner side of a first boundary line on a first plane that is perpendicular to an optical axis of incident light, a second diffraction grating formed on an outer side of the first boundary line, a third diffraction grating formed in a second region on an inner side of a second boundary line on a second plane which is perpendicular to the optical axis of the incident light and is different from the first plane in terms of a position in optical-axis direction, and a fourth diffraction grating formed on an outer side of the second boundary line;
a width of the first region in a radial direction of the optical recording medium is narrower than an effective diameter of the objective lens, and a width of the second region in the radial direction of the optical recording medium is narrower than the width of the first region; and
transmission light from the first and second planes is considered as the main beam, a first diffraction light group from the first diffraction grating or the third diffraction grating is considered as the first sub-beam group, and a second diffraction light group from the first and second diffraction gratings or the third and fourth diffraction gratings is considered as the second sub-beam group; and
the first diffraction light group from the first diffraction grating has the intensity distribution corresponding to the first optical recording medium, and the first diffraction light group from the third diffraction grating has the intensity distribution corresponding to the second optical recording medium.

37. The optical head as claimed in claim 34, wherein:
the diffraction optical element has a first diffraction grating formed in a first region on an inner side of a first boundary line on a first plane that is perpendicular to an optical axis of incident light, a second diffraction grating formed in a second region on an inner side of a second boundary line on a second plane which is perpendicular to the optical axis of the incident light and is different from the first plane in terms of a position in optical-axis direction, and a third diffraction grating formed on a third plane which is perpendicular to the optical axis of the incident light and is different from the first and second planes in terms of a position in optical-axis direction;
a width of the first region in a radial direction of the optical recording medium is narrower than an effective diameter of the objective lens, and a width of the second region in the radial direction of the optical recording medium is narrower than the width of the first region;
transmission light from the first, second, and third planes is considered as the main beam, a first diffraction light group from the first diffraction grating or the second diffraction grating is considered as the first sub-beam group, and a second diffraction light group from the third diffraction grating is considered as the second sub-beam group; and
the first diffraction light group from the first diffraction grating has the intensity distribution corresponding to the first optical recording medium, and the first diffraction light group from the second diffraction grating has the intensity distribution corresponding to the second optical recording medium.

38. The optical head as claimed in claim 32, wherein:
the intensity distribution changing device is a variable wave plate which is provided between the light source and the diffraction optical element, so as to work either to change or not to change polarizing direction of the incident light substantially by 90 degrees; and
the diffraction optical element generates the first sub-beam group that has an intensity distribution corresponding to either the first or the second optical recording medium in accordance with the polarizing direction of the incident light.

39. An optical head, comprising a light source, an objective lens for converging emitted light from the light source onto a disk-type optical recording medium, a diffraction optical element provided between the light source and the objective lens, and a photodetector for receiving reflected light from the optical recording medium, the optical head using, as the optical recording medium, a first optical recording medium having grooves with a first pitch for forming a track and a second optical recording medium having grooves with a second pitch for forming a track, wherein:
the diffraction optical element has a function of generating, from the emitted light from the light source, a main beam and a first sub-beam group, which are converged on the optical recording medium by the objective lens; and
the photodetector comprises a first light-receiving means group for receiving reflected light of the main beam that is reflected by the optical recording medium, and a second light-receiving means group for receiving reflected light of the first sub-beam group that is reflected by the optical recording medium,
the optical head further comprising an intensity distribution changing means which cooperates with the diffraction optical element for changing an intensity distribution of the first sub-beam group either to an intensity distribution corresponding to the first optical recording medium or to an intensity distribution corresponding to the second optical recording medium.

40. An optical information recording/reproducing device, comprising:
the optical head as claimed in claim 21;
a first arithmetic operation device which detects a push-pull signal for the first and second optical recording media based on output signals of the first light-receiving part group;
a second arithmetic operation device which detects a push-pull signal for the first optical recording medium based on output signals of the second light-receiving part group;
a third arithmetic operation device which detects a push-pull signal for the second optical recording medium based on output signals of the third light-receiving part group; and
a fourth arithmetic operation device which detects a radial tilt error signal indicating radial tilt of the first optical recording medium based on the push-pull signal detected from the output signals of the second light-receiving part group when the optical recording medium is the first optical recording medium, and detects a radial tilt error signal indicating radial tilt of the second optical recording medium based on the push-pull signal detected from the output signals of the third light-receiving part group when the optical recording medium is the second optical recording medium.

41. An optical information recording/reproducing device, comprising:
the optical head as claimed in claim 32;
a first arithmetic operation device which detects a push-pull signal for the first and second optical recording media based on output signals of the first light-receiving part group;
a second arithmetic operation device which detects a push-pull signal for the first and second optical recording media based on output signals of the second light-receiving part group;
a control device which controls the intensity distribution of the first sub-beam group to correspond to the first optical recording medium via the intensity distribution changing device when the optical recording medium is the first optical recording medium, and controls the intensity distribution of the first sub-beam group to correspond to the second optical recording medium via the intensity distribution changing device when the optical recording medium is the second optical recording medium; and
a third arithmetic operation device which detects a radial tilt error signal indicating radial tilt of the first optical recording medium based on the push-pull signal detected from the output signals of the second light-receiving part group when the optical recording medium is the first optical recording medium, and detects a radial tilt error signal indicating radial tilt of the second optical recording medium based on the push-pull signal detected from the output signals of the second light-receiving part group when the optical recording medium is the second optical recording medium.

42. An optical information recording/reproducing device, comprising:
the optical head as claimed in claim 21;
a first arithmetic operation means for detecting a push-pull signal for the first and second optical recording media based on output signals of the first light-receiving part group;
a second arithmetic operation means for detecting a push-pull signal for the first optical recording medium based on output signals of the second light-receiving part group;
a third arithmetic operation means for detecting a push-pull signal for the second optical recording medium based on output signals of the third light-receiving part group; and
a fourth arithmetic operation means for detecting a radial tilt error signal indicating radial tilt of the first optical recording medium based on the push-pull signal detected from the output signals of the second light-receiving part group when the optical recording medium is the first optical recording medium, and for detecting a radial tilt error signal indicating radial tilt of the second optical recording medium based on the push-pull signal detected from the output signals of the third light-receiving part group when the optical recording medium is the second optical recording medium.

43. An optical information recording/reproducing device, comprising:
the optical head as claimed in claim 32;
a first arithmetic operation means for detecting a push-pull signal for the first and second optical recording media based on output signals of the first light-receiving part group;
a second arithmetic operation means for detecting a push-pull signal for the first and second optical recording media based on output signals of the second light-receiving part group;
a control means for controlling the intensity distribution of the first sub-beam group to correspond to the first optical recording medium via the intensity distribution changing device when the optical recording medium is the first optical recording medium, and for controlling the intensity distribution of the first sub-beam group to correspond to the second optical recording medium via the intensity distribution changing device when the optical recording medium is the second optical recording medium; and
a third arithmetic operation means for detecting a radial tilt error signal indicating radial tilt of the first optical recording medium based on the push-pull signal detected from the output signals of the second light-receiving part group when the optical recording medium is the first optical recording medium, and for detecting a radial tilt error signal indicating radial tilt of the second optical recording medium based on the push-pull signal detected from the output signals of the second light-receiving part group when the optical recording medium is the second optical recording medium.

44. The optical information recording/reproducing device as claimed in claim 40, further comprising a correcting device for correcting the radial tilt of the optical recording medium.

45. The optical information recording/reproducing device as claimed in claim 41, further comprising a correcting device for correcting the radial tilt of the optical recording medium.
